(19) United States
(12) Patent Application Publication
(10) Pub. No.: US 2025/0383004 A1
(43) Pub. Date: Dec. 18, 2025

(54) DAMPING FORCE GENERATION MECHANISM

(71) Applicant: Hitachi Astemo, Ltd., Ibaraki (JP)

(72) Inventors: Hideo NAGAYAMA, Hitachinaka-shi (JP); Mikio YAMASHITA, Hitachinaka-shi (JP); Takamasa KOTANI, Hitachinaka-shi (JP); Tsutomu NAITO, Hitachinaka-shi (JP)

(21) Appl. No.: 18/878,178

(22) PCT Filed: May 19, 2023
(86) PCT No.: PCT/JP2023/018798

§ 371 Date: Dec. 23, 2024

(30) Foreign Application Priority Data
Jul. 8, 2022 (JP) 2022-110419

(51) Int. Cl. F16F 9/348; F16F 9/32; F16F 9/36

(52) U.S. Cl. CPC F16F 9/3482; F16F 9/3257; F16F 9/369; F16F 2228/04

(57) ABSTRACT

The damping force generation mechanism includes a biasing force generation member having a bottomed cylindrical shape and forming a back pressure chamber which causes a first damping force generation member disposed on an opening side to generate a biasing force in a valve closing direction, a frequency sensitive mechanism configured such that a movable mechanism having a seal portion is movably provided in the first passage provided at a bottom portion of the biasing force generation member to connect the back pressure chamber and a first chamber, thereby making the biasing force variable, a second passage parallel to or common with the first passage and having one side allowed to communicate with the back pressure chamber, and a communication mechanism on the one side of the second passage and allowed to communicate with another side of the second passage only when the first chamber is on an upstream side.

### TECHNICAL FIELD

The present invention relates to a damping force generation mechanism.

Priority is claimed on Japanese Patent Application No. 2022-110419, filed Jul. 8, 2022, the content of which is incorporated herein by reference.

### BACKGROUND ART

Among damping force generation mechanisms provided in shock absorbers, there is one in which a back pressure is applied to a damping force generation member in a valve closing direction (see, for example, Patent Documents 1 and 2).

### CITATION LIST

### Patent Document

Patent Document 1: PCT International Publication No. WO 2018/163868
Patent Document 2: U.S. patent Ser. No. 10/001,189

### SUMMARY OF INVENTION

### Technical Problem

It is desired to suppress an increase in size of a damping force generation mechanism.

Therefore, an objective of the present invention is to provide a damping force generation mechanism in which an increase in size can be suppressed.

### Solution to Problem

One aspect of a damping force generation mechanism according to the present invention includes a biasing force generation member having a bottomed cylindrical shape and forming a back pressure chamber which causes a first damping force generation member disposed on an opening side to generate a biasing force in a valve closing direction, a frequency sensitive mechanism configured such that a movable mechanism having a seal portion, which seals a first passage with an elastic member, is movably provided in the first passage provided at a bottom portion of the biasing force generation member to connect the back pressure chamber and a first chamber, thereby making the biasing force variable, a second passage parallel to or common with the first passage and having one side allowed to communicate with the back pressure chamber, and a communication mechanism which is on the one side of the second passage and allowed to communicate with another side of the second passage only when the first chamber is on an upstream side.

### Advantageous Effects of Invention

According to the aspect described above, it is possible to suppress an increase in size.

### BRIEF DESCRIPTION OF DRAWINGS

FIG. 1 A cross-sectional view showing a shock absorber including a damping force generation mechanism according to a first embodiment according to the present invention.

FIG. 2 A cross-sectional view showing a configuration of a main part including the damping force generation mechanism of the first embodiment.

FIG. 3 A cross-sectional view showing a configuration of a main part of the damping force generation mechanism of the first embodiment.

FIG. 4 A cross-sectional perspective view showing a configuration of a main part of the damping force generation mechanism of the first embodiment.

FIG. 5 A cross-sectional view showing a configuration of a main part of a damping force generation mechanism of a second embodiment according to the present invention.

FIG. 6 A plan view showing a disc of the damping force generation mechanism of the second embodiment.

FIG. 7 A plan view showing a disc of the damping force generation mechanism of the second embodiment.

FIG. 8 A cross-sectional view showing a configuration of a main part of a modified example of the damping force generation mechanism of the second embodiment.

FIG. 9 A plan view showing a disc of a modified example of the damping force generation mechanism of the second embodiment.

FIG. 10 A cross-sectional view showing a configuration of a main part including a damping force generation mechanism of a third embodiment according to the present invention.

FIG. 11 A cross-sectional view showing a configuration of a main part of the damping force generation mechanism of the third embodiment.

FIG. 12 A cross-sectional view showing a configuration of a main part of a modified example of the damping force generation mechanism of the third embodiment.

FIG. 13 A cross-sectional view showing a configuration of a main part of a damping force generation mechanism of a fourth embodiment according to the present invention.

FIG. 14 A plan view showing a pilot case of the damping force generation mechanism of the fourth embodiment.

FIG. 15 A cross-sectional view showing a configuration of a main part of a damping force generation mechanism of a fifth embodiment according to the present invention.

FIG. 16 A cross-sectional view showing a configuration of a main part of a damping force generation mechanism of a sixth embodiment according to the present invention.

FIG. 17 A bottom view showing a pilot case of the damping force generation mechanism of the sixth embodiment.

FIG. 18 A plan view showing a disc of the damping force generation mechanism of the sixth embodiment.

FIG. 19 A plan view showing a disc of the damping force generation mechanism of the sixth embodiment.

FIG. 20 A cross-sectional view showing a configuration of a main part of a damping force generation mechanism of a seventh embodiment according to the present invention.

### DESCRIPTION OF EMBODIMENTS

### First Embodiment

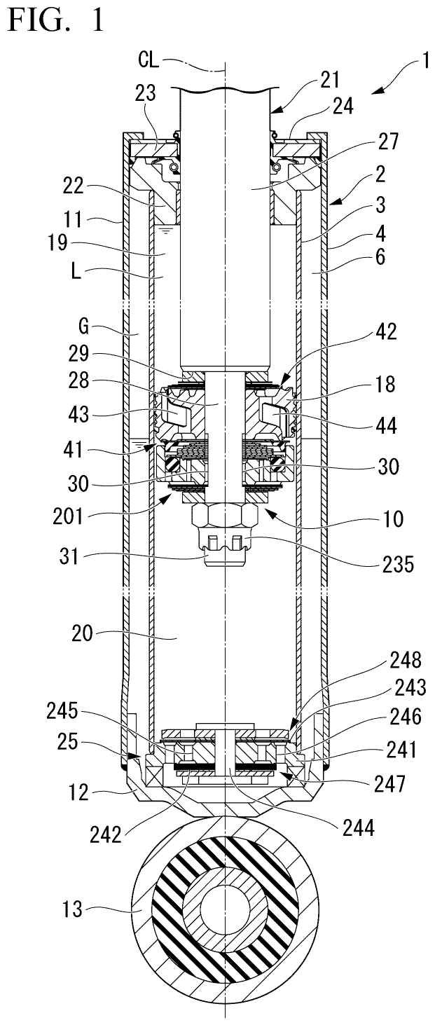

A shock absorber including a damping force generation mechanism 10 of a first embodiment will be described below with reference to FIGS. 1 to 4. Further, in the following, for convenience of explanation, an upper side in FIGS. 1 to 3, 5, 8, 10 to 13, 15, 16, and 20 will be referred to with “upper,” and a lower side in FIGS. 1 to 3, 5, 8, 10 to 13, 15, 16, and 20 will be referred to with “lower”. Also, in each of the drawings, a central axis of a shock absorber 1 may be denoted by reference sign CL.

As shown in FIG. 1, the shock absorber 1 is a dual-tube type hydraulic shock absorber. The shock absorber 1 is used in suspension devices of vehicles. The shock absorber 1 includes a cylinder 2 in which an oil fluid L is sealed as a working fluid. The cylinder 2 has an inner cylinder 3 and an outer cylinder 4. The inner cylinder 3 has a cylindrical shape. The outer cylinder 4 has a bottomed cylindrical shape. The outer cylinder 4 has an inner diameter larger than an outer diameter of the inner cylinder 3. The inner cylinder 3 is disposed inside of the outer cylinder 4. A central axis of the inner cylinder 3 and a central axis of the outer cylinder 4 coincide with each other. A reservoir chamber 6 is formed between the inner cylinder 3 and the outer cylinder 4.

The outer cylinder 4 includes a barrel member 11 and a bottom member 12. The barrel member 11 has a cylindrical shape. The bottom member 12 has a bottomed cylindrical shape. The bottom member 12 is fitted to a lower side of the barrel member 11 and fixed by welding. The bottom member 12 closes a lower part of the barrel member 11. Amounting eye 13 is fixed to the bottom member 12 on an outer side opposite to the barrel member 11 in an axial direction thereof.

The shock absorber 1 includes a piston 18. The piston 18 is slidably fitted into the inner cylinder 3 of the cylinder 2. The piston 18 partitions the inside of the inner cylinder 3 into two chambers, an upper chamber 19 and a lower chamber 20 (first chamber). In an axial direction of the cylinder 2, the upper chamber 19 is on a side opposite to the bottom member 12 with respect to the piston 18. In the axial direction of the cylinder 2, the lower chamber 20 is on the bottom member 12 side with respect to the piston 18. An oil fluid L is sealed in the upper chamber 19 and the lower chamber 20 in the inner cylinder 3 as a working fluid. The oil fluid L and a gas G are sealed in the reservoir chamber 6 between the inner cylinder 3 and the outer cylinder 4 as a working fluid.

The shock absorber 1 includes a piston rod 21. One end side of the piston rod 21 in an axial direction thereof is disposed inside the inner cylinder 3 of the cylinder 2. This one end part of the piston rod 21 is connected to the piston 18. The other end side of the piston rod 21 on a side opposite to the one end part in the axial direction extends from the cylinder 2 to the outside of the cylinder 2. The piston 18 is fixed to the piston rod 21. Therefore, the piston 18 and the piston rod 21 move together. In the shock absorber 1, a stroke in which the piston rod 21 moves in a direction to increase an amount of protrusion from the cylinder 2 is referred to as an extension stroke in which the entire length increases. In the shock absorber 1, a stroke in which the piston rod 21 moves in a direction to decrease an amount of protrusion from the cylinder 2 is referred to as a compression stroke in which the entire length decreases. In the shock absorber 1, the piston 18 moves to the upper chamber 19 side during the extension stroke. In the shock absorber 1, the piston 18 moves to the lower chamber 20 side during the compression stroke.

A rod guide 22 is fitted to an upper end opening side of the inner cylinder 3 and an upper end opening side of the outer cylinder 4. A seal member 23 is fitted into the outer cylinder 4 on an upper side of the rod guide 22. A disc 24 is fitted into the outer cylinder 4 on an upper side of the seal member 23. The rod guide 22 and the seal member 23 are both annular. The disc 24 has a bored circular flat plate shape with a constant thickness. The disc 24 is in contact with a portion on an outer circumferential side of the seal member 23. The piston rod 21 slides with respect to the rod guide 22 and the seal member 23 in an axial direction of these. The piston rod 21 extends from the inside of the cylinder 2 to the outside of the cylinder 2 with respect to the seal member 23.

The rod guide 22 restricts movement of the piston rod 21 in a radial direction with respect to the inner cylinder 3 and outer cylinder 4 of the cylinder 2. The piston rod 21 is fitted in the rod guide 22, and the piston 18 is fitted in the inner cylinder 3. Thereby, a central axis of the piston rod 21 and a central axis of the cylinder 2 coincide with each other. The rod guide 22 supports the piston rod 21 to be movable in an axial direction of the piston rod 21. The seal member 23 has an outer circumferential portion in close contact with the outer cylinder 4. The seal member 23 has an inner circumferential portion in close contact with an outer circumferential portion of the piston rod 21. The piston rod 21 moves in an axial direction of the seal member 23 with respect to the seal member 23. The seal member 23 curbs the oil fluid L in the inner cylinder 3 and the high-pressure gas and the oil fluid L in the reservoir chamber 6 leaking to the outside.

An outer circumferential portion of the rod guide 22 has a larger diameter at an upper portion than at a lower part. The rod guide 22 is fitted to an inner circumferential portion of an upper end of the inner cylinder 3 at the lower part with the smaller diameter. The rod guide 22 is fitted to an upper inner circumferential portion of the outer cylinder 4 at the upper portion with the larger diameter. A base valve 25 is installed on the bottom member 12 of the outer cylinder 4. The base valve 25 is positioned in the radial direction with respect to the outer cylinder 4. The base valve 25 partitions the lower chamber 20 and the reservoir chamber 6. An inner circumferential portion of a lower end of the inner cylinder 3 is fitted to the base valve 25. An upper end part of the outer cylinder 4 is swaged inward in the radial direction of the outer cylinder 4. The seal member 23, together with the disc 24, is fixed to the cylinder 2 by being sandwiched between the swaged portion and the rod guide 22.

The piston rod 21 includes a main shaft portion 27 and a mounting shaft portion 28. The mounting shaft portion 28 has an outer diameter smaller than an outer diameter of the main shaft portion 27. The mounting shaft portion 28 is disposed inside the cylinder 2. The piston 18 is attached to the mounting shaft portion 28. The main shaft portion 27 has a shaft step portion 29. The shaft step portion 29 is provided at an end part of the main shaft portion 27 on the mounting shaft portion 28 side. The shaft step portion 29 extends in a direction orthogonal to the central axis of the piston rod 21.

A passage groove 30 is formed in the piston rod 21 on an outer circumferential portion of the mounting shaft portion 28. The passage groove 30 is formed by cutting the outer circumferential portion of the mounting shaft portion 28 into a planar shape parallel to a central axis of the mounting shaft portion 28. The passage groove 30 extends in an axial direction of the mounting shaft portion 28. A plurality of, specifically two, passage grooves 30 are formed at intervals in a circumferential direction of the mounting shaft portion 28. A male screw 31 is formed on an outer circumferential portion of an end part of the mounting shaft portion 28 on a side opposite to the main shaft portion 27 with respect to the passage grooves 30 in the axial direction of the mounting shaft portion 28.

The shock absorber 1 is connected to a vehicle body of a vehicle, for example, with a part of the piston rod 21 protruding from the cylinder 2 disposed at an upper portion. At that time, the shock absorber 1 is connected to a wheel side of the vehicle with the mounting eye 13, which is provided on the cylinder 2 side, disposed at a lower part. Conversely, the cylinder 2 side of the shock absorber 1 may be connected to the vehicle body. In this case, the piston rod 21 of the shock absorber 1 is connected to the wheel side.

In the vehicle, the wheel vibrates with respect to the vehicle body as the vehicle travels. Then, in the shock absorber 1, relative positions of the cylinder 2 and the piston rod 21 change according to the vibration. This change is suppressed by fluid resistance in a flow path provided in the shock absorber 1. As will be described below, the fluid resistance in the flow path provided in the shock absorber 1 is designed to be different according to a speed and an amplitude of the vibration described above. Ride comfort of the vehicle is improved by the shock absorber 1 suppressing the vibration.

Also, in the vehicle, an inertial force or a centrifugal force generated in the vehicle body as the vehicle travels also acts between the cylinder 2 and the piston rod 21 in addition to the vibration generated by the wheel with respect to the vehicle body. For example, a centrifugal force is generated in the vehicle body when a traveling direction is changed by a steering wheel operation. Then, a force based on the centrifugal force acts between the cylinder 2 and the piston rod 21. As will be described below, the shock absorber 1 has satisfactory properties against vibration based on the force generated in the vehicle body as the vehicle travels. High traveling stability of the vehicle can be obtained by the shock absorber 1.

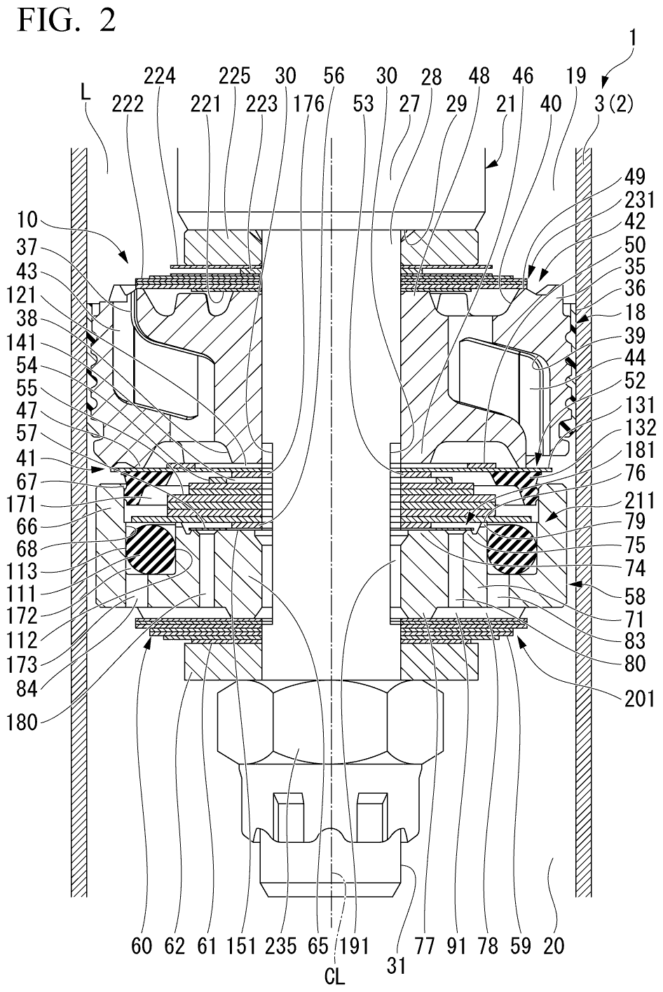

The damping force generation mechanism 10 includes the piston 18 and has a configuration shown in FIG. 2.

The piston 18 includes a piston main body 35 and a slide member 36. The piston main body 35 is made of a metal and has an annular shape. The piston main body 35 of the piston 18 is fitted onto the mounting shaft portion 28 of the piston rod 21. The slide member 36 is made of a synthetic resin and has an annular shape. The slide member 36 is integrally attached to an outer circumferential surface of the piston main body 35. The piston 18 slides with respect to the inner cylinder 3 with the slide member 36 in contact with the inner cylinder 3.

A passage hole 37, a passage groove 38, a passage hole 39, and a passage groove 40 are provided in the piston main body 35. The passage hole 37 penetrates the piston main body 35 in an axial direction of the piston main body 35. A plurality of passage holes 37 are formed in the piston main body 35 at intervals in a circumferential direction of the piston main body 35. The passage hole 39 penetrates the piston main body 35 in the axial direction of the piston main body 35. A plurality of passage holes 39 are formed in the piston main body 35 at intervals in the circumferential direction of the piston main body 35. In the piston main body 35, the passage holes 37 and the passage holes 39 are alternately formed one by one at a regular pitch in the circumferential direction of the piston main body 35.

The passage groove 38 is formed in the piston main body 35 in an annular shape in the circumferential direction of the piston main body 35. The passage groove 38 is formed at one end part of the piston main body 35 on the lower chamber 20 side in the axial direction. All the passage holes 37 open to the passage groove 38 at this end part side of the piston main body 35 in the axial direction. The passage groove 40 is formed in the piston main body 35 in an annular shape in the circumferential direction of the piston main body 35. The passage groove 40 is formed at an end part on the upper chamber 19 side of the piston main body 35 opposite to the passage groove 38 in the axial direction. All the passage holes 39 open to the passage groove 40 at the end part side of the piston main body 35 on a side opposite to the passage groove 38 in the axial direction. The plurality of passage holes 37 at end parts on a side opposite to the passage groove 38 in the axial direction of the piston main body 35 open to an outer side of the passage groove 40 in a radial direction of the piston main body 35. The plurality of passage holes 39 at end parts on a side opposite to the passage groove 40 in the axial direction of the piston main body 35 open to an outer side of the passage groove 38 in the radial direction of the piston main body 35. In the piston 18, the inside of the plurality of passage holes 37 and the inside of the passage groove 38 form a piston-side passage 43. In the piston 18, the inside of the plurality of passage holes 39 and the inside of the passage groove 40 form a piston-side passage 44.

The damping force generation mechanism 10 has a first valve mechanism 41 provided in the piston-side passage 43. The first valve mechanism 41 opens and closes the piston-side passage 43 to generate a damping force. The first valve mechanism 41 is disposed on the lower chamber 20 side of the piston 18 in the axial direction. Thereby, the piston-side passage 43 serves as a passage through which the oil fluid L flows from the upper chamber 19 on one side toward the lower chamber 20 on the other side due to movement of the piston 18 to the upper chamber 19 side which is one direction. That is, the piston-side passage 43 serves as a passage through which the oil fluid L flows from the upper chamber 19 toward the lower chamber 20 during the extension stroke. The first valve mechanism 41 generates a damping force by suppressing a flow of the oil fluid L from the piston-side passage 43 to the lower chamber 20 that occurs during the extension stroke.

The damping force generation mechanism 10 has a first valve mechanism 42 provided in the piston-side passage 44. The first valve mechanism 42 opens and closes the piston-side passage 44 to generate a damping force. The first valve mechanism 42 is disposed on the upper chamber 19 side of the piston 18 in the axial direction. Thereby, the piston-side passage 44 serves as a passage through which the oil fluid L flows from the lower chamber 20 toward the upper chamber 19 due to movement of the piston 18 to the lower chamber 20. That is, the piston-side passage 44 serves as a passage through which a flow of the oil fluid L occurs from the lower chamber 20 toward the upper chamber 19 during the compression stroke. The first valve mechanism 42 generates a damping force by suppressing a flow of the oil fluid L from the piston-side passage 44 to the upper chamber 19 that occurs during the compression stroke.

The piston main body 35 has a bored disc shape and has the mounting shaft portion 28 of the piston rod 21 fitted to an inner circumferential portion thereof.

An inner seat portion 46 and a valve seat portion 47 are formed at an end part of the piston main body 35 on the lower chamber 20 side in the axial direction. The inner seat portion 46 is annular. The inner seat portion 46 is disposed on an inner side with respect to the opening of the passage groove 38 on the lower chamber 20 side in the radial direction of the piston main body 35. The valve seat portion 47 is annular. The valve seat portion 47 is disposed on an outer side with respect to the opening of the passage groove 38 on the lower chamber 20 side in the radial direction of the piston main body 35. The valve seat portion 47 constitutes a part of the first valve mechanism 41.

An inner seat portion 48 and a valve seat portion 49 are formed at an end part of the piston main body 35 on the upper chamber 19 side in the axial direction. The inner seat portion 48 is annular. The inner seat portion 48 is disposed on an inner side with respect to the opening of the passage groove 40 on the upper chamber 19 side in the radial direction of the piston main body 35. The valve seat portion 49 is annular. The valve seat portion 49 is disposed on an outer side with respect to the opening of the passage groove 40 on the upper chamber 19 side in the radial direction of the piston main body 35. The valve seat portion 49 constitutes a part of the first valve mechanism 42.

The damping force generation mechanism 10 includes one disc 50, one first damping valve 52 (first damping force generation member), one disc 53, one disc 54, a plurality of, specifically six, discs 55, one disc 56, one opening/closing disc 57, one pilot case 58 (biasing force generation member), a second damping valve 60 formed of a plurality of, specifically six, discs 59, one disc 61, and one annular member 62 on the inner seat portion 46 side in the axial direction of the piston 18 in order from the inner seat portion 46 side in the axial direction of the piston 18.

The discs 50, 53 to 56, 59, and 61, the opening/closing disc 57, the pilot case 58, and the annular member 62 are all made of a metal. The discs 50, 53 to 56, 59, and 61, the opening/closing disc 57, and the annular member 62 all have a bored circular flat plate shape with a constant thickness. The discs 50, 53 to 56, 59, and 61 and the opening/closing disc 57 are formed by press forming. The first damping valve 52 and the pilot case 58 are both annular. The mounting shaft portion 28 of the piston rod 21 is fitted to an inner side of all the discs 50, 53 to 56, 59, and 61, the opening/closing disc 57, the first damping valve 52, the pilot case 58, and the annular member 62.

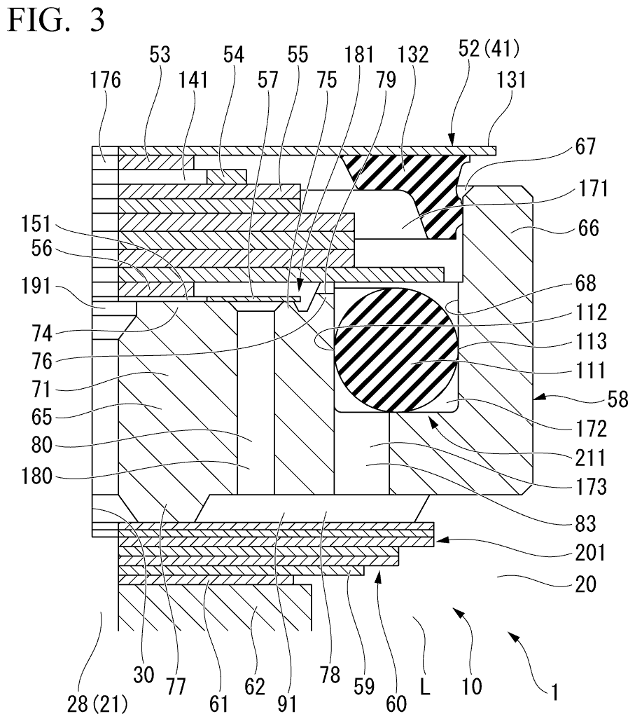

As shown also in FIG. 3, the pilot case 58 has a bottomed cylindrical shape. The pilot case 58 is seamlessly and integrally formed as a whole by sintering. The pilot case 58 has a bottom portion 65 and a cylindrical portion 66.

The bottom portion 65 has a bored disc shape and has the mounting shaft portion 28 of the piston rod 21 fitted to an inner circumferential portion thereof. The cylindrical portion 66 is cylindrical and extends to one side in the axial direction of the bottom portion 65 from an outer circumferential portion of the bottom portion 65. The pilot case 58 has an opening 67 on a side of the cylindrical portion 66 opposite to the bottom portion 65 in the axial direction. In other words, the pilot case 58 has a bottomed cylindrical shape having the opening 67 at one end in the axial direction.

The bottom portion 65 has a bottom main body portion 71, an inner seat portion 74, a valve seat portion 75, an outer seat portion 76, an inner seat portion 77, and an outer seat portion 78.

The bottom main body portion 71 has a bored disc shape and has the mounting shaft portion 28 of the piston rod 21 fitted to an inner circumferential side thereof. A seal groove 68 is formed in the bottom main body portion 71 on the cylindrical portion 66 side in the axial direction. The seal groove 68 is annular and is formed on an inner side of the cylindrical portion 66 in the radial direction of the bottom main body portion 71. The seal groove 68 is recessed in a direction opposite to the cylindrical portion 66 in the axial direction of the bottom portion 65 from the cylindrical portion 66 side in the axial direction of the bottom main body portion 71.

The inner seat portion 74 is formed on an inner circumferential side of the bottom main body portion 71. The inner seat portion 74 is annular. The inner seat portion 74 protrudes to the same side as the cylindrical portion 66 in the axial direction of the bottom main body portion 71 from the bottom main body portion 71.

The valve seat portion 75 is formed outward of the inner seat portion 74 in the radial direction of the bottom main body portion 71. The valve seat portion 72 is annular. The valve seat portion 75 protrudes to the same side as the inner seat portion 74 in the axial direction of the bottom main body portion 71 from the bottom main body portion 71. The valve seat portion 75 has a height in an axial direction of the pilot case 58 that is equal to that of the inner seat portion 74.

The outer seat portion 76 is formed outward of the valve seat portion 75 and inward of the seal groove 68 in the radial direction of the bottom main body portion 71. The outer seat portion 76 is annular. The outer seat portion 76 protrudes from the bottom main body portion 71 to the same side as the inner seat portion 74 and the valve seat portion 75 in the axial direction of the bottom main body portion 71. The outer seat portion 76 has a height from the bottom main body portion 71 in the axial direction of the pilot case 58 that is higher than that of the valve seat portion 75.

A passage groove 79 penetrating the outer seat portion 76 in the radial direction is formed in the outer seat portion 76 at a distal end in the axial direction thereof. A plurality of passage grooves 79 are formed in the outer seat portion 76 at regular intervals in the circumferential direction of the outer seat portion 76.

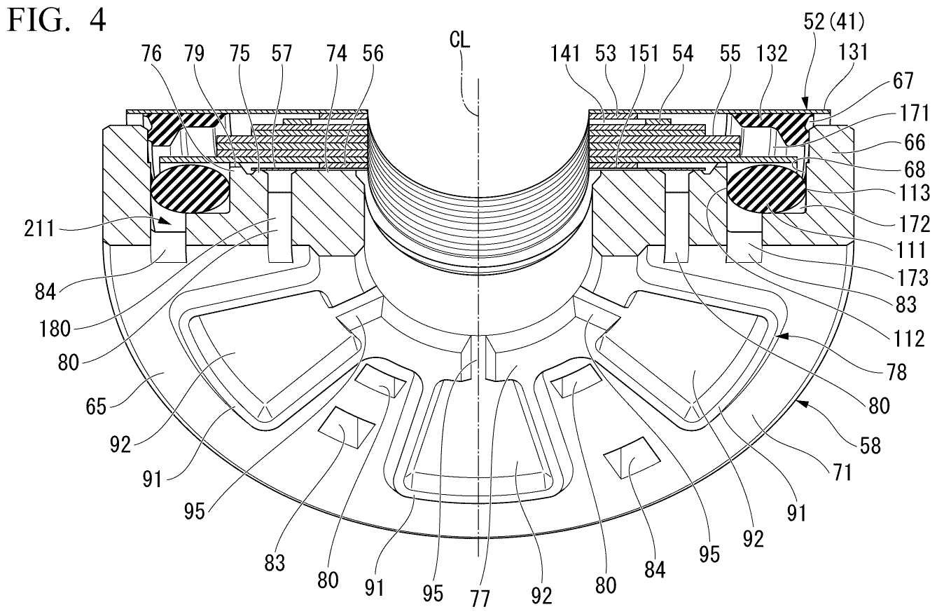

An inner passage hole 80 is formed in the bottom main body portion 71. The inner passage hole 80 penetrates the bottom main body portion 71 in the axial direction of the bottom main body portion 71. As shown in FIG. 4, a plurality of, specifically six, inner passage holes 80 are provided in the pilot case 58 at regular intervals in a circumferential direction of the pilot case 58. As shown in FIG. 3, the plurality of inner passage holes 80 open between the inner seat portion 74 and the valve seat portion 75 in the radial direction of the bottom main body portion 71.

As shown in FIG. 2, outer passage holes 83 and 84 are formed in the pilot case 58 at a bottom surface of the seal groove 68. The outer passage holes 83 and 84 both penetrate the bottom main body portion 71 in the axial direction of the bottom main body portion 71 at a position of the bottom surface of the seal groove 68. The outer passage hole 83 is on an inner side with respect to the outer passage hole 84 in the radial direction of the pilot case 58. The outer passage hole 83 is at an inner end position of the bottom surface of the seal groove 68 in the radial direction of the pilot case 58. The outer passage hole 84 is at an outer end position of the bottom surface of the seal groove 68 in the radial direction of the pilot case 58.

As shown in FIG. 4, a plurality of, specifically three, outer passage holes 83 are provided in the pilot case 58 at regular intervals in the circumferential direction of the pilot case 58. A plurality of, specifically three, outer passage holes 84 are provided in the pilot case 58 at regular intervals in the circumferential direction of the pilot case 58. The outer passage holes 83 and the outer passage holes 84 are alternately disposed in the pilot case 58 at regular intervals in the circumferential direction of the pilot case 58. The inner passage hole 80 is aligned with one of the outer passage hole 83 and the outer passage hole 84 in position in the circumferential direction of the pilot case 58.

The inner seat portion 77 is formed on an inner circumferential side of the bottom main body portion 71. The inner seat portion 77 is annular. As shown in FIG. 3, the inner seat portion 77 protrudes from a part of the bottom main body portion 71 on the inner circumferential side to a side opposite to the inner seat portion 74 in the axial direction of the bottom main body portion 71.

The outer seat portion 78 is formed at an intermediate part of the bottom main body portion 71 in the radial direction. As shown in FIG. 4, the outer seat portion 78 protrudes, at a radially outward of the inner seat portion 77, from the bottom main body portion 71 to the same side as the inner seat portion 77 in the axial direction of the bottom main body portion 71. The outer seat portion 78 is a petal-like deformed seat that is not circular. The outer seat portion 78 has a plurality of, specifically six, seat forming portions 91. These seat forming portions 91 have the same shape and are disposed at regular intervals in the circumferential direction of the pilot case 58. The inner seat portion 77 has an annular shape with a central axis of the pilot case 58 as a center. The plurality of seat forming portions 91 extend radially from the inner seat portion 77. In the axial direction of the pilot case 58, a position of a distal end surface of the plurality of seat forming portions 91 on a side opposite to the bottom main body portion 71 is at the same position as a position of a distal end surface of the inner seat portion 77 on a side opposite to the bottom main body portion 71.

A passage recessed portion 92 is formed on an inner side of each seat forming portion 91. The passage recessed portion 92 is formed to be surrounded by a part of the inner seat portion 77 and the seat forming portion 91. The passage recessed portion 92 is recessed in the axial direction of the pilot case 58 from the distal end surface on the protruding side of the inner seat portion 77 and the distal end surface on the protruding side of the seat forming portion 91. A bottom surface of the passage recessed portion 92 is formed of the bottom main body portion 71. The passage recessed portion 92 is formed on an inner side of all the seat forming portions 91.

The inner passage hole 80 and the outer passage holes 83 and 84 are provided at positions between adjacent seat forming portions 91 in the circumferential direction of the pilot case 58. Therefore, the inner passage hole 80 and the outer passage holes 83 and 84 are provided on an outer side of the inner seat portion 77. The inner passage hole 80 and the outer passage holes 83 and 84 do not open into the passage recessed portion 92.

A passage groove 95 penetrating the inner seat portion 77 in the radial direction of the inner seat portion 77 is formed in the inner seat portion 77. The passage groove 95 is disposed at positions inside each of the plurality of seat forming portions 91 in the circumferential direction of the bottom main body portion 71. A passage in the passage groove 95 opens into the passage recessed portion 92. The passage in the passage groove 95 communicates with a passage in the passage groove 30 of the piston rod 21 shown in FIG. 2.

The damping force generation mechanism 10 has a partition member 111 (movable mechanism) in the seal groove 68. The partition member 111 has an annular shape as a whole, and is an O-ring having a circular cross section in a plane including a central axis of the annular ring. The partition member 111 is fitted in the seal groove 68 of the pilot case 58. The partition member 111 is formed of an elastic material having sealing properties and is, specifically, rubber. As shown in FIG. 3, a seal portion 112 at an inner circumference of the partition member 111 comes into pressure contact with a wall surface on a radially inner side of the seal groove 68 to seal a gap between itself and the wall surface. A seal portion 113 at an outer circumference of the partition member 111 comes into pressure contact with a wall surface on a radially outer side of the seal groove 68 to seal a gap between itself and the wall surface.

The disc 50 shown in FIG. 2 has an outer diameter larger than an outer diameter of the inner seat portion 46 of the piston 18 and smaller than an inner diameter of the valve seat portion 47. A notch 121 is formed in the disc 50. The notch 121 extends radially outward from the inner circumferential edge part of the disc 50 fitted onto the mounting shaft portion 28. A passage in the notch 121 is in constant communication with the piston-side passage 43 of the piston 18 and the passage in the passage groove 30 of the piston rod 21.

The first damping valve 52 is formed of a disc 131 and a seal member 132.

The disc 131 is made of a metal and has a bored circular flat plate shape with a constant thickness. The disc 131 is formed by press forming. An outer diameter of the disc 131 is larger than an outer diameter of the valve seat portion 47 of the piston 18. The mounting shaft portion 28 of the piston rod 21 is fitted to an inner circumferential side of the disc 131. In the first damping valve 52, the disc 131 comes into contact with the valve seat portion 47. The first damping valve 52 opens and closes an opening on the lower chamber 20 side of the piston-side passage 43 formed in the piston 18 due to the disc 131 separated from and coming into contact with the valve seat portion 47.

The seal member 132 is formed of an elastic material having sealing properties and is, specifically, rubber. The seal member 132 has an annular shape. The seal member 132 is fixed to an outer circumferential side of the disc 131. The seal member 132 is fitted to an inner circumferential surface of the cylindrical portion 66 of the pilot case 58 on the opening 67 side over the entire circumference. The seal member 132 is axially slidable with respect to the inner circumferential surface of the cylindrical portion 66. The seal member 132 constantly seals a gap between the first damping valve 52 and the cylindrical portion 66. The pilot case 58 has the opening 67 in which the first damping valve 52 is disposed.

The disc 53 has an outer diameter equal to the outer diameter of the inner seat portion 46 of the piston 18. The outer diameter of the disc 53 is smaller than a minimum inner diameter of the seal member 132.

As shown in FIG. 3, an outer diameter of the disc 54 is larger than the outer diameter of the disc 53 and smaller than the minimum inner diameter of the seal member 132. The disc 54 has a notch 141 formed from an inner circumferential edge part thereof to a position radially outward of the disc 53. A passage in the notch 141 is in constant communication with the passage in the passage groove 30 of the piston rod 21.

Of the plurality of, specifically six, discs 55, two discs on a side closest to the disc 54 in the axial direction have an outer diameter larger than an outer diameter of the disc 54. Of the six discs 55, three intermediate discs in the axial direction have an outer diameter larger than the outer diameter of the two discs on the disc 54 side. Of the six discs 55, one disc on a farthest side opposite to the disc 54 in the axial direction has an outer diameter larger than the outer diameter of the intermediate three discs. The six discs 55 as a whole increases in outer diameter with distance away from the disc 54 in the axial direction.

The disc 56 has an outer diameter equal to the outer diameter of the disc 53.

The opening/closing disc 57 has an outer diameter larger than an outer diameter of the valve seat portion 75 of the pilot case 58 and smaller than an inner diameter of an outer seat portion 76. The opening/closing disc 57 can come into contact with the inner seat portion 74 and the valve seat portion 75 of the pilot case 58. The opening/closing disc 57 closes passages in the plurality of inner passage holes 80 by being seated on the valve seat portion 75. The opening/closing disc 57 opens the passages in the plurality of inner passage holes 80 by being separated from the valve seat portion 75.

The opening/closing disc 57 has a notch 151 formed from an inner circumferential edge part that fits onto the mounting shaft portion 28 to a position that is larger in diameter than an outer diameter of the disc 56 and smaller in diameter than an outer diameter of the inner seat portion 74. A passage in the notch 151 is in constant communication with the passage in the passage groove 30 of the piston rod 21.

The seal portions 112 and 113 of the partition member 111 are simultaneously in pressure contact with the wall surfaces of the seal groove 68 on the radially inner side and outer side. Thereby, a portion surrounded by the pilot case 58, the first damping valve 52 and the discs 53 to 56, the opening/closing disc 57, and the partition member 111 forms a back pressure chamber 171. The back pressure chamber 171 is in constant communication with the passage in the passage groove 30 of the piston rod 21 via the passages in the notches 141 and 151.

Also, due to the partition member 111, a variable chamber 172 is formed between a bottom surface side of the seal groove 68 and the partition member 111. As shown in FIG. 2, the variable chamber 172 is in constant communication with the lower chamber 20 via the passages in the outer passage hole 83 and the outer passage hole 84.

The back pressure chamber 171 is formed inside the bottomed cylindrical pilot case 58 by the first damping valve 52, the discs 53 to 56, the opening/closing disc 57, and the partition member 111. The partition member 111 is provided inside the pilot case 58 and partitions the inside of the pilot case 58 into the back pressure chamber 171 and the variable chamber 172.

The disc 131 of the first damping valve 52 can be seated on the valve seat portion 47 of the piston 18. The first damping valve 52 is provided in the piston-side passage 43 formed in the piston 18 and suppresses a flow of the oil fluid L caused by sliding of the piston 18 to an extension side to generate a damping force. The first damping valve 52, together with the valve seat portion 47 of the piston 18, constitutes the first valve mechanism 41. The first damping valve 52 opens when the disc 131 thereof is separated from the valve seat portion 47. Then, the first damping valve 52 causes the oil fluid L from the piston-side passage 43 to flow into the lower chamber 20 through a space between itself and the valve seat portion 47. The piston-side passage 43 serves as an extension-side passage through which the oil fluid L in the upper chamber 19 flows due to movement of the piston 18 to the upper chamber 19 side. The piston-side passage 43 serves as an extension-side passage through which the oil fluid L as a working fluid flows from the upper chamber 19 on one side to the lower chamber 20 on the other side during the extension stroke. The extension-side first valve mechanism 41 formed of the valve seat portion 47 and the first damping valve 52 is provided in the piston-side passage 43 and suppresses a flow of the oil fluid L by opening and closing the piston-side passage 43 with the first damping valve 52, thereby generating a damping force. The lower chamber 20 is on a downstream side of the first damping valve 52 in a flow direction of the oil fluid L during the extension stroke.

In the extension-side first valve mechanism 41, neither the valve seat portion 47 nor the first damping valve 52 that comes into contact with the valve seat portion 47 has a fixed orifice formed to allow communication between the upper chamber 19 and the lower chamber 20 even when the valve seat portion 47 and the first damping valve 52 are in a contact state. In other words, a fixed orifice formed to allow constant communication between the upper chamber 19 and the lower chamber 20 is not formed in the first valve mechanism 41. The piston-side passage 43 is a passage upstream of the first damping valve 52 in a flow direction of the oil fluid L during the extension stroke.

The passage in the notch 121 of the disc 50, the passage in the passage groove 30 of the piston rod 21, the passage in the notch 141 of the disc 54, and the passage in the notch 151 of the opening/closing disc 57 constitute a back pressure chamber introduction passage 176 that branches off and extends from the piston-side passage 43. The back pressure chamber introduction passage 176 allows the upper chamber 19 and the back pressure chamber 171 to communicate with each other via a part of the piston-side passage 43. During the extension stroke, the back pressure chamber introduction passage 176 introduces the oil fluid L from the upper chamber 19 on an upstream side of the back pressure chamber 171 to the back pressure chamber 171 via a part of the piston-side passage 43.

The passages in the outer passage holes 83 and 84 and the passage in the seal groove 68, which are all provided in the bottom portion 65 of the pilot case 58, constitute a first passage 173 that extends to connect the back pressure chamber 171 and the lower chamber 20. The partition member 111 having the seal portions 112 and 113, which seal the first passage 173 with an elastic member, is provided to be movable in the first passage 173.

The back pressure chamber 171 causes an internal pressure to act on the first damping valve 52 in a direction of the piston 18, that is, in a valve closing direction in which the disc 131 is seated on the valve seat portion 47. The pilot case 58 has a bottomed cylindrical shape and forms the back pressure chamber 171 that causes the first damping valve 52 disposed on the opening 67 side to generate a biasing force in a valve closing direction.

The inside of the inner passage hole 80 of the pilot case 58 serves as a second passage 180. The opening/closing disc 57 is provided to be openable and closable between the second passage 180 and the back pressure chamber 171. The second passage 180 in the inner passage hole 80 is provided parallel to the first passage 173 in the outer passage holes 83 and 84 and in the seal groove 68. The second passage 180 is disposed on an inner circumferential side of the first passage 173 in the pilot case 58. In a state in which the opening/closing disc 57 is in contact with the valve seat portion 75 of the pilot case 58, the opening/closing disc 57 blocks a flow of the oil fluid L between the back pressure chamber 171, and the second passage 180 and the lower chamber 20. Also, in a state in which the opening/closing disc 57 is separated from the valve seat portion 75, the opening/closing disc 57 allows the flow of the oil fluid L between the back pressure chamber 171, and the second passage 180 and the lower chamber 20.

Here, when a pressure on a side of the second passage 180 and the lower chamber 20 becomes higher than a pressure on the back pressure chamber 171 side by a predetermined value or more, the opening/closing disc 57 allows a flow of the oil fluid L from the lower chamber 20 and the second passage 180 to the back pressure chamber 171 through the second passage 180. In a state in which a pressure on the back pressure chamber 171 side is higher than a pressure on the side of the second passage 180 and the lower chamber 20, the opening/closing disc 57 restricts a flow of the oil fluid L from the back pressure chamber 171 to the lower chamber 20 through the second passage 180.

The opening/closing disc 57 and the valve seat portion 75 of the pilot case 58 constitute a communication mechanism 181. One side of the second passage 180 can communicate with the back pressure chamber 171. The communication mechanism 181 is on the one side of the second passage 180 and is allowed to communicate with the lower chamber 20 side, which is the other side of the second passage 180, only when the lower chamber 20 is on the upstream side. In other words, when the lower chamber 20 is on the downstream side, the communication mechanism 181 cannot communicate with the lower chamber 20 side which is the other side of the second passage 180. Between the back pressure chamber 171 and the lower chamber 20, the communication mechanism 181 restricts a flow of the oil fluid L in one direction from the back pressure chamber 171 side to the lower chamber 20 side. On the other hand, the communication mechanism 181 allows a flow of the oil fluid L in the other direction from the lower chamber 20 side to the back pressure chamber 171 side. The communication mechanism 181 is a check valve, and the opening/closing disc 57 is a valve member thereof.

The communication mechanism 181 restricts a flow of the oil fluid L from the upper chamber 19, a part of the piston-side passage 43, the back pressure chamber introduction passage 176, and the back pressure chamber 171 to the second passage 180 and the lower chamber 20. The communication mechanism 181 allows a flow of the oil fluid L from the lower chamber 20 and the second passage 180 to the back pressure chamber 171, the back pressure chamber introduction passage 176, a part of the piston-side passage 43, and the upper chamber 19.

The second damping valve 60, which is formed of the plurality of discs 59, as a whole has an outer diameter that increases toward the pilot case 58 side in the axial direction. Of the plurality of discs 59, an outer diameter of the disc 59 on a side closest to the pilot case 58 is slightly larger than a maximum outer diameter of a distal end surface of the outer seat portion 78. The second damping valve 60 formed of the plurality of discs 59 can be separated from and seated on the outer seat portion 78.

The passage in the passage groove 30 of the piston rod 21 and the passage in the passage groove 95 and the passage recessed portion 92 of the pilot case 58 shown in FIG. 4 form a rod-side passage 191 shown in FIG. 2. The rod-side passage 191 further branches off from the back pressure chamber introduction passage 176 which branches off from the piston-side passage 43 and allows communication between the upper chamber 19 and the lower chamber 20. The outer seat portion 78 and the second damping valve 60 are provided in the rod-side passage 191 and constitute a second valve mechanism 201 that opens and closes the rod-side passage 191.

The second damping valve 60 of the second valve mechanism 201 is seated on the outer seat portion 78. During the extension stroke, the second damping valve 60 opens to provide resistance to a flow of the oil fluid L from the upper chamber 19 to the lower chamber 20 via a part of the piston-side passage 43, a part of the back pressure chamber introduction passage 176, and the rod-side passage 191. In other words, the second valve mechanism 201 suppresses the flow of the oil fluid L from the upper chamber 19 to the lower chamber 20 to generate a damping force. The second valve mechanism 201 is an extension-side damping force generation mechanism that is provided in the rod-side passage 191 and generates a damping force due to a flow of the oil fluid L.

In the extension-side second valve mechanism 201, neither the outer seat portion 78 nor the second damping valve 60 that comes into contact with the outer seat portion 78 has a fixed orifice formed to allow the rod-side passage 191 to communicate with the lower chamber 20 side even when the outer seat portion 78 and the second damping valve 60 are in a contact state. That is, a fixed orifice that is in constant communication with the lower chamber 20 is not formed in the rod-side passage 191.

An outer diameter of the disc 61 is smaller than a minimum outer diameter of the second damping valve 60.

An outer diameter of the annular member 62 is larger than the outer diameter of the disc 61. A rigidity of the annular member 62 is higher than a rigidity of the second damping valve 60.

The first valve mechanism 42 on a compression side includes one disc 221, a plurality of, specifically four, discs 222, one disc 223, one disc 224, and one annular member 225 on the inner seat portion 48 side in the axial direction of the piston 18 in order from the inner seat portion 48 side in the axial direction of the piston 18. The discs 221 to 224 and the annular member 225 are made of a metal and have a bored circular flat plate shape with a constant thickness. The discs 221 to 224 are formed by press forming. The mounting shaft portion 28 of the piston rod 21 is fitted to an inner side of all the discs 221 to 224 and the annular member 225.

The disc 221 has an outer diameter larger than an outer diameter of the inner seat portion 48 of the piston 18 and smaller than an inner diameter of the valve seat portion 49.

The plurality of discs 222 constitute a first damping valve 231. The first damping valve 231 as a whole has an outer diameter that increases toward the disc 221 side in the axial direction. Of the plurality of discs 222, the disc on a side closest to the disc 221 has an outer diameter slightly larger than an outer diameter of the valve seat portion 49 of the piston 18.

The disc 223 has an outer diameter smaller than an outer diameter of the disc with a minimum outer diameter among the plurality of discs 222.

The disc 224 has an outer diameter larger than the outer diameter of the disc 223.

The annular member 225 has an outer diameter smaller than the outer diameter of the disc 224 and larger than the outer diameter of the disc 223. The annular member 225 has a larger thickness and a higher rigidity than the disc 222. The annular member 225 is in contact with the shaft step portion 29 of the piston rod 21.

The first damping valve 231 formed of the plurality of discs 222 constitutes the first valve mechanism 42 together with the valve seat portion 49 of the piston 18. The first damping valve 231 opens by being separated from the valve seat portion 49. Then, the first damping valve 231 allows the oil fluid L from the piston-side passage 44 to flow into the upper chamber 19 through a space between itself and the valve seat portion 49. The piston-side passage 44 serves as a compression-side passage through which the oil fluid L in the lower chamber 20 flows due to movement of the piston 18 to the lower chamber 20 side. During the compression stroke, the piston-side passage 44 allows the oil fluid L as a working fluid to flow from the lower chamber 20 on one side toward the upper chamber 19 on the other side. The compression-side first valve mechanism 42 formed of the valve seat portion 49 and the first damping valve 231 is provided in the piston-side passage 44. The first valve mechanism 42 generates a damping force by opening and closing the piston-side passage 44 with the first damping valve 231 to suppress a flow of the oil fluid L.

In the compression-side first valve mechanism 42, neither the valve seat portion 49 nor the first damping valve 231 that comes into contact with the valve seat portion 49 has a fixed orifice formed to allow communication between the lower chamber 20 and the upper chamber 19 even when the valve seat portion 49 and the first damping valve 231 are in a contact state. That is, a fixed orifice that allows constant communication between the lower chamber 20 and the upper chamber 19 is not formed in the compression-side first valve mechanism 42. The disc 224 and the annular member 225 suppress deformation of the first damping valve 231 in the opening direction beyond a specified limit.

The pilot case 58 and the partition member 111 constitute a frequency sensitive mechanism 211 that makes a damping force variable in response to a frequency of reciprocation of the piston 18 (hereinafter referred to as a piston frequency). In the frequency sensitive mechanism 211, the partition member 111 moves and deforms in response to the frequency of reciprocation of the piston 18, thereby changing a volume of the back pressure chamber 171 that is in constant communication with the upper chamber 19 and a volume of the variable chamber 172 that is in constant communication with the lower chamber 20. The frequency sensitive mechanism 211 has the partition member 111 provided in the first passage 173 to be movable. The frequency sensitive mechanism 211 varies a biasing force on the first damping valve 52 by the back pressure chamber 171.

During the extension stroke, the back pressure chamber 171 side has a higher pressure than the lower chamber 20 side. Then, the partition member 111, receiving the pressure from the back pressure chamber 171, moves to the bottom surface side of the seal groove 68 and comes into contact with the bottom surface to be compressively deformed while maintaining the sealed state with the seal groove 68. Thereby, a volume of the back pressure chamber 171 increases.

During the compression stroke, the lower chamber 20 side has a higher pressure than the back pressure chamber 171 side. Then, if a differential pressure between the lower chamber 20 side and the back pressure chamber 171 side is lower than a predetermined value, the partition member 111, receiving the pressure from the lower chamber 20 side, moves to the disc 55 side and comes into contact with the disc 55 to be compressively deformed while maintaining the sealed state with the seal groove 68. Thereby, a volume of the variable chamber 172 increases. Also, during the compression stroke, when a pressure on the lower chamber 20 side becomes higher than that on the back pressure chamber 171 side by the predetermined value or more, the communication mechanism 181 opens to allow the oil fluid L to flow from the lower chamber 20 to the back pressure chamber 171.

In the piston rod 21, the annular member 225, the disc 224, the disc 223, the plurality of discs 222, the disc 221, the piston 18, the disc 50, the first damping valve 52, the disc 53, the disc 54, the plurality of discs 55, the disc 56, the opening/closing disc 57, the pilot case 58, the plurality of discs 59, the disc 61, and the annular member 62 are stacked in that order on the shaft step portion 29 with the mounting shaft portion 28 inserted through the inside of them. At that time, the pilot case 58 fits the seal member 132 of the first damping valve 52 into the cylindrical portion 66. Further, the partition member 111 is press-fitted into the seal groove 68 in advance before such an assembly of the pilot case 58 to the piston rod 21.

With the parts from the annular member 225 to the annular member 62 disposed on the piston rod 21 as described above, a nut 235 is screwed onto the male screw 31 of the mounting shaft portion 28 that protrudes from the annular member 62. Thereby, the parts from the annular member 225 to the annular member 62 stacked as described above are clamped in the axial direction by being sandwiched by the shaft step portion 29 of the piston rod 21 and the nut 235 at the inner circumferential side of them or in their entirety.

As shown in FIG. 1, the base valve 25 described above is provided between the inner cylinder 3 and the bottom member 12 of the outer cylinder 4. The base valve 25 includes a base valve member 241, a disc valve 242, a disc valve 243, and an attachment pin 244. The base valve 25 is placed on the bottom member 12 at the base valve member 241, and is fitted into the inner cylinder 3 at the base valve member 241. The base valve member 241 partitions the lower chamber 20 and the reservoir chamber 6. The disc valve 242 is provided on a lower side of the base valve member 241, that is, on the reservoir chamber 6 side. The disc valve 243 is provided on an upper side of the base valve member 241, that is, on the lower chamber 20 side. The attachment pin 244 attaches the disc valve 242 and the disc valve 243 to the base valve member 241.

The base valve member 241 has an annular shape, and the attachment pin 244 is inserted through a center thereof in the radial direction. A plurality of passage holes 245 and a plurality of passage holes 246 are formed in the base valve member 241. The plurality of passage holes 245 allow the oil fluid L to flow between the lower chamber 20 and the reservoir chamber 6. The plurality of passage holes 246 are disposed on an outer side of the plurality of passage holes 245 in a radial direction of the base valve member 241. The plurality of passage holes 246 allow the oil fluid L to flow between the lower chamber 20 and the reservoir chamber 6. The disc valve 242 on the reservoir chamber 6 side allows a flow of the oil fluid L from the lower chamber 20 to the reservoir chamber 6 through the passage holes 245. On the other hand, the disc valve 242 suppresses a flow of the oil fluid L from the reservoir chamber 6 to the lower chamber 20 through the passage holes 245. The disc valve 243 allows a flow of the oil fluid L from the reservoir chamber 6 to the lower chamber 20 through the passage holes 246. On the other hand, the disc valve 243 suppresses a flow of the oil fluid L from the lower chamber 20 to the reservoir chamber 6 through the passage holes 246.

The disc valve 242 and the base valve member 241 constitute a damping valve mechanism 247. The damping valve mechanism 247 opens during the compression stroke of the shock absorber 1 to allow the oil fluid L to flow from the lower chamber 20 to the reservoir chamber 6 and generate a damping force. The disc valve 243 and the base valve member 241 constitute a suction valve mechanism 248. The suction valve mechanism 248 opens during the extension stroke of the shock absorber 1 to allow the oil fluid L to flow from the reservoir chamber 6 into the lower chamber 20. Further, the suction valve mechanism 248 performs a function of causing the liquid to flow from the reservoir chamber 6 to the lower chamber 20 substantially without generating a damping force so that a shortage of the liquid caused mainly due to extension of the piston rod 21 from the cylinder 2 is supplemented.

Next, an operation of the shock absorber 1 including the damping force generation mechanism 10 will be described.

{Low-Frequency Minute-Low-Speed Region x1 in which Piston Frequency is Low, and Piston Speed is Lower than First Predetermined Value v1 in Extension Stroke}

In this low-frequency minute-low-speed region x1, the first valve mechanism 41 and the second valve mechanism 201 do not open. Then, the oil fluid L from the upper chamber 19 flows into the back pressure chamber 171 via a part of the piston-side passage 43 and the back pressure chamber introduction passage 176. Then, the partition member 111 of the frequency sensitive mechanism 211 moves to the bottom surface side of the seal groove 68 and comes into contact with the bottom surface to be compressively deformed. In the low-frequency minute-low-speed region x1, since the piston frequency is low and the piston 18 makes a large stroke, a large amount of the oil fluid L is introduced from the upper chamber 19 into the back pressure chamber 171 at the beginning of the stroke. Therefore, the partition member 111 of the frequency sensitive mechanism 211 moves and deforms to the bottom surface side of the seal groove 68 to near the limit, and then does not readily deform (high spring region). Also, none of the first valve mechanisms 41 and 42 and the second valve mechanism 201 has a fixed orifice that allows constant communication between the upper chamber 19 and the lower chamber 20. As a result, in the low-frequency minute-low-speed region x1, an increasing rate of the damping force with respect to an increase in the piston speed is high.

{Low-Frequency Low-Speed Region x2 in which Piston Frequency is Low, and Piston Speed is Equal to or Higher than First Predetermined Value v1 and Lower than Second Predetermined Value v2 in Extension Stroke}

In this low-frequency low-speed region x2, the oil fluid L from the upper chamber 19 largely moves and deforms the partition member 111 of the frequency sensitive mechanism 211 to the bottom surface side of the seal groove 68 as in the low-frequency minute-low-speed region x1. Thereafter, the oil fluid L from the upper chamber 19 via the piston-side passage 43 and the back pressure chamber introduction passage 176 is not readily introduced into the back pressure chamber 171. In the low-frequency low-speed region x2, the pressure in the back pressure chamber 171 is higher than that in the low-frequency minute-low-speed region x1. Therefore, in the low-frequency low-speed region x2, the oil fluid L from the upper chamber 19 flows from the piston-side passage 43, the back pressure chamber introduction passage 176, and the rod-side passage 191 to the lower chamber 20 by opening the second damping valve 60 of the second valve mechanism 201. As a result, in the low-frequency low-speed region x2, the increasing rate of the damping force with respect to an increase in the piston speed is lower than that in the low-frequency minute-low-speed region x1. In the low-frequency low-speed region x2, since the partition member 111 of the frequency sensitive mechanism 211 moves and deforms to near the limit, the pressure in the back pressure chamber 171 becomes high. Therefore, a biasing force from the back pressure chamber 171 is large, and therefore opening of the first damping valve 52 of the first valve mechanism 41 is limited.

{Low-Frequency Medium-High-Speed Region x3 in which Piston Frequency is Low, and Piston Speed is Equal to Higher than Second Predetermined Value v2 in Extension Stroke}

In this low-frequency medium-high-speed region x3, the oil fluid L from the upper chamber 19 opens the second damping valve 60 of the second valve mechanism 201 and flows into the lower chamber 20 via a part of the piston-side passage 43, a part of the back pressure chamber introduction passage 176, and the rod-side passage 191 as in the low-frequency low-speed region x2. In this way, in the low-frequency medium-high-speed region x3, since the oil fluid L flows from the rod-side passage 191 to the lower chamber 20, an increase in pressure of the back pressure chamber 171 due to the oil fluid L introduced into the back pressure chamber 171 via a part of the piston-side passage 43 and the back pressure chamber introduction passage 176 is suppressed. In contrast, since a force in a valve opening direction exerted to the first valve mechanism 41 from the piston-side passage 43 increases, the oil fluid L from the upper chamber 19 passes through the piston-side passage 43 and flows into the lower chamber 20 by opening the first damping valve 52 of the first valve mechanism 41. As a result, in the low-frequency medium-high-speed region x3, the increasing rate of the damping force with respect to an increase in the piston speed is lower than that in the low-frequency low-speed region x2.

{High-Frequency Minute-Low-Speed Region x4 in which Piston Frequency is Higher than Low Frequency Described Above, and Piston Speed is Lower than Third Predetermined Value v3 in Extension Stroke}

In this high-frequency minute-low-speed region x4, the first valve mechanism 41 and the second valve mechanism 201 do not open. Then, as in the low-frequency minute-low-speed region x1, the oil fluid L from the upper chamber 19 flows into the back pressure chamber 171 via a part of the piston-side passage 43 and the back pressure chamber introduction passage 176. Then, the partition member 111 of the frequency sensitive mechanism 211 moves and deforms to the bottom surface side of the seal groove 68. In the high-frequency minute-low-speed region x4, the piston frequency is high, and a stroke of the piston 18 is small. Therefore, an amount of the oil fluid L introduced from the upper chamber 19 into the back pressure chamber 171 is less than that in the low-frequency minute-low-speed region x1. Therefore, the partition member 111 of the frequency sensitive mechanism 211 is likely to deform without deforming to near the limit (low spring region). As a result, the oil fluid L introduced from the upper chamber 19 into the back pressure chamber 171 can be absorbed by the movement and deformation of the partition member 111. Therefore, in the high-frequency minute-low-speed region x4, although the increasing rate of the damping force with respect to an increase in the piston speed is high, the damping force at the same piston speed is lower than that in the low-frequency minute-low-speed region x1, thereby exhibiting soft characteristics.

{High-Frequency Low-Medium-High-Speed Region x5 in which Piston Frequency is Higher than Low Frequency Described Above, and Piston Speed is Equal to or Higher than Third Predetermined Value v3 in Extension Stroke}

In this high-frequency low-medium-high-speed region x5, the oil fluid L from the upper chamber 19 moves and deforms the partition member 111 of the frequency sensitive mechanism 211 to the bottom surface side of the seal groove 68 as in the high-frequency minute-low-speed region x4. In the high-frequency low-medium-high-speed region x5, since an amount of the oil fluid L introduced into the back pressure chamber 171 is small, an increase in pressure of the back pressure chamber 171 is suppressed by the deformation of the partition member 111. Therefore, the biasing force from the back pressure chamber 171 to the first damping valve 52 of the first valve mechanism 41 becomes smaller, making it easier for the first damping valve 52 to open. Therefore, the oil fluid L from the upper chamber 19 passes through the piston-side passage 43 and flows into the lower chamber 20 by opening the first damping valve 52 of the first valve mechanism 41. As a result, in the high-frequency low-medium-high-speed region x5, the increasing rate of the damping force with respect to an increase in the piston speed is lower than that in the high-frequency minute-low-speed region x4. Also, in the high-frequency low-medium-high-speed region x5, the damping force at the same piston speed is lower than that in the low-frequency low-speed region x2 and the low-frequency medium-high-speed region x3, thereby exhibiting soft characteristics. In the high-frequency low-medium-high-speed region x5, since the increase in pressure of the back pressure chamber 171 is suppressed, the second valve mechanism 201 remains in a closed state.

{Low-Frequency Minute-Low-Speed Region y1 in which Piston Frequency is Low, and Piston Speed is Lower than Fourth Predetermined Value v4 in Compression Stroke}

In this low-frequency minute-low-speed region y1, the first valve mechanism 42 and the communication mechanism 181 do not open. Then, the oil fluid L from the lower chamber 20 is introduced into the variable chamber 172 through the passages in the outer passage holes 83 and 84 in the first passage 173. Then, the partition member 111 of the frequency sensitive mechanism 211 moves to the disc 55 side and is deformed. In the low-frequency minute-low-speed region y1, since the piston frequency is low and the piston 18 makes a large stroke, a large amount of the oil fluid L is introduced from the lower chamber 20 into the variable chamber 172 at the beginning of the stroke. Therefore, the partition member 111 of the frequency sensitive mechanism 211 moves and deforms to the disc 55 side to near the limit, and does not readily deform (high spring region). Also, none of the first valve mechanism 41 and 42 and the second valve mechanism 201 has a fixed orifice that allows constant communication between the lower chamber 20 and the upper chamber 19. As a result, in the low-frequency minute-low-speed region y1, the increasing rate of the damping force with respect to an increase in the piston speed is high, thereby exhibiting hard characteristics.

{Low-Frequency Low-Speed Region y2 in which Piston Frequency is Low, and Piston Speed is Equal to or Higher than Fourth Predetermined Value v4 and Lower than Fifth Predetermined Value v5 in Compression Stroke}

In this low-frequency low-speed region y2, the oil fluid L from the lower chamber 20 moves and deforms the partition member 111 to the disc 55 side to near the limit as in the low-frequency minute-low-speed region y1, and then flows from the second passage 180 to the upper chamber 19 via the back pressure chamber 171, the back pressure chamber introduction passage 176, and a part of the piston-side passage 43 by opening the communication mechanism 181. As a result, in the low-frequency low-speed region y2, the increasing rate of the damping force with respect to an increase in the piston speed is lower than that in the low-frequency minute-low-speed region y1.

{Low-Frequency Medium-High-Speed Region y3 in which Piston Frequency is Low, and Piston Speed is Equal to or Higher than Fifth Predetermined Value v5 in Compression Stroke}

In this low-frequency medium-high-speed region y3, as in the low-frequency low-speed region y2, the oil fluid L from the lower chamber 20 flows from the second passage 180 to the upper chamber 19 via the back pressure chamber 171, the back pressure chamber introduction passage 176, and a part of the piston-side passage 43 by opening the communication mechanism 181. In addition to this, in the low-frequency low-medium-high-speed region y3, the oil fluid L from the lower chamber 20 passes through the piston-side passage 44 and flows into the upper chamber 19 by opening the first damping valve 231 of the first valve mechanism 42. As a result, in the low-frequency medium-high-speed region y3, the increasing rate of the damping force with respect to an increase in the piston speed is lower than that in the low-frequency low-speed region y2.

{High-Frequency Minute-Low-Speed Region y4 in which Piston Frequency is Higher than Low Frequency Described Above, and Piston Speed is Lower than Sixth Predetermined Value v6 in Compression Stroke}

In this high-frequency minute-low-speed region y4, the first valve mechanism 42 and the communication mechanism 181 do not open. Then, the oil fluid L from the lower chamber 20 is introduced into the variable chamber 172 through the passages in the outer passage holes 83 and 84 in the first passage 173. Then, the partition member 111 of the frequency sensitive mechanism 211 moves and deforms to the disc 55 side. In the high-frequency minute-low-speed region y4, since the piston frequency is high and the stroke of the piston 18 is small, an amount of the oil fluid L introduced from the lower chamber 20 to the variable chamber 172 is less than that in the low-frequency minute-low-speed region y1. Therefore, the partition member 111 of the frequency sensitive mechanism 211 is likely to move and deform without deforming to near the limit (low spring region). As a result, the oil fluid L introduced from the lower chamber 20 into the variable chamber 172 can be absorbed by the movement and deformation of the partition member 111. Therefore, in the high-frequency minute-low-speed region y4, the damping force at the same piston speed has softer characteristics than that in the low-frequency minute-low-speed region y1.

{High-Frequency Low-Speed Region y5 in which Piston Frequency is Higher than Low Frequency Described Above, and Piston Speed is Equal to or Higher than Sixth Predetermined Value v6 and Lower than Seventh Predetermined Value v7 in Compression Stroke}

In this high-frequency low-speed region y5, the oil fluid L from the lower chamber 20 flows from the first passage 173 to the upper chamber 19 via the back pressure chamber 171, the back pressure chamber introduction passage 176, and a part of the piston-side passage 43 by opening the communication mechanism 181. In the high-frequency low-speed region y5, the increasing rate of the damping force with respect to an increase in the piston speed is lower than that in the high-frequency minute-low-speed region y4. Also, in the high-frequency low-speed region y5, the damping force at the same piston speed is lower and softer than that in the low-frequency low-speed region y2.

{High-Frequency Medium-High-Speed Region y6 in which Piston Frequency is Higher than Low Frequency Described Above, and Piston Speed is Equal to or Higher than Seventh Predetermined Value v7 in Compression Stroke}

In this high-frequency medium-high-speed region y6, as in the high-frequency low-speed region y5, the oil fluid L from the lower chamber 20 flows from the first passage 173 to the upper chamber 19 via the back pressure chamber 171, the back pressure chamber introduction passage 176, and a part of the piston-side passage 43 by opening the communication mechanism 181. In addition to that, in the high-frequency medium-high-speed region y6, the oil fluid L from the lower chamber 20 passes through the piston-side passage 44 and flows into the upper chamber 19 by opening the first damping valve 231 of the first valve mechanism 42. As a result, in the high-frequency medium-high-speed region y6, the increasing rate of the damping force with respect to an increase in the piston speed is lower than that in the high-frequency low-speed region y5. Also, in the high-frequency medium-high-speed region y6, the damping force at the same piston speed is lower and softer than that in the low-frequency medium-high-speed region y3.

During the compression stroke, the shock absorber 1 has characteristics in which the damping force characteristics due to the damping valve mechanism 247 are also combined.

The above-described Patent Documents 1 and 2 disclose a damping force generation mechanism provided in a shock absorber, and configured to apply back pressure to a damping force generation member in a valve closing direction. Also, a frequency sensitive mechanism is provided in the damping force generation mechanism of Patent Document 1. Incidentally, there is a demand for suppressing an increase in size of the damping force generation mechanism.

The damping force generation mechanism 10 of the first embodiment has the pilot case 58, the frequency sensitive mechanism 211, the second passage 180, and the communication mechanism 181. The pilot case 58 has a bottomed cylindrical shape and forms the back pressure chamber 171 that causes the first damping valve 52 disposed on the opening 67 side to generate a biasing force in a valve closing direction. The frequency sensitive mechanism 211 is configured such that the partition member 111, having the seal portions 112 and 113 that seal the first passage 173 with an elastic member, is movably provided in the first passage 173 that is provided in the bottom portion 65 of the pilot case 58 to connect the back pressure chamber 171 and the lower chamber 20, thereby varying the biasing force in a valve closing direction on the first damping valve 52. The second passage 180 is provided parallel to the first passage 173 and can communicate with the back pressure chamber 171 at one side. The communication mechanism 181 is on the one side of the second passage 180 and is allowed to communicate with the other side of the second passage 180 only when the lower chamber 20 is on the upstream side.

As described above, the damping force generation mechanism 10 is provided with the first passage 173 that extends to connect the back pressure chamber 171 and the lower chamber 20 in the bottom portion 65 of the pilot case 58 that forms the back pressure chamber 171. Then, the damping force generation mechanism 10 varies the biasing force in a valve closing direction on the first damping valve 52 by the frequency sensitive mechanism 211 in which the partition member 111 that seals the first passage 173 with the seal portions 112 and 113 is movably provided in the first passage 173. Therefore, the damping force generation mechanism 10, even with the frequency sensitive mechanism 211, can suppress an increase in size.

Here, during the compression stroke described above, the damping force generation mechanism 10 is configured such that the partition member 111 of the frequency sensitive mechanism 211 moves and elastically deforms in a direction that reduces the back pressure chamber 171. Therefore, when the stroke is reversed from the compression stroke to the extension stroke, the partition member 111 needs to return from the elastically deformed state and move in a direction that expands the back pressure chamber 171. As a result, if it is assumed that the communication mechanism 181 is not provided in the damping force generation mechanism 10, introduction of the oil fluid L from the upper chamber 19 to the back pressure chamber 171 performed via a part of the piston-side passage 43 and the back pressure chamber introduction passage 176 takes time, and thereby it takes time to increase the pressure in the back pressure chamber 171. Then, the closed state of the first damping valve 52, which is biased in a valve closing direction by the pressure of the back pressure chamber 171, becomes unstable. Thereby, the oil fluid L flows from the piston-side passage 43 to the lower chamber 20 by easily opening the first damping valve 52, thereby causing a delay in the rise of the damping force when the stroke reverses from the compression stroke to the extension stroke.

In contrast, since the communication mechanism 181 is provided in the damping force generation mechanism 10, when the stroke is reversed from the compression stroke to the extension stroke, the communication mechanism 181 opens to allow the oil fluid L to be introduced from the lower chamber 20, which has a higher pressure than the upper chamber 19 during the compression stroke, into the back pressure chamber 171 via the second passage 180, thereby allowing the pressure in the back pressure chamber 171 to be quickly increased. Then, the closed state of the first damping valve 52, which is biased in a valve closing direction by the pressure of the back pressure chamber 171, becomes stable. Thereby, it is possible to suppress the delay in the rise of the damping force that occurs when the stroke is reversed from the compression stroke to the extension stroke.

Also, since the second passage 180 that is opened and closed by the communication mechanism 181 is disposed on an inner circumference side of the bottom portion 65 with respect to the first passage 173, an increase in size of the damping force generation mechanism 10 in the radial direction can be suppressed.

Also, since an O-ring is used as the partition member 111 having the seal portions 112 and 113 that seal the first passage 173 with an elastic member, the damping force generation mechanism 10 is subject to large compressive deformation. From this, effects of suppressing a delay in the rise of the damping force that occurs when the stroke is reversed from the compression stroke to the extension stroke by providing the communication mechanism 181 are high.

### Second Embodiment

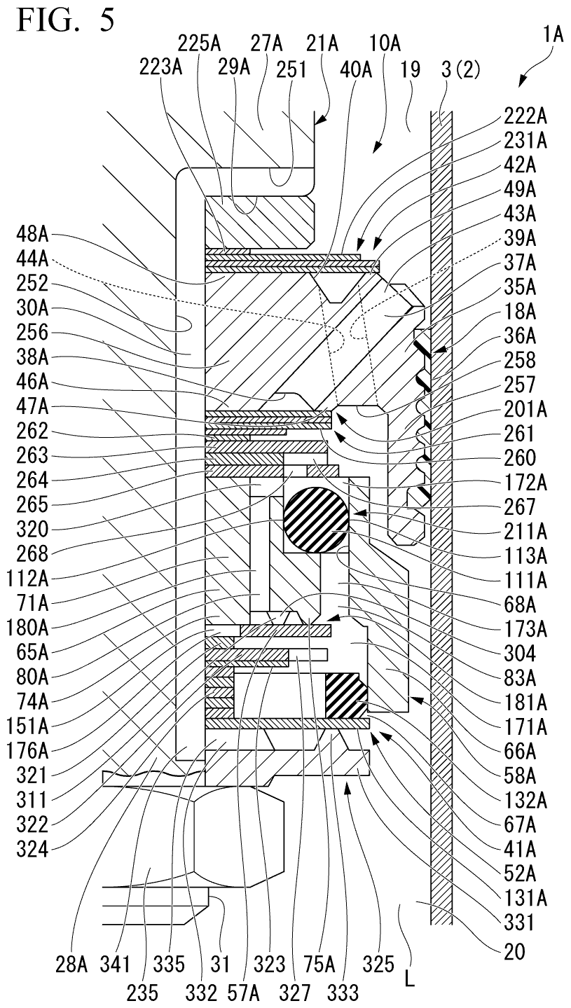

Next, a second embodiment will be described mainly on the basis of FIGS. 5 to 9, focusing on differences from the first embodiment. Further, parts common to those in the first embodiment will be denoted by the same terms and the same reference signs.

As shown in FIG. 5, a shock absorber 1A including a damping force generation mechanism 10A of the second embodiment has a piston rod 21A, which is partially different from the piston rod 21, instead of the piston rod 21. The piston rod 21A has a main shaft portion 27A, which is partially different from the main shaft portion 27, instead of the main shaft portion 27. The main shaft portion 27A has, instead of the shaft step portion 29, a shaft step portion 29A which differs from the shaft step portion 29 in that a radial groove 251 extending in a radial direction is formed.

The piston rod 21A has a mounting shaft portion 28A, which is partially different from the mounting shaft portion 28, instead of the mounting shaft portion 28. The mounting shaft portion 28A differs from the mounting shaft portion 28 in that an axial groove 252 communicating with the radial groove 251 and extending in the axial direction is formed instead of the passage groove 30. The radial groove 251 and the axial groove 252 form a passage groove 30A that is continuously formed from the shaft step portion 29A to an outer circumferential portion of the mounting shaft portion 28A. A male screw 31 is formed on an outer circumferential portion of an end part of the mounting shaft portion 28A on a side opposite to the main shaft portion 27A with respect to the passage grooves 30A in an axial direction of the mounting shaft portion 28A. In the passage groove 30A, the radial groove 251 formed in the shaft step portion 29 opens to the upper chamber 19.

The damping force generation mechanism 10A is provided in the shock absorber TA instead of the damping force generation mechanism 10. The damping force generation mechanism 10A has a piston 18A instead of the piston 18. As in the piston 18, the piston 18A is slidably fitted into an inner cylinder 3 of a cylinder 2 and partitions the inside of the inner cylinder 3 into two chambers, an upper chamber 19 and a lower chamber 20.

The piston 18A has a piston main body 35A and a slide member 36A. The piston main body 35A is made of a metal and is seamlessly and integrally formed. The piston main body 35A is annular and formed by sintering. The piston main body 35A of the piston 18A is fitted onto the mounting shaft portion 28A of the piston rod 21A. The slide member 36A is made of synthetic resin and has an annular shape. The slide member 36A is integrally attached to an outer circumferential surface of the piston main body 35A. The piston 18A slides with respect to the inner cylinder 3 with the slide member 36A in contact with the inner cylinder 3.

The piston main body 35A has a main body base portion 256 and a main body cylindrical portion 257. The main body base portion 256 has a bored disc shape. The main body cylindrical portion 257 has a cylindrical shape and extends to one side in an axial direction of the main body base portion 256 from an outer circumferential portion of the main body base portion 256. The piston main body 35A allows the mounting shaft portion 28A of the piston rod 21A to be fitted to an inner circumferential portion of the main body base portion 256.

In the piston main body 35A, the main body cylindrical portion 257 side of the main body base portion 256 in the axial direction and an inner circumferential side of the main body cylindrical portion 257 form a recessed portion 258. The recessed portion 258 is recessed in an axial direction of the piston main body 35A from one end of the piston main body 35A in the axial direction. Therefore, the piston 18A has the recessed portion 258 in which an axial dimension in a predetermined range on a radially inner side is made smaller than that in other regions. The piston main body 35A is configured such that the main body cylindrical portion 257 extends from the main body base portion 256 to the lower chamber 20 side between the upper chamber 19 and the lower chamber 20. The slide member 36A is attached across outer circumferential portions of both the main body base portion 256 and the main body cylindrical portion 257.

A passage hole 37A, a passage groove 38A, a passage hole 39A and a passage groove 40A are provided in the main body base portion 256 of the piston main body 35A.

The passage hole 37A penetrates the main body base portion 256 in the axial direction of the main body base portion 256. A plurality of passage holes 37A are formed in the main body base portion 256 at intervals in a circumferential direction of the main body base portion 256.

The passage hole 39A penetrates the main body base portion 256 in the axial direction of the main body base portion 256. A plurality of passage holes 39A are formed in the main body base portion 256 at intervals in the circumferential direction of the main body base portion 256. In the main body base portion 256, the passage holes 37A and the passage holes 39A are alternately formed one by one at a regular pitch in the circumferential direction of the main body base portion 256.

The passage groove 38A is formed in the main body base portion 256 in an annular shape in the circumferential direction of the main body base portion 256. The passage groove 38A is formed at one end part of the main body base portion 256 on the main body cylindrical portion 257 side in the axial direction. All the passage holes 37A open to the passage groove 38A at end parts on the main body cylindrical portion 257 side in the axial direction of the main body base portion 256.

The passage groove 40A is formed in the main body base portion 256 in an annular shape in the circumferential direction of the main body base portion 256. The passage groove 40A is formed at the other end part of the main body base portion 256 on a side opposite to the main body cylindrical portion 257 in the axial direction. All the passage holes 39A open to the passage groove 40A at end parts on a side opposite to the main body cylindrical portion 257 in the axial direction of the main body base portion 256.

End parts of the plurality of passage holes 37A on a side opposite to the passage groove 38A in the axial direction of the main body base portion 256 open to an outer side of the passage groove 40A in the radial direction of the main body base portion 256. End parts of the plurality of passage holes 39A on a side opposite to the passage groove 40A in the axial direction of the main body base portion 256 open to an outer side of the passage groove 38A in the radial direction of the main body base portion 256. In the piston 18A, the inside of the plurality of passage holes 37A and the inside of the passage groove 38A form a piston-side passage 43A. In the piston 18A, the inside of the plurality of passage holes 39A and the inside of the passage groove 40A form a piston-side passage 44A.

The damping force generation mechanism 10A has a piston valve mechanism 201A provided for the piston-side passage 43A of the piston 18A. The piston valve mechanism 201A opens and closes the piston-side passage 43A to generate a damping force. The piston valve mechanism 201A is provided on the lower chamber 20 side of the piston 18A in the axial direction of the piston 18A. The piston-side passage 43A serves as a passage through which the oil fluid flows from the upper chamber 19 toward the lower chamber 20 when the piston 18A moves to the upper chamber 19 side. In other words, the piston-side passage 43A serves as an extension-side passage through which the oil fluid flows from the upper chamber 19 to the lower chamber 20 during an extension stroke of the shock absorber TA. The piston valve mechanism 201A is an extension-side damping force generation unit that generates a damping force by suppressing a flow of the oil fluid through the piston-side passage 43A.

The damping force generation mechanism 10A has a first valve mechanism 42A provided for the piston-side passage 44A of the piston 18A. The first valve mechanism 42A opens and closes the piston-side passage 44A to generate a damping force. The first valve mechanism 42A is provided on the upper chamber 19 side of the piston 18A in the axial direction of the piston 18A. The piston-side passage 44A serves as a passage through which the oil fluid flows from the lower chamber 20 toward the upper chamber 19 when the piston 18A moves to the lower chamber 20 side. In other words, the piston-side passage 44A serves as a compression-side passage through which the oil fluid flows from the lower chamber 20 toward the upper chamber 19 during a compression stroke of the shock absorber TA. The first valve mechanism 42A serves as a compression-side damping force generation unit that generates a damping force by suppressing a flow of the oil fluid through the piston-side passage 44A.

An inner seat portion 46A and a valve seat portion 47A are formed radially inward of the main body cylindrical portion 257 at an axial end part of the main body base portion 256 on the lower chamber 20 side. The inner seat portion 46A has an annular shape. The valve seat portion 47A also has an annular shape. The inner seat portion 46A is disposed inward of the opening of the passage groove 38A on the lower chamber 20 side in the radial direction of the main body base portion 256. The valve seat portion 47A is disposed outward of the opening of the passage groove 38A on the lower chamber 20 side in the radial direction of the main body base portion 256. The valve seat portion 47A constitutes a part of the piston valve mechanism 201A.

An inner seat portion 48A and a valve seat portion 49A are formed at an axial end part of the main body base portion 256 on the upper chamber 19 side, that is, an axial end part of the piston main body 35A on the upper chamber 19 side. The inner seat portion 48A has an annular shape. The valve seat portion 49A also has an annular shape. The inner seat portion 48A is disposed inward of the opening of the passage groove 40A on the upper chamber 19 side in the radial direction of the main body base portion 256. The valve seat portion 49A is disposed outward of the opening of the passage groove 40A on the upper chamber 19 side in the radial direction of the main body base portion 256. The valve seat portion 49A constitutes a part of the first valve mechanism 42A.

In the main body base portion 256, openings in all the passage holes 39A on the lower chamber 20 side are disposed on a side of the valve seat portion 47A opposite to the passage groove 38A in the radial direction of the main body base portion 256. In the main body base portion 256, openings of all the passage holes 37A on the upper chamber 19 side are disposed on a side of the valve seat portion 49A opposite to the passage groove 40A in the radial direction of the main body base portion 256.

The damping force generation mechanism 10A has a damping valve 261 formed of a plurality of, specifically four, discs 260 on the lower chamber 20 side in the axial direction of the main body base portion 256. The damping force generation mechanism 10A has one disc 262, one disc 263, one disc 264, and one disc 265 on a side of the damping valve 261 opposite to the main body base portion 256 in the axial direction in order from the damping valve 261 side. The discs 260 and 262 to 265 are all made of a metal and are formed by press forming. The discs 260 and 262 to 265 all have a bored flat plate shape with a constant thickness. The discs 260 and 262 to 265 all have the mounting shaft portion 28A of the piston rod 21A fitted to an inner circumferential side thereof.

The damping valve 261 as a whole decreases in outer diameter with distance away from the main body base portion 256 in the axial direction. The inner seat portion 46A and the valve seat portion 47A of the piston 18A come into contact with the disc 260 of the damping valve 261 closest to the main body base portion 256. The damping valve 261 opens and closes the piston-side passage 43A provided in the piston 18A by being separated from and seated on the valve seat portion 47A, thereby generating a damping force. The damping valve 261 constitutes the extension-side piston valve mechanism 201A. In the piston valve mechanism 201A, a fixed orifice that allows the piston-side passage 43A to constantly communicate with the lower chamber 20 is not provided between the damping valve 261 and the valve seat portion 47A.

The disc 262 has an outer diameter smaller than an outer diameter of the disc with a minimum outer diameter among the plurality of discs 260 constituting the damping valve 261.

The disc 263 has an outer diameter larger than the outer diameter of the disc 262.

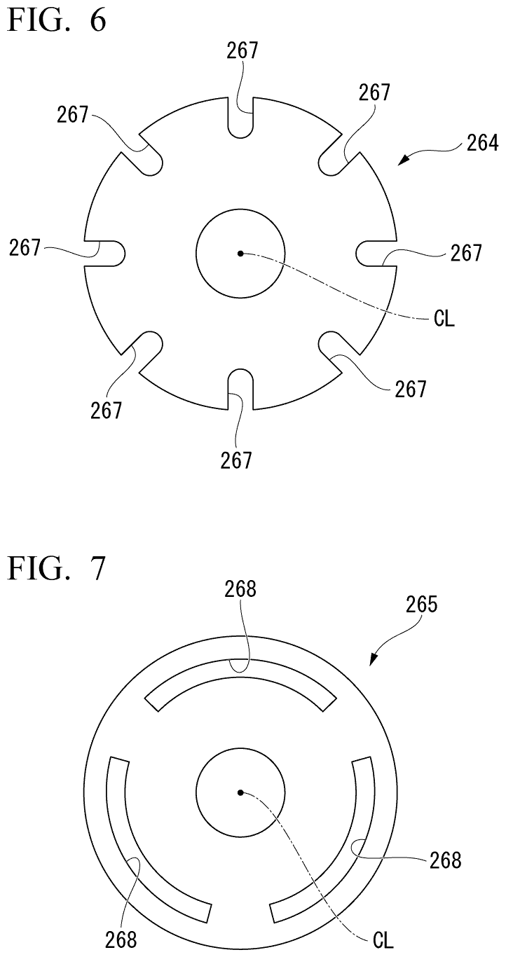

The disc 264 has an outer diameter equal to the outer diameter of the disc 263. The disc 264 has a notch 267 formed on an outer circumferential side thereof. As shown in FIG. 6, a plurality of, specifically eight, notches 267 are provided in the disc 264 at regular intervals in a circumferential direction of the disc 264.

As shown in FIG. 5, the disc 265 has an outer diameter equal to the outer diameters of the discs 263 and 264. The disc 265 has a passage hole 268 formed at an intermediate position in the radial direction. As shown in FIG. 7, the passage hole 268 has an arcuate shape that is concentric with the disc 265. A plurality of, specifically three, passage holes 268 are provided in the disc 265 at regular intervals in a circumferential direction of the disc 265. As shown in FIG. 5, inner portions of the notches 267 and the passage holes 268 are aligned in position in a radial direction of the discs 264 and 265. Therefore, the notch 267 and the passage hole 268 communicate with each other.

The damping force generation mechanism 10A has a first damping valve 231A formed of a plurality of, specifically three, discs 222A on the upper chamber 19 side in the axial direction of the piston 18A. The damping force generation mechanism 10A has one disc 223A on a side of the first damping valve 231A opposite to the piston 18A in the axial direction. The damping force generation mechanism 10A has an annular member 225A on a side of the disc 223A opposite to the first damping valve 231A in the axial direction.

The discs 222A and 223A and the annular member 225A are all made of a metal. The discs 222A and 223A both have a flat plate shape with a constant thickness and are both annular. The annular member 225A has an annular shape. The discs 222A and 223A and the annular member 225A all have the mounting shaft portion 28A of the piston rod 21A fitted to an inner circumferential side thereof.

The first damping valve 231A as a whole decreases in outer diameter with distance away from the main body base portion 256 in the axial direction.

The disc 223A has an outer diameter smaller than an outer diameter of the disc with a minimum outer diameter among the plurality of discs 222A. The annular member 225A has an outer diameter larger than the outer diameter of the disc 223A and has an outer diameter smaller than an outer diameter of the disc with the minimum outer diameter among the plurality of discs 222A. The annular member 225A has a larger thickness and a higher rigidity than each of the discs 222A constituting the first damping valve 231A. The annular member 225A is in contact with the shaft step portion 29A of the piston rod 21 A.

The valve seat portion 49A of the piston 18A comes into contact with an outer circumferential side of the disc 222A that is closest to the main body base portion 256 in the axial direction of the first damping valve 231A. The first damping valve 231A opens and closes the piston-side passage 44A provided in the piston 18A by being separated from and seated on the valve seat portion 49A, thereby generating a damping force. The first damping valve 231A closes an opening on the upper chamber 19 side which is one side of the piston-side passage 44A. The first damping valve 231A constitutes the compression-side first valve mechanism 42A. In the first valve mechanism 42A, a fixed orifice that allows the piston-side passage 44A to constantly communicate with the upper chamber 19 is not provided between the first damping valve 231A and the valve seat portion 49A. The annular member 225A comes into contact with the first damping valve 231A when the first damping valve 231A deforms in an opening direction, and suppresses deformation of the first damping valve 231A beyond a specified limit.

The damping force generation mechanism 10A has a pilot case 58A (biasing force generation member) on a side of the disc 265 opposite to the disc 264 in the axial direction. The pilot case 58A is made of a metal and is seamlessly and integrally formed by sintering. The pilot case 58A has a bottomed cylindrical shape, and has a bottom portion 65A and a cylindrical portion 66A.

The bottom portion 65A has a bored disc shape and has the mounting shaft portion 28A of the piston rod 21A fitted to an inner circumferential portion thereof. The cylindrical portion 66A is cylindrical and extends to one side in the axial direction of the bottom portion 65A from an outer circumferential portion of the bottom portion 65A. The pilot case 58A has an opening 67A on a side of the cylindrical portion 66A opposite to the bottom portion 65A in the axial direction.

The bottom portion 65A has a bottom main body portion 71A, an inner seat portion 74A, an intermediate seat portion 304, and a valve seat portion 75A.

The bottom main body portion 71A has a bored disc shape and has the mounting shaft portion 28A of the piston rod 21A fitted to an inner circumferential side thereof.

The inner seat portion 74A, the intermediate seat portion 304, and the valve seat portion 75A are provided on the cylindrical portion 66A side in an axial direction of the bottom main body portion 71A and on an inner side of the cylindrical portion 66A in a radial direction of the bottom main body portion 71A. The inner seat portion 74A, the intermediate seat portion 304, and the valve seat portion 75A protrude from the bottom main body portion 71A to the cylindrical portion 66A side in the axial direction of the bottom main body portion 71A.

The inner seat portion 74A is provided on an inner circumferential side of the bottom portion 65A. The inner seat portion 74A has an annular shape.

The intermediate seat portion 304 is provided outward of the inner seat portion 74A in a radial direction of the bottom portion 65A. The intermediate seat portion 304 has an annular shape that surrounds the inner seat portion 74A. The intermediate seat portion 304 includes a passage groove 311 formed to penetrate the intermediate seat portion 304 in a radial direction of the intermediate seat portion 304. A plurality of passage grooves 311 are formed in the intermediate seat portion 304 at regular intervals in a circumferential direction of the intermediate seat portion 304.

The valve seat portion 75A is provided outward of the intermediate seat portion 304 in the radial direction of the bottom portion 65A. The valve seat portion 75A has an annular shape that surrounds the intermediate seat portion 304.

A seal groove 68A is formed in the bottom main body portion 71A on a side opposite to the cylindrical portion 66A in the axial direction. The seal groove 68A is annular and is formed on an outer circumferential side of the bottom main body portion 71A. The bottom main body portion 71A has an outer passage hole 83A that penetrates the bottom main body portion 71A in the axial direction from a radially outer portion of a bottom surface of the seal groove 68A. A plurality of outer passage holes 83A are formed in the bottom main body portion 71A at regular intervals in the circumferential direction. The outer passage hole 83A opens between the cylindrical portion 66A and the valve seat portion 75A in the radial direction of the bottom main body portion 71A.

The bottom main body portion 71A has an inner passage hole 80A that penetrates the bottom main body portion 71A in the axial direction on a radially inner side of the seal groove 68A. A plurality of inner passage holes 80A are provided in the bottom main body portion 71A at regular intervals in a circumferential direction of the bottom main body portion 71A. The inner passage hole 80A opens between the inner seat portion 74A and the intermediate seat portion 304 in the radial direction of the bottom main body portion 71A. The inner passage hole 80A is inward of the outer passage hole 83A in a radial direction of the pilot case 58A.

A passage groove 320 that allows communication between the inner passage hole 80A and an opening side of the seal groove 68A is formed in the bottom main body portion 71A on a side opposite to the cylindrical portion 66A in the axial direction.

The pilot case 58A comes into contact with the disc 265 at an end part of the bottom main body portion 71A on a side opposite to the cylindrical portion 66A in the axial direction. At that time, the disc 265 covers the opening of the seal groove 68A except for an outer portion thereof in the radial direction. Also, at that time, the passage hole 268 of the disc 265 communicates with the radially inner portion of the opening of the seal groove 68A.

The damping force generation mechanism 10A has a partition member 111A (movable mechanism) in the seal groove 68A. The partition member 111A has an annular shape as a whole, and is an O-ring having a circular cross section in a plane including a central axis of the annular ring. The partition member 111A is formed of an elastic material having sealing properties and is, specifically, rubber. The partition member 111A is fitted in the seal groove 68A. A seal portion 112A at an inner circumference of the partition member 111A comes into pressure contact with a wall surface on a radially inner side of the seal groove 68A to seal a gap between itself and the wall surface. A seal portion 113A at an outer circumference of the partition member 111A comes into pressure contact with a wall surface on a radially outer side of the seal groove 68A to seal a gap between itself and the wall surface. The partition member 111A moves in an axial direction of the partition member 111A within the seal groove 68A. The partition member 111A elastically deforms in the axial direction of the partition member 111 A within the seal groove 68A.

The damping force generation mechanism 10A has one opening/closing disc 57A, one disc 321, one disc 322, one disc 323, a plurality of, specifically five, discs 324, one first damping valve 52A (first damping force generation member), and one seat forming member 325 on the inner seat portion 74A side in an axial direction of the pilot case 58A in order from the inner seat portion 74A side in the axial direction of the pilot case 58A.

The opening/closing disc 57A, the discs 321 to 324, and the seat forming member 325 are all made of a metal. The opening/closing disc 57A and the discs 321 to 324 all have a bored circular flat plate shape with a constant thickness and are formed by press forming. The first damping valve 52A and the seat forming member 325 are both annular. The first damping valve 52A, the opening/closing disc 57A, the discs 321 to 324, and the seat forming member 325 all have the mounting shaft portion 28A of the piston rod 21A fitted inside.

The opening/closing disc 57A has an outer diameter larger than an outer diameter of the valve seat portion 75A of the pilot case 58A. The opening/closing disc 57A can come into contact with the inner seat portion 74A, the intermediate seat portion 304, and the valve seat portion 75A of the pilot case 58A. The opening/closing disc 57A closes passages in the plurality of inner passage holes 80A by being seated on the valve seat portion 75A. The opening/closing disc 57A opens the passages in the plurality of inner passage holes 80A by being separated from the valve seat portion 75A. The opening/closing disc 57A includes a notch 151A formed to extend in a radial direction of the opening/closing disc 57A within a range of the inner seat portion 74A from the inner circumferential edge part that fits onto the mounting shaft portion 28A.

The disc 321 has an outer diameter smaller than an outer diameter of the opening/closing disc 57A and smaller than an outer diameter of the inner seat portion 74A of the pilot case 58A. The disc 321 has an outer diameter that does not cover an outer end part of the notch 151A in the radial direction of the opening/closing disc 57A.

The disc 322 has an outer diameter larger than the outer diameter of the disc 321. The disc 322 has a notch 327 formed at an outer circumferential portion.

The disc 323 has an outer diameter smaller than the outer diameter of the disc 322.

The disc 324 has an outer diameter smaller than the outer diameter of the disc 323.

The first damping valve 52A is formed of a disc 131A and a seal member 132A.

The disc 131 A is made of a metal and have a bored circular flat plate shape with a constant thickness. The disc 131A is formed by press forming. The mounting shaft portion 28A of the piston rod 21A is fitted to an inner circumferential side of the disc 131 A.

The seal member 132A is formed of an elastic material having sealing properties and is, specifically, rubber. The seal member 132A has an annular shape. The seal member 132A is fixed to an outer circumferential side of the disc 131A. The seal member 132A is fitted to an inner circumferential surface of the cylindrical portion 66A of the pilot case 58A on the opening 67A side over the entire circumference. The seal member 132A is axially slidable with respect to the inner circumferential surface of the cylindrical portion 66A. The seal member 132A constantly seals a gap between the first damping valve 52A and the cylindrical portion 66A. The first damping valve 52A is disposed in the pilot case 58A at the opening 67A.

The seat forming member 325 is made of a metal and has an annular shape. The seat forming member 325 is seamlessly and integrally formed by sintering. The seat forming member 325 has a member main body portion 331, an inner seat portion 332, and a valve seat portion 333.

The member main body portion 331 has a bored disc shape and has the mounting shaft portion 28A of the piston rod 21A fitted to an inner circumferential portion thereof.

The inner seat portion 332 protrudes from an inner circumferential edge part of the member main body portion 331 to one axial side of the member main body portion 331. The inner seat portion 332 has an annular shape. A passage groove 335 penetrating the inner seat portion 332 in the radial direction is formed in the inner seat portion 332. The passage groove 335 communicates with the passage groove 30A of the piston rod 21 A.

The valve seat portion 333 protrudes from an outer circumferential side of the member main body portion 331 in the axial direction of the member main body portion 331. The valve seat portion 333 has an annular shape surrounding the inner seat portion 332. The valve seat portion 333 protrudes from the member main body portion 331 to the same side as the inner seat portion 332 in the axial direction of the member main body portion 331.

The seat forming member 325 is oriented such that the inner seat portion 332 and the valve seat portion 333 are positioned on the first damping valve 52A side in the axial direction. A nut 235 comes into contact with a side of the seat forming member 325 opposite to the first damping valve 52A in the axial direction.

In the first damping valve 52A, an outer diameter of the disc 131A is larger than an outer diameter of the valve seat portion 333. In the first damping valve 52A, the disc 131A comes into contact with the valve seat portion 333.

A passage in the passage groove 30A of the piston rod 21A, a passage in the passage groove 335 of the seat forming member 325, and a passage between the inner seat portion 332 and the valve seat portion 333 of the seat forming member 325 constitute a rod-side passage 341. The first damping valve 52A opens and closes the rod-side passage 341 due to the disc 131A separated from and coming into contact with the valve seat portion 333.

The first damping valve 52A is provided in the rod-side passage 341 and suppresses a flow of the oil fluid L caused by sliding of the piston 18A to the extension side, thereby generating a damping force. The first damping valve 52A, together with the valve seat portion 333 of the seat forming member 325, constitutes a first valve mechanism 41A. The first damping valve 52A opens due to the disc 131A thereof separated from the valve seat portion 333. Then, the first damping valve 52A allows the oil fluid L from the rod-side passage 341 to flow into the lower chamber 20 through a gap between itself and the valve seat portion 333. The rod-side passage 341 serves as the extension-side passage through which the oil fluid L in the upper chamber 19 flows due to movement of the piston 18A to the upper chamber 19 side. Through the rod-side passage 341, the oil fluid L as a working fluid flows from the upper chamber 19 on one side to the lower chamber 20 on the other side during the extension stroke. The extension-side first valve mechanism 41A formed of the valve seat portion 333 and the first damping valve 52A is provided in the rod-side passage 341, and generates a damping force by opening and closing the rod-side passage 341 with the first damping valve 52A to suppress a flow of the oil fluid L.

In the extension-side first valve mechanism 41A, neither the valve seat portion 333 nor the first damping valve 52A that comes into contact with the valve seat portion 333 has a fixed orifice formed to allow communication between the upper chamber 19 and the lower chamber 20 even when the valve seat portion 333 and the first damping valve 52A are in a contact state. That is, a fixed orifice that allows constant communication between the upper chamber 19 and the lower chamber 20 is not formed in the extension-side first valve mechanism 41A. The rod-side passage 341 serves as a passage upstream of the first damping valve 52A in a flow direction of the oil fluid L during the extension stroke. The lower chamber 20 is on a downstream side of the first damping valve 52A in the flow direction of the oil fluid L during the extension stroke.

The seal portions 112A and 113A of the partition member 111 A are simultaneously in pressure contact with the respective wall surfaces on the radially inner and outer sides of the seal groove 68A. Thereby, a portion surrounded by the pilot case 58A, the first damping valve 52A, the opening/closing disc 57A, the discs 321 to 324, and the partition member 111A serves as a back pressure chamber 171A. The back pressure chamber 171A constantly communicates with the passage in the passage groove 30A of the piston rod 21A via a passage in the notch 151A of the opening/closing disc 57A.

Also, due to the partition member 111A, a variable chamber 172A is formed between the partition member 111A of the seal groove 68A and the disc 265. The variable chamber 172A is in constant communication with the lower chamber 20 via a passage between an outer circumferential portion of the disc 265 and the seal groove 68A. The variable chamber 172A is in constant communication with the lower chamber 20 via the passage hole 268 of the disc 265 and a passage in the notch 267 of the disc 264.

The back pressure chamber 171A is formed inside the bottomed cylindrical pilot case 58A by the first damping valve 52A, the opening/closing disc 57A, the discs 321 to 324, and the partition member 111A. The partition member 111 A is provided inside the pilot case 58A and partitions the inside of the pilot case 58A into the back pressure chamber 171A and the variable chamber 172A.

The passage in the notch 151A of the opening/closing disc 57A constitutes a back pressure chamber introduction passage 176A that branches off from the rod-side passage 341 and communicates with the back pressure chamber 171A. The back pressure chamber introduction passage 176A allows communication between the upper chamber 19 and the back pressure chamber 171A via the rod-side passage 341. During the extension stroke, the back pressure chamber introduction passage 176A introduces the oil fluid L from the upper chamber 19, which is upstream of the back pressure chamber 171A, into the back pressure chamber 171A via the rod-side passage 341.

A passage in the outer passage hole 83A provided in the bottom portion 65A of the pilot case 58A, a passage in the seal groove 68A, a passage in the passage hole 268 of the disc 265 and the notch 267 of the disc 264, and the passage between the outer circumferential portion of the disc 265 and the seal groove 68A constitute a first passage 173A that extends to connect the back pressure chamber 171A and the lower chamber 20. The partition member 111A having the seal portions 112A and 113A that seal the first passage 173A with an elastic member is movably provided in the first passage 173A.

The back pressure chamber 171A causes an internal pressure to act on the first damping valve 52A in a direction of the seat forming member 325, that is, in a valve closing direction in which the disc 131A is seated on the valve seat portion 333. The pilot case 58A has a bottomed cylindrical shape and forms the back pressure chamber 171 A that causes the first damping valve 52A disposed on the opening 67A side to generate a biasing force in a valve closing direction.

The inside of the plurality of inner passage holes 80A and the inside of the passage groove 320 of the pilot case 58A form a second passage 180A. The second passage 180A communicates with the variable chamber 172A. The opening/closing disc 57A is provided to be openable and closable between the second passage 180A and the back pressure chamber 171A. The second passage 180A is provided parallel to the first passage 173A. The second passage 180A is disposed on an inner circumferential side of the first passage 173A in the pilot case 58A. In a state in which the opening/closing disc 57A is in contact with the valve seat portion 75A of the pilot case 58A, the opening/closing disc 57A blocks a flow of the oil fluid L between the back pressure chamber 171A, and the second passage 180A and the lower chamber 20. Also, in a state in which the opening/closing disc 57A is separated from the valve seat portion 75A, the opening/closing disc 57A allows the flow of the oil fluid L between the back pressure chamber 171A, and the second passage 180A and the lower chamber 20.

Here, when a pressure on a side of the second passage 180A and the lower chamber 20 becomes higher than a pressure on the back pressure chamber 171A side by a predetermined value or more, the opening/closing disc 57A allows a flow of the oil fluid L from the lower chamber 20 and the second passage 180A to the back pressure chamber 171A. In a state in which a pressure on the back pressure chamber 171A side is higher than a pressure on the side of the second passage 180A and the lower chamber 20, the opening/closing disc 57A restricts a flow of the oil fluid L from the back pressure chamber 171A to the lower chamber 20 through the second passage 180A.

The opening/closing disc 57A and the valve seat portion 75A of the pilot case 58A constitute a communication mechanism 181A. One side of the second passage 180A can communicate with the back pressure chamber 171 A. The communication mechanism 181A is on the one side of the second passage 180A and is allowed to communicate with the lower chamber 20 side, which is the other side of the second passage 180A, only when the lower chamber 20 is on the upstream side. In other words, when the lower chamber 20 is on the downstream side, the communication mechanism 181A cannot communicate with the lower chamber 20 side which is the other side of the second passage 180A. Between the back pressure chamber 171A and the variable chamber 172A, the communication mechanism 181A restricts a flow of the oil fluid L in one direction from the back pressure chamber 171A side to the variable chamber 172A side through the second passage 180A. On the other hand, the communication mechanism 181A allows a flow of the oil fluid L in the other direction from the variable chamber 172A side to the back pressure chamber 171A side through the second passage 180A. The communication mechanism 181A is a check valve, and the opening/closing disc 57A is a valve member thereof.

The communication mechanism 181A restricts a flow of the oil fluid L from the upper chamber 19, a part of the rod-side passage 341, the back pressure chamber introduction passage 176A, and the back pressure chamber 171A to the second passage 180A and the lower chamber 20. The communication mechanism 181A allows the flow of the oil fluid L from the lower chamber 20 and the second passage 180A to the back pressure chamber 171A, the back pressure chamber introduction passage 176A, a part of the rod-side passage 341, and the upper chamber 19.

The pilot case 58A and the partition member 111A constitute a frequency sensitive mechanism 211A that makes a damping force variable in response to a piston frequency. In the frequency sensitive mechanism 211 A, the partition member 111 A moves and deforms in response to the frequency of reciprocation of the piston 18A, thereby changing a volume of the back pressure chamber 171A that is in constant communication with the upper chamber 19 and a volume of the variable chamber 172A that is in constant communication with the lower chamber 20. The frequency sensitive mechanism 211A has the partition member 111A provided in the first passage 173A to be movable. The frequency sensitive mechanism 211 A varies a biasing force on the first damping valve 52A by the back pressure chamber 171A.

During the extension stroke, the back pressure chamber 171A side has a higher pressure than the lower chamber 20 side. Then, the partition member 111A, receiving the pressure from the back pressure chamber 171A, moves to the disc 265 side and comes into contact with the disc 265 to be compressively deformed while maintaining the sealed state with the seal groove 68A. Thereby, a volume of the back pressure chamber 171A increases.

During the compression stroke, the lower chamber 20 side has a higher pressure than the back pressure chamber 171A side. Then, if a differential pressure between the lower chamber 20 side and the back pressure chamber 171A side is lower than a predetermined value, the partition member 111A, receiving the pressure from the lower chamber 20 side, moves to the bottom surface side of the seal groove 68A and comes into contact with the bottom surface to be compressively deformed while maintaining the sealed state with the seal groove 68A. Thereby, a volume of the variable chamber 172A increases. Also, during the compression stroke, when a pressure on the lower chamber 20 side becomes higher than that on the back pressure chamber 171A side by the predetermined value or more, the communication mechanism 181 A opens to allow the oil fluid L to flow from the lower chamber 20 to the back pressure chamber 171A through the second passage 180A.

Next, an operation of the shock absorber 1A including the damping force generation mechanism 10A will be described.

### {Low-Frequency Minute-Low-Speed Region x1 in Extension Stroke}

In a low-frequency minute-low-speed region x1, the first valve mechanism 41A and the piston valve mechanism 201A do not open. Then, the oil fluid L from the upper chamber 19 flows into the back pressure chamber 171A via a part of the rod-side passage 341 and the back pressure chamber introduction passage 176A. Then, the partition member 111A of the frequency sensitive mechanism 211A moves to the disc 265 side and deforms. In the low-frequency minute-low-speed region x1, a large amount of the oil fluid L is introduced from the upper chamber 19 to the back pressure chamber 171A at the beginning of the stroke. Therefore, the partition member 111A of the frequency sensitive mechanism 211A moves and deforms to the disc 265 side to near the limit, and then does not readily deform. Also, none of the first valve mechanisms 41A and 42A and the piston valve mechanism 201A has a fixed orifice that allows constant communication between the upper chamber 19 and the lower chamber 20. As a result, in the low-frequency minute-low-speed region x1, an increasing rate of the damping force with respect to an increase in the piston speed is high.

### {Low-Frequency Low-Speed Region x2 in Extension Stroke}

In a low-frequency low-speed region x2, the oil fluid L from the upper chamber 19 largely moves and deforms the partition member 111 A of the frequency sensitive mechanism 211A to the disc 265 side as in the low-frequency minute-low-speed region x1. Thereafter, the oil fluid L from the upper chamber 19 via the rod-side passage 341 and the back pressure chamber introduction passage 176A is not readily introduced into the back pressure chamber 171A. In the low-frequency low-speed region x2, the pressure in the back pressure chamber 171A is higher than that in the low-frequency minute-low-speed region x1. Therefore, in the low-frequency low-speed region x2, the oil fluid L from the upper chamber 19 flows from the piston-side passage 43A to the lower chamber 20 by opening the damping valve 261 of the piston valve mechanism 201A. As a result, in the low-frequency low-speed region x2, the increasing rate of the damping force with respect to an increase in the piston speed is lower than that in the low-frequency minute-low-speed region x1. In the low-frequency low-speed region x2, since the partition member 111A of the frequency sensitive mechanism 211A moves and deforms to near the limit, the pressure in the back pressure chamber 171A becomes high. Therefore, a biasing force from the back pressure chamber 171A is large, and therefore opening of the first damping valve 52A of the first valve mechanism 41 is limited.

### {Low-Frequency Medium-High-Speed Region x3 in Extension Stroke}

In a low-frequency medium-high-speed region x3, the oil fluid L from the upper chamber 19 flows from the piston-side passage 43A to the lower chamber 20 by opening the damping valve 261 of the piston valve mechanism 201A as in the low-frequency low-speed region x2. In this way, in the low-frequency medium-high-speed region x3, since the oil fluid L flows from the piston-side passage 43A to the lower chamber 20, an increase in pressure of the back pressure chamber 171A due to the oil fluid L introduced into the back pressure chamber 171A via a part of the rod-side passage 341 and the back pressure chamber introduction passage 176A is suppressed. In contrast, since a force in a valve opening direction exerted to the first valve mechanism 41A from the rod-side passage 341 increases, the oil fluid L from the upper chamber 19 passes through the rod-side passage 341 and flows into the lower chamber 20 by opening the first damping valve 52A of the first valve mechanism 41A. As a result, in the low-frequency medium-high-speed region x3, the increasing rate of the damping force with respect to an increase in the piston speed is lower than that in the low-frequency low-speed region x2.

### {High-Frequency Minute-Low-Speed Region x4 in Extension Stroke}

In a high-frequency minute-low-speed region x4, the first valve mechanism 41A and the piston valve mechanism 201A do not open. Then, the oil fluid L from the upper chamber 19 flows into the back pressure chamber 171A via a part of the rod-side passage 341 and the back pressure chamber introduction passage 176A as in the low-frequency minute-low-speed region x1. Then, the partition member 111A of the frequency sensitive mechanism 211A moves and deforms to the disc 265 side. In the high-frequency minute-low-speed region x4, an amount of the oil fluid L introduced from the upper chamber 19 to the back pressure chamber 171A is less than that in the low-frequency minute-low-speed region x1. Therefore, the partition member 111A of the frequency sensitive mechanism 211A is likely to deform without deforming to near the limit. As a result, the oil fluid L introduced from the upper chamber 19 into the back pressure chamber 171A can be absorbed by the movement and deformation of the partition member 111A. Therefore, in the high-frequency minute-low-speed region x4, although the increasing rate of the damping force with respect to an increase in the piston speed is high, the damping force at the same piston speed is lower than that in the low-frequency minute-low-speed region x1, thereby exhibiting soft characteristics.

### {High-Frequency Low-Medium-High-Speed Region x5 in Extension Stroke}

In a high-frequency low-medium-high-speed region x5, the oil fluid L from the upper chamber 19 moves and deforms the partition member 111 A of the frequency sensitive mechanism 211A to the disc 265 side as in the high-frequency minute-low-speed region x4. In the high-frequency low-medium-high-speed region x5, since an amount of the oil fluid L introduced into the back pressure chamber 171 A is small, an increase in pressure of the back pressure chamber 171A is suppressed by the deformation of the partition member 111A. Therefore, the biasing force from the back pressure chamber 171A to the first damping valve 52A of the first valve mechanism 41A becomes smaller, making it easier for the first damping valve 52A to open. Therefore, the oil fluid L from the upper chamber 19 passes through the rod-side passage 341 and flows into the lower chamber 20 by opening the first damping valve 52A of the first valve mechanism 41A. As a result, in the high-frequency low-medium-high-speed region x5, the increasing rate of the damping force with respect to an increase in the piston speed is lower than that in the high-frequency minute-low-speed region x4. Also, in the high-frequency low-medium-high-speed region x5, the damping force at the same piston speed is lower than that in the low-frequency low-speed region x2 and the low-frequency medium-high-speed region x3, thereby exhibiting soft characteristics. In the high-frequency low-medium-high-speed region x5, the piston valve mechanism 201A remains in a closed state.

### {Low-Frequency Minute-Low-Speed Region y1 in Compression Stroke}

In a low-frequency minute-low-speed region y1, the first valve mechanism 42A and the communication mechanism 181A do not open. Then, the oil fluid L from the lower chamber 20 is introduced into the variable chamber 172A of the first passage 173A. Then, the partition member 111A of the frequency sensitive mechanism 211A moves to the bottom surface side of the seal groove 68A and deforms. In the low-frequency minute-low-speed region y1, a large amount of the oil fluid L is introduced from the lower chamber 20 into the variable chamber 172A at the beginning of the stroke. Therefore, the partition member 111A of the frequency sensitive mechanism 211 A moves and deforms to the bottom surface side of the seal groove 68A to near the limit, and does not readily deform. Also, none of the first valve mechanism 41A and 42A and the piston valve mechanism 201A has a fixed orifice that allows constant communication between the lower chamber 20 and the upper chamber 19. As a result, in the low-frequency minute-low-speed region y1, the increasing rate of the damping force with respect to an increase in the piston speed is high, thereby exhibiting hard characteristics.

### {Low-Frequency Low-Speed Region y2 in Compression Stroke}

In a low-frequency low-speed region y2, the oil fluid L from the lower chamber 20 moves and deforms the partition member 111A to the bottom surface side of the seal groove 68A to near the limit as in the low-frequency minute-low-speed region y1, and then flows from the second passage 180A to the upper chamber 19 via the back pressure chamber 171A, the back pressure chamber introduction passage 176A, and a part of the rod-side passage 341 by opening the communication mechanism 181A. As a result, in the low-frequency low-speed region y2, the increasing rate of the damping force with respect to an increase in the piston speed is lower than that in the low-frequency minute-low-speed region y1.

### {Low-Frequency Medium-High-Speed Region y3 in Compression Stroke}

In a low-frequency medium-high-speed region y3, as in the low-frequency low-speed region y2, the oil fluid L from the lower chamber 20 flows from the second passage 180A to the upper chamber 19 via the back pressure chamber 171 A, the back pressure chamber introduction passage 176A, and a part of the rod-side passage 341 by opening the communication mechanism 181A. In addition to this, in the low-frequency low-medium-high-speed region y3, the oil fluid L from the lower chamber 20 passes through the piston-side passage 44 and flows into the upper chamber 19 by opening the first damping valve 231A of the first valve mechanism 42A. As a result, in the low-frequency medium-high-speed region y3, the increasing rate of the damping force with respect to an increase in the piston speed is lower than that in the low-frequency low-speed region y2.

### {High-Frequency Minute-Low-Speed Region y4 in Compression Stroke}

In a high-frequency minute-low-speed region y4, the first valve mechanism 42A and the communication mechanism 181A do not open. Then, the oil fluid L from the lower chamber 20 is introduced into the variable chamber 172A. Then, the partition member 111A of the frequency sensitive mechanism 211A moves to the bottom surface side of the seal groove 68A and deforms. In the high-frequency minute-low-speed region y4, since the piston frequency is high and a stroke of the piston 18A is small, an amount of the oil fluid L introduced from the lower chamber 20 to the variable chamber 172A is less than that in the low-frequency minute-low-speed region y1. Therefore, the partition member 111 A of the frequency sensitive mechanism 211 A is likely to move and deform without deforming to near the limit. As a result, the oil fluid L introduced from the lower chamber 20 into the variable chamber 172A can be absorbed by the movement and deformation of the partition member 111 A. Therefore, in the high-frequency minute-low-speed region y4, the damping force at the same piston speed has softer characteristics than in the low-frequency minute-low-speed region y1.

### {High-Frequency Low-Speed Region y5 in Compression Stroke}

In a high-frequency low-speed region y5, the oil fluid L from the lower chamber 20 flows from the first passage 173A to the upper chamber 19 via the back pressure chamber 171A, the back pressure chamber introduction passage 176A, and a part of the rod-side passage 341 by opening the communication mechanism 181A. In the high-frequency low-speed region y5, the increasing rate of the damping force with respect to an increase in the piston speed is lower than that in the high-frequency minute-low-speed region y4. Also, in the high-frequency low-speed region y5, the damping force at the same piston speed is lower and softer than that in the low-frequency low-speed region y2.

### {High-Frequency Medium-High-Speed Region y6 in Compression Stroke}

In the high-frequency medium-high-speed region y6, as in the high-frequency low-speed region y5, the oil fluid L from the lower chamber 20 flows from the first passage 173A to the upper chamber 19 via the back pressure chamber 171A, the back pressure chamber introduction passage 176A, and a part of the rod-side passage 341 by opening the communication mechanism 181A. In addition to that, in the high-frequency medium-high-speed region y6, the oil fluid L from the lower chamber 20 passes through the piston-side passage 44A and flows into the upper chamber 19 by opening the first damping valve 231 A of the first valve mechanism 42A. As a result, in the high-frequency medium-high-speed region y6, the increasing rate of the damping force with respect to an increase in the piston speed is lower than that in the high-frequency low-speed region y5. Also, in the high-frequency medium-high-speed region y6, the damping force at the same piston speed is lower and softer than that in the low-frequency medium-high-speed region y3.

The damping force generation mechanism 10A of the second embodiment has the pilot case 58A, the frequency sensitive mechanism 211A, the second passage 180A, and the communication mechanism 181 A. The pilot case 58A has a bottomed cylindrical shape and forms the back pressure chamber 171A that causes the first damping valve 52A disposed on the opening 67A side to generate a biasing force in a valve closing direction. The frequency sensitive mechanism 211A is configured such that the partition member 111A, having the seal portions 112A and 113A that seal the first passage 173A with an elastic member, is movably provided in the first passage 173A that is provided in the bottom portion 65A of the pilot case 58A and connecting the back pressure chamber 171A and the lower chamber 20, thereby varying the biasing force in a valve closing direction on the first damping valve 52A. The second passage 180A is provided parallel to the first passage 173A, and one side thereof can communicate with the back pressure chamber 171A. The communication mechanism 181A is on the one side of the second passage 180A and is allowed to communicate with the other side of the second passage 180A only when the lower chamber 20 is on the upstream side.

As described above, the damping force generation mechanism 10A is configured such that the first passage 173A, which extends to connect the back pressure chamber 171 A and the lower chamber 20, is provided in the bottom portion 65A of the pilot case 58A that forms the back pressure chamber 171A. Then, the damping force generation mechanism 10A varies the biasing force in a valve closing direction on the first damping valve 52A by the frequency sensitive mechanism 211 A in which the partition member 111A that seals the first passage 173A with the seal portions 112A and 113A is movably provided in the first passage 173A. Therefore, the damping force generation mechanism 10A, even with the frequency sensitive mechanism 211 A, can suppress an increase in size.

Also, since the communication mechanism 181 A is provided in the damping force generation mechanism 10A, when the stroke is reversed from the compression stroke to the extension stroke, the communication mechanism 181A opens to allow the oil fluid L to be introduced from the lower chamber 20, which has a higher pressure than the upper chamber 19 during the compression stroke, into the back pressure chamber 171A via the second passage 180A, thereby allowing the pressure in the back pressure chamber 171A to be quickly increased. Then, the closed state of the first damping valve 52A, which is biased in a valve closing direction by the pressure of the back pressure chamber 171A, becomes stable. Thereby, it is possible to suppress a delay in the rise of the damping force that occurs when the stroke is reversed from the compression stroke to the extension stroke.

Also, since the second passage 180A that is opened and closed by the communication mechanism 181A is disposed on an inner circumference side of the bottom portion 65A with respect to the first passage 173A, an increase in size of the damping force generation mechanism 10A in the radial direction can be suppressed.

Also, since an O-ring is used as the partition member 111A having the seal portions 112A and 113A that seal the first passage 173A with an elastic member, the damping force generation mechanism 10A is subject to a large compressive deformation. From this, provision of the communication mechanism 181A is highly effective in suppressing the delay in the rise of the damping force that occurs when the stroke is reversed from the compression stroke to the extension stroke.

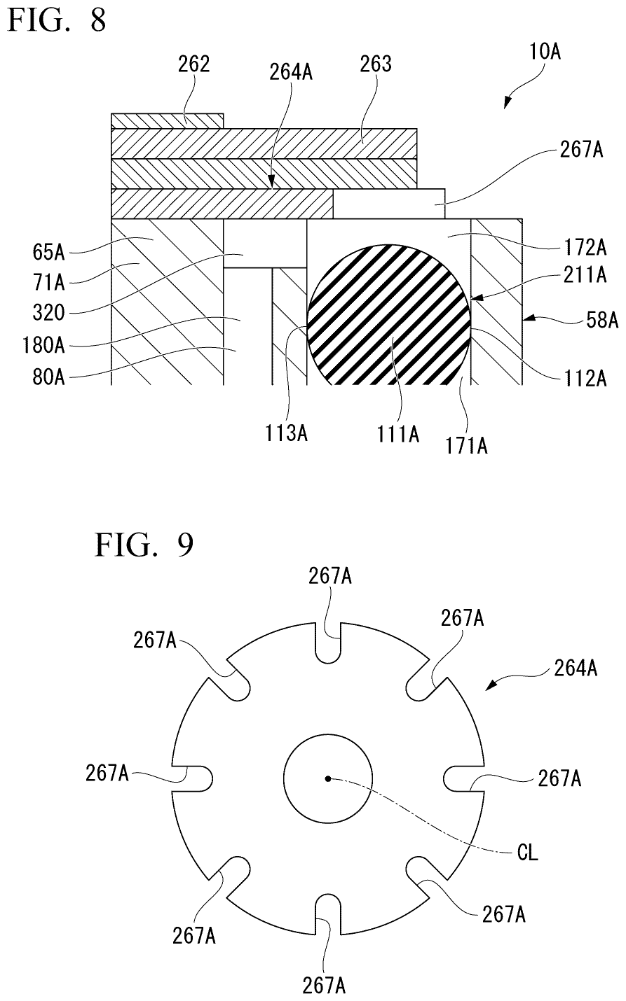

Further, in the damping force generation mechanism 10A, a sintered disc 264A may be provided instead of the discs 264 and 265 as shown in FIG. 8. The disc 264A has the same outer diameter as the disc 264. A notch 267A is formed at an outer circumferential portion of the disc 264A as shown in FIG. 9. A plurality of notches 267A are provided in the disc 264A at regular intervals in the circumferential direction. Passages in the plurality of notches 267A of the disc 264A allow communication between the variable chamber 172A and the lower chamber 20. In this case, it is also possible to secure rigidity by using a plurality of discs 263.

### Third Embodiment

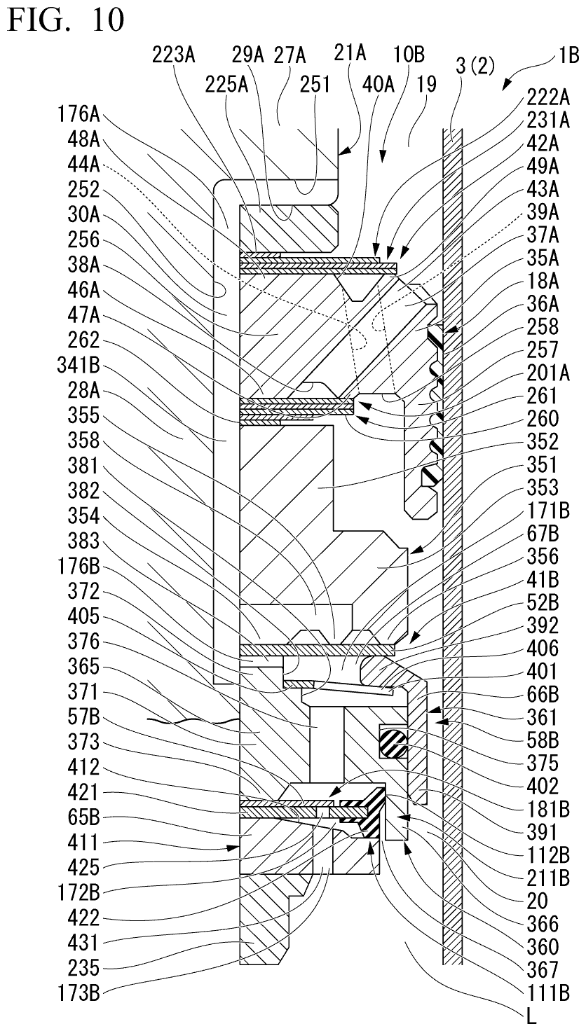

Next, a third embodiment will be described mainly on the basis of FIGS. 10 to 12, focusing on differences from the second embodiment. Further, parts common to those in the second embodiment will be denoted by the same terms and the same reference signs.

As shown in FIG. 10, in a shock absorber 1B including a damping force generation mechanism 10B of the third embodiment, a partial configuration of the damping force generation mechanism 10B differs from that of the damping force generation mechanism 10A. The damping force generation mechanism 10B differs from the damping force generation mechanism 10A in configuration between a disc 262 and a nut 235 in an axial direction of a piston rod 21 A.

The damping force generation mechanism 10B has a seat forming member 351 and a first damping valve 52B (first damping force generation member) in order from the disc 262 side in the axial direction of the piston rod 21A.

The seat forming member 351 is made of a metal, and is seamlessly and integrally formed as a whole by sintering. The seat forming member 351 has a barrel portion 352, a flange portion 353, an inner seat portion 354, an intermediate seat portion 355, and a valve seat portion 356.

The barrel portion 352 has a cylindrical shape, and has a mounting shaft portion 28A of the piston rod 21A fitted to an inner circumferential side thereof.

The flange portion 353 extends outward in a radial direction of the barrel portion 352 from one end side of the barrel portion 352 in the axial direction. The flange portion 353 has a disc shape.

The inner seat portion 354 protrudes in the axial direction of the barrel portion 352 from an inner circumferential side of an end part of the barrel portion 352 on the same side as the flange portion 353 in the axial direction. The inner seat portion 354 has an annular shape.

The intermediate seat portion 355 protrudes to the same side as the inner seat portion 354 in the axial direction of the barrel portion 352 and the flange portion 353 from the vicinity of a boundary between the barrel portion 352 and the flange portion 353. The intermediate seat portion 355 has an annular shape that surrounds the inner seat portion 354 from an outer side in the radial direction.

The valve seat portion 356 protrudes to the same side as the intermediate seat portion 355 in the axial direction of the flange portion 353 from an outer circumferential portion of the flange portion 353. The valve seat portion 356 has an annular shape that surrounds the intermediate seat portion 355 from an outer side in the radial direction.

The seat forming member 351 includes a passage grooves 358 formed by the inner seat portion 354, the intermediate seat portion 355, and end parts of the barrel portion 352 and the flange portion 353 on a side of the inner seat portion 354 and the intermediate seat portion 355 in the axial direction. The passage groove 358 penetrates the inner seat portion 354 and the intermediate seat portion 355 in a radial direction thereof. The passage groove 358 communicates with a passage groove 30A of the piston rod 21A.

The seat forming member 351 is in contact with the disc 262 at an end part of the barrel portion 352 on a side opposite to the flange portion 353 in the axial direction.

The first damping valve 52B is made of a metal and have a bored circular flat plate shape with a constant thickness. The first damping valve 52B is formed by press forming. The mounting shaft portion 28A of the piston rod 21A is fitted into the inside of the first damping valve 52B. The first damping valve 52B has an outer diameter equal to an outer diameter of the valve seat portion 356. The first damping valve 52B opens and closes a passage between itself and the valve seat portion 356 by being separated from and seated on the valve seat portion 356.

The damping force generation mechanism 10B has a case member 360 and a pressing member 361 on a side of the first damping valve 52B opposite to the seat forming member 351 in the axial direction.

The case member 360 is made of a metal, and is seamlessly and integrally formed as a whole by sintering. The case member 360 has a bottomed cylindrical shape, and has a bottom portion 365 and a cylindrical portion 366.

The bottom portion 365 has a bored disc shape, and has the mounting shaft portion 28A of the piston rod 21A fitted to an inner circumferential side thereof.

The cylindrical portion 366 has a cylindrical shape and extends to one side in an axial direction of the bottom portion 365 from an outer circumferential portion of the bottom portion 365. The case member 360 has an opening 367 on a side of the cylindrical portion 366 opposite to the bottom portion 365 in the axial direction.

The bottom portion 365 has a bottom main body portion 371, a one-side seat portion 372, and another-side seat portion 373.

The bottom main body portion 371 has a bored disc shape, and has the mounting shaft portion 28A of the piston rod 21A fitted to an inner circumferential side thereof. An annular groove 375 having an annular shape is formed on an outer circumferential portion of the bottom main body portion 371. A passage hole 376 penetrating the bottom main body portion 371 in the axial direction is formed in the bottom main body portion 371. The passage hole 376 is inward of the annular groove 375 in a radial direction of the bottom main body portion 371.

The one-side seat portion 372 protrudes to a side of the bottom main body portion 371 opposite to the cylindrical portion 366 in the axial direction from an inner circumferential side of an end part of the bottom main body portion 371 on a side opposite to the cylindrical portion 366 in the axial direction. The one-side seat portion 372 has an annular shape. The case member 360 comes into contact with an inner circumferential side of the first damping valve 52B at the one-side seat portion 372.

The one-side seat portion 372 has a large diameter portion 381 and a small diameter portion 382. In an axial direction of the one-side seat portion 372, the large diameter portion 381 is on the bottom main body portion 371 side with respect to the small diameter portion 382. The large diameter portion 381 has an outer diameter larger than an outer diameter of the small diameter portion 382. A passage groove 383 is formed at an end part of the small diameter portion 382 of the one-side seat portion 372 on a side opposite to the large diameter portion 381 in the axial direction. The passage groove 383 penetrates the small diameter portion 382 in a radial direction of the small diameter portion 382. The passage groove 383 communicates with the passage groove 30A of the piston rod 21A.

The other-side seat portion 373 protrudes to the same side as the cylindrical portion 366 in an axial direction of the bottom main body portion 371 from an inner circumferential side of an end part of the bottom main body portion 371 on the cylindrical portion 366 side in the axial direction. The other-side seat portion 373 has an annular shape.

The passage hole 376 of the bottom main body portion 371 is provided radially outward of the one-side seat portion 372 and between the other-side seat portion 373 and the cylindrical portion 366 in the radial direction of the bottom main body portion 371.

The pressing member 361 has a cylindrical portion 391 and an inner protruding portion 392. The cylindrical portion 391 has a cylindrical shape. The inner protruding portion 392 extends inward in a radial direction of the cylindrical portion 391 from one end of the cylindrical portion 391 in the axial direction. The inner protruding portion 392 has an annular shape.

In the pressing member 361, the cylindrical portion 391 fits onto an outer circumferential portion of the bottom main body portion 371 of the case member 360 with the inner protruding portion 392 positioned on the first damping valve 52B side with respect to the cylindrical portion 391 in the axial direction. The pressing member 361 is axially slidable with respect to the case member 360. The pressing member 361 comes into contact with an outer circumferential portion of the first damping valve 52B at an end part on the inner protruding portion 392 side in the axial direction.

The damping force generation mechanism 10B has a spring member 401 and a seal member 402.

The spring member 401 is made of a metal plate material and is formed by press forming. The spring member 401 includes a base plate portion 405 having a bored disc shape, and a spring plate portion 406 extending outward in a radial direction of the base plate portion 405 from the base plate portion 405. A plurality of spring plate portions 406 are provided in the spring member 401 at regular intervals in a circumferential direction of the base plate portion 405.

The spring member 401 is placed on an end surface of the large diameter portion 381 on the small diameter portion 382 side in the axial direction while the base plate portion 405 is fitted on the small diameter portion 382 of the one-side seat portion 372 of the case member 360 at an inner circumferential side thereof. In the spring member 401, the plurality of spring plate portions 406 come into contact with an end surface of the inner protruding portion 392 of the pressing member 361 on a side opposite to the first damping valve 52B in the axial direction. In this state, the plurality of spring plate portions 406 of the spring member 401 are elastically deformed to urge the first damping valve 52B to the valve seat portion 356 side via the pressing member 361, thereby pressing the first damping valve 52B against the valve seat portion 356.

The seal member 402 is annular, and is fitted into the annular groove 375 of the case member 360. The seal member 402 is made of an elastic material having sealing properties, specifically, rubber. The seal member 402 is an O-ring, and constantly seals a gap between the bottom main body portion 371 and the cylindrical portion 391 of the pressing member 361.

The damping force generation mechanism 10B has an opening/closing disc 57B, a partition member 111B (movable mechanism), and a stopper member 411 on a side of the case member 360 opposite to the first damping valve 52B in the axial direction in order from the other-side seat portion 373 side with the mounting shaft portion 28A fitted to the inside of them. The nut 235 is in contact with an end surface of the stopper member 411 on a side opposite to the partition member 111B in the axial direction.

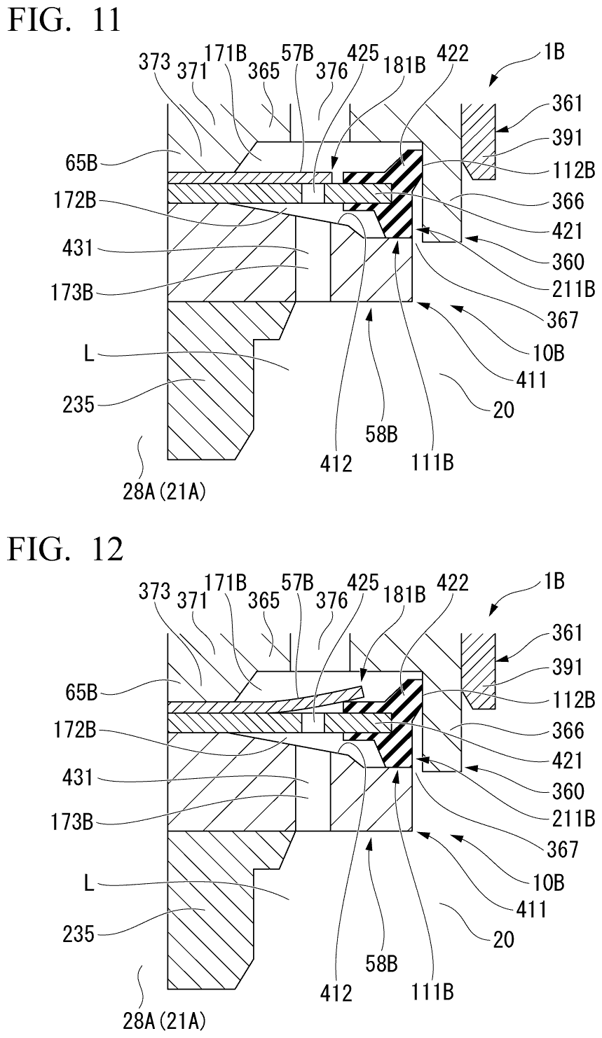

As shown in FIG. 11, the partition member 111B is formed of a disc 421 and a packing 422.

The disc 421 is made of a metal and have a bored circular flat plate shape with a constant thickness. The disc 421 is formed by press forming. The mounting shaft portion 28A of the piston rod 21A is fitted to an inner circumferential side of the disc 421. The disc 421 has a passage hole 425 formed at an intermediate portion in the radial direction. The passage hole 425 penetrates the disc 421 in an axial direction of the disc 421. A plurality of passage holes 425 are formed in the disc 421 at regular intervals in a circumferential direction of the disc 421.

The packing 422 is made of an elastic material having sealing properties, specifically, rubber. The packing 422 has an annular shape. The packing 422 is fixed to an outer circumferential side of the disc 421. The packing 422 is fitted to an inner circumferential surface of the cylindrical portion 366 of the case member 360 over the entire circumference. At that time, the packing 422 comes into contact with the inner circumferential surface of the cylindrical portion 366 at a seal portion 112B of the outer circumferential portion. The packing 422 is axially slidable along the inner circumferential surface of the cylindrical portion 366. The packing 422 constantly seals a gap between the partition member 111B and the cylindrical portion 366. The passage hole 425 of the disc 421 is disposed inward of the packing 422 in a radial direction of the disc 421.

The opening/closing disc 57B is made of a metal. The opening/closing disc 57B is a bored circular flat plate shape with a constant thickness and is formed by press forming. The opening/closing disc 57B comes into contact with the disc 421 of the partition member 111B to close passages in the plurality of passage holes 425. The opening/closing disc 57B opens the passages in the plurality of passage holes 425 by being separated from the disc 421 of the partition member 111B.

The stopper member 411 is made of a metal and has a bored disc shape. The mounting shaft portion 28A of the piston rod 21A is fitted to an inner circumferential side of the stopper member 411. The stopper member 411 includes a tapered portion 412 provided at a radially intermediate position on the partition member 111B side in the axial direction. The tapered portion 412 becomes further away from the disc 421 of the partition member 111B in an axial direction of the stopper member 411 toward the outside in a radial direction of the stopper member 411. The stopper member 411 has a passage hole 431 formed at an intermediate position in a radial direction of the tapered portion 412. The passage hole 431 penetrates the stopper member 411 in the axial direction of the stopper member 411. When the partition member 111B deforms to the stopper member 411 side and the disc 421 comes into contact with the tapered portion 412, any further deformation, that is, movement, is restricted.

The stopper member 411 is provided to cover the opening 367 of the cylindrical portion 366 of the case member 360. The stopper member 411 has an outer diameter smaller than an inner diameter of the cylindrical portion 366 of the case member 360. The nut 235 is in contact with a side of the stopper member 411 opposite to the partition member 111B in the axial direction.

As shown in FIG. 10, in the damping force generation mechanism 10B, the case member 360, the pressing member 361, the spring member 401, the seal member 402, and a stopper member 411 constitute a pilot case 58B (biasing force generation member). In the pilot case 58B, the bottom main body portion 371, the other-side seat portion 373, and the cylindrical portion 366 of the case member 360, and the stopper member 411 form a bottom portion 65B. In the pilot case 58B, a portion of the pressing member 361 extending to a side of the pressing member 361 opposite to the stopper member 411 with respect to the bottom main body portion 371 of the case member 360 in the axial direction forms a cylindrical portion 66B. The pilot case 58B has an opening 67B on a side of the cylindrical portion 66B opposite to the bottom portion 65B in the axial direction.

The pilot case 58B includes the tapered portion 412 provided inside the bottom portion 65B. Also, a passage in the passage hole 431 of the pilot case 58B is provided between the tapered portion 412 and an outer bottom side of the bottom portion 65B and can constantly communicate with the lower chamber 20.

The passage in the passage groove 30A of the piston rod 21A, a passage in the passage groove 358 of the seat forming member 351, a passage between the inner seat portion 354 and the intermediate seat portion 355 of the seat forming member 351, and a passage between the intermediate seat portion 355 and the valve seat portion 356 of the seat forming member 351 constitute a rod-side passage 341B.

The first damping valve 52B opens and closes the rod-side passage 341B by being separated from and coming into contact with the valve seat portion 356.

The first damping valve 52B is provided in the rod-side passage 341B and suppresses a flow of the oil fluid L caused by sliding of the piston 18A to the extension side, thereby generating a damping force. The first damping valve 52B, together with the valve seat portion 356 of the seat forming member 351, constitutes a first valve mechanism 41B. The first damping valve 52B opens by being separated from the valve seat portion 356. Then, the first damping valve 52B allows the oil fluid L from the rod-side passage 341B to flow into the lower chamber 20 through a gap between itself and the valve seat portion 356. The rod-side passage 341B serves as an extension-side passage through which the oil fluid Lin the upper chamber 19 flows due to movement of the piston 18A to the upper chamber 19 side. The rod-side passage 341B serves as an extension-side passage through which the oil fluid L as a working fluid flows from the upper chamber 19 on one side to the lower chamber 20 on the other side during an extension stroke. The extension-side first valve mechanism 41B formed of the valve seat portion 356 and the first damping valve 52B is provided in the rod-side passage 341B, and generates a damping force by opening and closing the rod-side passage 341B with the first damping valve 52B to suppress a flow of the oil fluid L.

In the extension-side first valve mechanism 41B, neither the valve seat portion 356 nor the first damping valve 52B that comes into contact with the valve seat portion 356 has a fixed orifice formed to allow communication between the upper chamber 19 and the lower chamber 20 even when the valve seat portion 356 and the first damping valve 52B are in a contact state. That is, a fixed orifice that allows constant communication between the upper chamber 19 and the lower chamber 20 is not formed in the extension-side first valve mechanism 41B. The rod-side passage 341B serves as a passage upstream of the first damping valve 52B in a flow direction of the oil fluid L during the extension stroke. The lower chamber 20 is on a downstream side of the first damping valve 52B in the flow direction of the oil fluid L during the extension stroke.

The seal portion 112B of the partition member 111B is in pressure contact with the inner circumferential surface of the cylindrical portion 366 of the case member 360 over the entire circumference. Thereby, a portion surrounded by the first damping valve 52B, the case member 360, the pressing member 361, the seal member 402, the opening/closing disc 57B, and the partition member 111B serves as a back pressure chamber 171B. The back pressure chamber 171B constantly communicates with the passage in the passage groove 30A of the piston rod 21A via a passage in the passage groove 383 of the pilot case 58B.

Also, a portion surrounded by the partition member 111B and the stopper member 411 serves as a variable chamber 172B. The variable chamber 172B is constantly communicates with the lower chamber 20 via the passage in the passage hole 431 of the stopper member 411.

The back pressure chamber 171B is formed inside the bottomed cylindrical pilot case 58B by the first damping valve 52B, the opening/closing disc 57B, and the partition member 111B. The partition member 111B is provided inside the pilot case 58B, and partitions the inside of the pilot case 58B into the back pressure chamber 171B and the variable chamber 172B.

The passage in the passage groove 30A of the piston rod 21A and the passage in the passage groove 383 of the pilot case 58B constitute a back pressure chamber introduction passage 176B that branches off from the rod-side passage 341B and communicates with the back pressure chamber 171B. The back pressure chamber introduction passage 176B allows communication between the upper chamber 19 and the back pressure chamber 171B via the rod-side passage 341B. During the extension stroke, the back pressure chamber introduction passage 176B introduces the oil fluid L from the upper chamber 19, which is upstream of the back pressure chamber 171B, into the back pressure chamber 171B.

The passage in the passage hole 431 of the stopper member 411, the variable chamber 172B, and the passages in the passage holes 425 of the partition member 111B constitute a first passage 173B that extends to connect the back pressure chamber 171B and the lower chamber 20. The partition member 111B having the seal portion 112B that seals the first passage 173B with an elastic member is movably provided in the first passage 173B.

The back pressure chamber 171B causes an internal pressure to act on the first damping valve 52B in a direction of the seat forming member 351, that is, in a valve closing direction in which the first damping valve 52B is seated on the valve seat portion 356. The pilot case 58B has a bottomed cylindrical shape and forms the back pressure chamber 171B that causes the first damping valve 52B disposed on the opening 67B side to generate a biasing force in a valve closing direction.

The opening/closing disc 57B is provided to be openable and closable between the first passage 173B and the back pressure chamber 171B. In a state in which the opening/closing disc 57B is in contact with the disc 421 of the partition member 111B by surface contact, the opening/closing disc 57B blocks a flow of the oil fluid L between the back pressure chamber 171B, and the first passage 173B and the lower chamber 20. Also, in a state in which the opening/closing disc 57B is separated from the disc 421 of the partition member 111B, the opening/closing disc 57B allows the oil fluid L to flow between the back pressure chamber 171B, and the first passage 173B and the lower chamber 20.

Here, when a pressure on the lower chamber 20 side becomes higher than a pressure on the back pressure chamber 171B side by a predetermined value or more, the opening/closing disc 57B allows a flow of the oil fluid L from the lower chamber 20 to the back pressure chamber 171B via the first passage 173B. In a state in which a pressure on the back pressure chamber 171B side is higher than a pressure on the lower chamber 20 side, the opening/closing disc 57B restricts a flow of the oil fluid L from the back pressure chamber 171B to the lower chamber 20 via the first passage 173B.

The opening/closing disc 57B and the disc 421 including the passage hole 425 of the partition member 111B constitute a communication mechanism 181B. One side of the first passage 173B can communicate with the back pressure chamber 171B. The communication mechanism 181B is on the one side of the first passage 173B and is allowed to communicate with the lower chamber 20 side, which is the other side of the first passage 173B, only when the lower chamber 20 is on the upstream side. In other words, when the lower chamber 20 is on the downstream side, the communication mechanism 181B cannot communicate with the lower chamber 20 side which is the other side of the first passage 173B. Between the back pressure chamber 171B and the variable chamber 172B, the communication mechanism 181B restricts a flow of the oil fluid L in one direction from the back pressure chamber 171B side to the variable chamber 172B side. On the other hand, the communication mechanism 181B allows a flow of the oil fluid L in the other direction from the variable chamber 172B side to the back pressure chamber 171B side. The communication mechanism 181B is a check valve, and the opening/closing disc 57B is a valve member thereof.

The partition member 111B has the disc 421 having the passage hole 425 and the packing 422. The opening/closing disc 57B can close the passage hole 425. The opening/closing disc 57B opens when the first passage 173B allows the oil fluid L to flow from the lower chamber 20 to the back pressure chamber 171B. The first passage 173B is provided to connect the back pressure chamber 171B and the lower chamber 20, and the partition member 111B is provided therein. In the first passage 173B in which the partition member 111B is provided, one side thereof is allowed to communicate with the back pressure chamber 171B, and the one side also serves as a passage in which the communication mechanism 181B allowed to communicate with the other side only when the lower chamber 20 side is an upstream side is provided.

The communication mechanism 181B restricts a flow of the oil fluid L from the upper chamber 19, the rod-side passage 341B, the back pressure chamber introduction passage 176B, and the back pressure chamber 171B to the lower chamber 20 via the first passage 173B. The communication mechanism 181B allows a flow of the oil fluid L from the lower chamber 20 to the back pressure chamber 171B, the back pressure chamber introduction passage 176B, the rod-side passage 341B, and the upper chamber 19 via the first passage 173B.

The pilot case 58B and the partition member 111B constitute a frequency sensitive mechanism 211B that makes a damping force variable in response to a piston frequency. In the frequency sensitive mechanism 211B, the partition member 111B moves and deforms in response to the frequency of reciprocation of the piston 18A, thereby changing a volume of the back pressure chamber 171B that is in constant communication with the upper chamber 19 and a volume of the variable chamber 172B that is in constant communication with the lower chamber 20. The frequency sensitive mechanism 211B has the partition member 111B provided in the first passage 173B to be movable. The frequency sensitive mechanism 211B varies a biasing force on the first damping valve 52B by the back pressure chamber 171B.

During the extension stroke, a differential pressure between the back pressure chamber 171B and the lower chamber 20 is such that the back pressure chamber 171B side has a higher pressure than the lower chamber 20 side. Then, receiving the pressure from the back pressure chamber 171B, the partition member 111B, together with the opening/closing disc 57B, moves and deforms to the stopper member 411 side while maintaining the sealed state with the cylindrical portion 366. Thereby, a volume of the back pressure chamber 171B increases.

During the compression stroke, the lower chamber 20 side has a higher pressure than the back pressure chamber 171B side. Then, if a differential pressure between the lower chamber 20 side and the back pressure chamber 171B side is lower than a predetermined value, the partition member 111B, receiving the pressure from the lower chamber 20 side, moves and deforms to a side opposite to stopper member 411 together with the opening/closing disc 57B while maintaining the sealed state with the cylindrical portion 366. Thereby, a volume of the variable chamber 172B increases. Also, during the compression stroke, when a pressure on the lower chamber 20 side becomes higher than that on the back pressure chamber 171B side by a predetermined value or more, the communication mechanism 181B opens and allows the oil fluid L to flow from the lower chamber 20 to the back pressure chamber 171B.

Next, an operation of the shock absorber 1B including the damping force generation mechanism 10B will be described.

### {Low-Frequency Minute-Low-Speed Region x1 in Extension Stroke}

In a low-frequency minute-low-speed region x1, the first valve mechanism 41B and the piston valve mechanism 201A do not open. Then, the oil fluid L from the upper chamber 19 flows into the back pressure chamber 171B via the rod-side passage 341B and the back pressure chamber introduction passage 176B. Then, the partition member 111B of the frequency sensitive mechanism 211B deforms to the stopper member 411 side together with the opening/closing disc 57B. In the low-frequency minute-low-speed region x1, a large amount of the oil fluid L is introduced from the upper chamber 19 to the back pressure chamber 171B at the beginning of the stroke. Therefore, the partition member 111B of the frequency sensitive mechanism 211B, together with the opening/closing disc 57B, deforms to the stopper member 411 side to near the limit, and then does not readily deform. Also, none of the first valve mechanism 41B and 42A and the piston valve mechanism 201A has a fixed orifice that allows constant communication between the upper chamber 19 and the lower chamber 20. As a result, in the low-frequency minute-low-speed region x1, an increasing rate of the damping force with respect to an increase in the piston speed is high.

### {Low-Frequency Low-Speed Region x2 in Extension Stroke}

In a low-frequency low-speed region x2, the oil fluid L from the upper chamber 19 largely deforms the partition member 111B of the frequency sensitive mechanism 211B, together with the opening/closing disc 57B, to the stopper member 411 side as in the low-frequency minute-low-speed region x1. Thereafter, the oil fluid L from the upper chamber 19 via the rod-side passage 341B and the back pressure chamber introduction passage 176B is not readily introduced into the back pressure chamber 171B. Therefore, in the low-frequency low-speed region x2, the oil fluid L from the upper chamber 19 flows from the piston-side passage 43A to the lower chamber 20 by opening the damping valve 261 of the piston valve mechanism 201A. As a result, in the low-frequency low-speed region x2, the increasing rate of the damping force with respect to an increase in the piston speed is lower than that in the low-frequency minute-low-speed region x1. In this low-frequency low-speed region x2, since the partition member 111B of the frequency sensitive mechanism 211B moves and deforms to near the limit, the pressure in the back pressure chamber 171B becomes high. A biasing force from the back pressure chamber 171B is large, and therefore opening of the first damping valve 52B of the first valve mechanism 41 is limited.

### {Low-Frequency Medium-High-Speed Region x3 in Extension Stroke}

In a low-frequency medium-high-speed region x3, the oil fluid L from the upper chamber 19 flows from the piston-side passage 43A to the lower chamber 20 by opening the damping valve 261 of the piston valve mechanism 201A as in the low-frequency low-speed region x2. In this manner, in the low-frequency medium-high-speed region x3, since the oil fluid L flows from the piston-side passage 43A to the lower chamber 20, an increase in pressure of the back pressure chamber 171B due to the oil fluid L introduced into the back pressure chamber 171B via a part of the rod-side passage 341B and the back pressure chamber introduction passage 176B is suppressed. In contrast, since a force in a valve opening direction exerted to the first valve mechanism 41B through the rod-side passage 341B increases, the oil fluid L from the upper chamber 19 passes through the rod-side passage 341B and flows into the lower chamber 20 by opening the first damping valve 52B of the first valve mechanism 41B. As a result, in the low-frequency medium-high-speed region x3, the increasing rate of the damping force with respect to an increase in the piston speed is lower than that in the low-frequency low-speed region x2.

### {High-Frequency Minute-Low-Speed Region x4 in Extension Stroke}

In a high-frequency minute-low-speed region x4, the first valve mechanism 41B and the piston valve mechanism 201A do not open. Then, the oil fluid L from the upper chamber 19 flows into the back pressure chamber 171B via the rod-side passage 341B and the back pressure chamber introduction passage 176B as in the low-frequency minute-low-speed region x1. Then, the partition member 111B of the frequency sensitive mechanism 211B, together with the opening/closing disc 57B, deforms to the stopper member 411 side. In the high-frequency minute-low-speed region x4, an amount of the oil fluid L introduced from the upper chamber 19 to the back pressure chamber 171B is less than that in the low-frequency minute-low-speed region x1. Therefore, the partition member 111B of the frequency sensitive mechanism 211B is likely to deform without deforming to near the limit. As a result, the oil fluid L introduced from the upper chamber 19 into the back pressure chamber 171B can be absorbed by the deformation of the partition member 111B and the opening/closing disc 57B. Therefore, in the high-frequency minute-low-speed region x4, although the increasing rate of the damping force with respect to an increase in the piston speed is high, the damping force at the same piston speed is lower than that in the low-frequency minute-low-speed region x1, thereby exhibiting soft characteristics.

### {High-Frequency Low-Medium-High-Speed Region x5 in Extension Stroke}

In a high-frequency low-medium-high-speed region x5, the oil fluid L from the upper chamber 19 deforms the partition member 111B of the frequency sensitive mechanism 211B, together with the opening/closing disc 57B, to the stopper member 411 side as in the high-frequency minute-low-speed region x4. In the high-frequency low-medium-high-speed region x5, since an amount of the oil fluid L introduced into the back pressure chamber 171B is small, an increase in pressure of the back pressure chamber 171B is suppressed by the deformation of the partition member 111B. Therefore, the biasing force from the back pressure chamber 171B to the first damping valve 52B of the first valve mechanism 41B becomes smaller, making it easier for the first damping valve 52B to open. Therefore, the oil fluid L from the upper chamber 19 passes through the rod-side passage 341B and flows into the lower chamber 20 by opening the first damping valve 52B of the first valve mechanism 41B. As a result, in the high-frequency low-medium-high-speed region x5, the increasing rate of the damping force with respect to an increase in the piston speed is lower than that in the high-frequency minute-low-speed region x4. Also, in the high-frequency low-medium-high-speed region x5, the damping force at the same piston speed is lower than that in the low-frequency low-speed region x2 and the low-frequency medium-high-speed region x3, thereby exhibiting soft characteristics. In the high-frequency low-medium-high-speed region x5, since the increase in pressure of the back pressure chamber 171B is suppressed, the piston valve mechanism 201A remains in a closed state.

### {Low-Frequency Minute-Low-Speed Region y1 in Compression Stroke}

In the low-frequency minute-low-speed region y1, the first valve mechanism 42A and the communication mechanism 181B do not open. Then, the oil fluid L from the lower chamber 20 is introduced into the variable chamber 172B of the first passage 173B. Then, the partition member 111B of the frequency sensitive mechanism 211B, together with the opening/closing disc 57B, deforms to a side opposite to the stopper member 411. In the low-frequency minute-low-speed region y1, a large amount of the oil fluid L is introduced from the lower chamber 20 to the variable chamber 172B at the beginning of the stroke. Therefore, the partition member 111B of the frequency sensitive mechanism 211B deforms to a side opposite to the stopper member 411 to near the limit, and does not readily deform. Also, none of the first valve mechanism 41B and 42A and the piston valve mechanism 201A has a fixed orifice that allows constant communication between the lower chamber 20 and the upper chamber 19. As a result, in the low-frequency minute-low-speed region y1, the increasing rate of the damping force with respect to an increase in the piston speed is high, thereby exhibiting hard characteristics.

### {Low-Frequency Low-Speed Region y2 in Compression Stroke}

In the low-frequency low-speed region y2, the oil fluid L from the lower chamber 20 moves and deforms the partition member 111B to a side opposite to the stopper member 411 to near the limit as in the low-frequency minute-low-speed region y1, and then flows from the first passage 173B to the upper chamber 19 via the back pressure chamber 171B, the back pressure chamber introduction passage 176B, and the rod-side passage 341B by opening the communication mechanism 181B. As a result, in the low-frequency low-speed region y2, the increasing rate of the damping force with respect to an increase in the piston speed is lower than that in the low-frequency minute-low-speed region y1.

### {Low-Frequency Medium-High-Speed Region y3 in Compression Stroke}

In a low-frequency medium-high-speed region y3, as in the low-frequency low-speed region y2, the oil fluid L from the lower chamber 20 flows from the first passage 173B to the upper chamber 19 via the back pressure chamber 171B, the back pressure chamber introduction passage 176B, and the rod-side passage 341B by opening the communication mechanism 181B. In addition to this, in the low-frequency low-medium-high-speed region y3, the oil fluid L from the lower chamber 20 passes through the piston-side passage 44 and flows into the upper chamber 19 by opening the first damping valve 231A of the first valve mechanism 42A. As a result, in the low-frequency medium-high-speed region y3, the increasing rate of the damping force with respect to an increase in the piston speed is lower than that in the low-frequency low-speed region y2.

### {High-Frequency Minute-Low-Speed Region y4 in Compression Stroke}

In a high-frequency minute-low-speed region y4, the first valve mechanism 42A and the communication mechanism 181B do not open. Then, the oil fluid L from the lower chamber 20 is introduced into the variable chamber 172B. Then, the partition member 111B of the frequency sensitive mechanism 211B, together with the opening/closing disc 57B, deforms to a side opposite to the stopper member 411. In the high-frequency minute-low-speed region y4, since the piston frequency is high and a stroke of the piston 18A is small, an amount of the oil fluid L introduced from the lower chamber 20 to the variable chamber 172B is less than that in the low-frequency minute-low-speed region y1. Therefore, the partition member 111B of the frequency sensitive mechanism 211B is likely to move and deform without deforming to near the limit. As a result, the oil fluid L introduced from the lower chamber 20 into the variable chamber 172B can be absorbed by the movement and deformation of the partition member 111B. Therefore, in the high-frequency minute-low-speed region y4, the damping force at the same piston speed has softer characteristics than in the low-frequency minute-low-speed region y1.

### {High-Frequency Low-Speed Region y5 in Compression Stroke}

In a high-frequency low-speed region y5, the oil fluid L from the lower chamber 20 flows from the first passage 173B to the upper chamber 19 via the back pressure chamber 171B, the back pressure chamber introduction passage 176B, and the rod-side passage 341B by opening the communication mechanism 181B. In the high-frequency low-speed region y5, the increasing rate of the damping force with respect to an increase in the piston speed is lower than that in the high-frequency minute-low-speed region y4. Also, in the high-frequency low-speed region y5, the damping force at the same piston speed is lower and softer than that in the low-frequency low-speed region y2.

### {High-Frequency Medium-High-Speed Region y6 in Compression Stroke}

In a high-frequency medium-high-speed region y6, as in the high-frequency low-speed region y5, the oil fluid L from the lower chamber 20 flows from the first passage 173B to the upper chamber 19 via the back pressure chamber 171B, the back pressure chamber introduction passage 176B, and the rod-side passage 341B by opening the communication mechanism 181B. In addition to that, in the high-frequency medium-high-speed region y6, the oil fluid L from the lower chamber 20 passes through the piston-side passage 44A and flows into the upper chamber 19 by opening the first damping valve 231A of the first valve mechanism 42A. As a result, in the high-frequency medium-high-speed region y6, the increasing rate of the damping force with respect to an increase in the piston speed is lower than that in the high-frequency low-speed region y5. Also, in the high-frequency medium-high-speed region y6, the damping force at the same piston speed is lower and softer than that in the low-frequency medium-high-speed region y3.

The damping force generation mechanism 10B of the third embodiment has the pilot case 58B, the frequency sensitive mechanism 211B, the first passage 173B, and the communication mechanism 181B. The pilot case 58B has a bottomed cylindrical shape and forms the back pressure chamber 171B that causes the first damping valve 52B disposed on the opening 67B side to generate a biasing force in a valve closing direction. The frequency sensitive mechanism 211B is configured such that the partition member 111B, having the seal portion 112B that seals the first passage 173B with an elastic member, is movably provided in the first passage 173B that is provided in the bottom portion 65B of the pilot case 58B and allowing communication between the back pressure chamber 171B and the lower chamber 20, thereby varying the biasing force in a valve closing direction on the first damping valve 52B. One side of the first passage 173B can communicate with the back pressure chamber 171B. The communication mechanism 181B is on the one side of the first passage 173B and is allowed to communicate with the other side of the first passage 173B only when the lower chamber 20 is on the upstream side.

As described above, the damping force generation mechanism 10B is configured such that the first passage 173B, which allows communication between the back pressure chamber 171B and the lower chamber 20, is provided in the bottom portion 65B of the pilot case 58B that forms the back pressure chamber 171B. Then, the damping force generation mechanism 10B varies the biasing force in a valve closing direction on the first damping valve 52B by the frequency sensitive mechanism 211B in which the partition member 111B that seals the first passage 173B with the seal portions 112B is movably provided in the first passage 173B. Therefore, the damping force generation mechanism 10B, even with the frequency sensitive mechanism 211B, can suppress an increase in size.

Also, since the communication mechanism 181B is provided in the damping force generation mechanism 10B, when the stroke is reversed from the compression stroke to the extension stroke, the communication mechanism 181B opens and introduces the oil fluid L from the lower chamber 20, which has a higher pressure than the upper chamber 19 during the compression stroke, into the back pressure chamber 171B via the first passage 173B, thereby allowing the pressure in the back pressure chamber 171B to be quickly increased. Then, the closed state of the first damping valve 52B, which is biased in a valve closing direction by the pressure of the back pressure chamber 171B, becomes stable. Thereby, it is possible to suppress a delay in the rise of the damping force that occurs when the stroke is reversed from the compression stroke to the extension stroke.

Also, the damping force generation mechanism 10B is configured such that, in the first passage 173B in which the partition member 111B is provided, one side thereof is allowed to communicate with the back pressure chamber 171B, and the one side also serves as a passage in which the communication mechanism 181B allowed to communicate with the other side only when the lower chamber 20 side is an upstream side is provided. Thereby, it is possible to further suppress an increase in size of the damping force generation mechanism 10B.

Also, the damping force generation mechanism 10B has the tapered portion 412 provided inside the bottom portion 65B of the pilot case 58B. Then, deformation, that is, movement, of the damping force generation mechanism 10B is restricted by the tapered portion 412 when the partition member 111B deforms to the stopper member 411 side. Therefore, local deformation of the partition member 111B can be suppressed, and durability thereof can be improved.

Also, the damping force generation mechanism 10B has a passage formed in the passage hole 431 that is provided in the pilot case 58B between the tapered portion 412 and an outer bottom side of the bottom portion 65B and can constantly communicate with the lower chamber 20. Therefore, the damping force generation mechanism 10B can suppress an increase in size of the pilot case 58B.

Also, in the damping force generation mechanism 10B, the partition member 111B has the disc 421 having the passage hole 425, and the packing 422. Then, the opening/closing disc 57B is capable of closing the passage hole 425, and opens when the first passage 173B allows the oil fluid L to flow from the lower chamber 20 to the back pressure chamber 171B. Therefore, a variable volume of the back pressure chamber 171B can be increased while suppressing an increase in size of the damping force generation mechanism 10B.

Further, as shown in FIG. 12, the damping force generation mechanism 10B may be configured such that an outer diameter of the flat plate-shaped opening/closing disc 57B is increased so that an outer circumferential portion of the opening/closing disc 57B comes into contact with a side of an inner circumferential portion of the packing 422 opposite to the disc 421 in the axial direction of the opening/closing disc 57B over the entire circumference. Thereby, a preload can be applied to the opening/closing disc 57B by bending the opening/closing disc 57B in a tapered shape. Thereby, the oil fluid L leaking from the back pressure chamber 171B to the lower chamber 20 side via the communication mechanism 181B can be suppressed, particularly, during the extension stroke.

### Fourth Embodiment

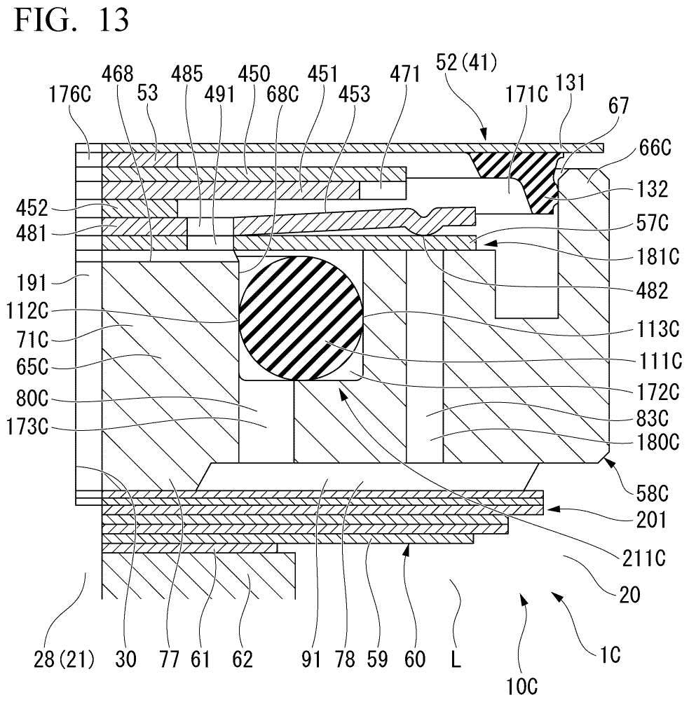

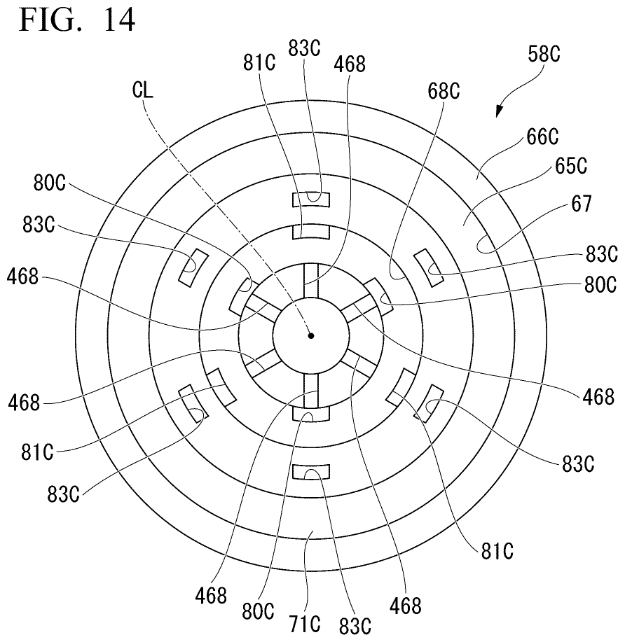

Next, a fourth embodiment will be described mainly on the basis of FIGS. 13 and 14, focusing on differences from the first embodiment. Further, parts common to those in the first embodiment will be denoted by the same terms and the same reference signs.

As shown in FIG. 13, in a shock absorber 1C including a damping force generation mechanism 10C of the fourth embodiment, a partial configuration of the damping force generation mechanism 10C differs from that of the damping force generation mechanism 10. The damping force generation mechanism 10C differs from the damping force generation mechanism 10 in configuration between a disc 53 and a second damping valve 60 in an axial direction of a piston rod 21.

The damping force generation mechanism 10C has one disc 450, one disc 451, one disc 452, one spring disc 453, one opening/closing disc 57C, and one pilot case 58C (a biasing force generation member) on a side of the disc 53 opposite to a first damping valve 52 in the axial direction of the piston rod 21 in order from the disc 53 side in the axial direction of the piston rod 21.

The discs 450 to 452, the spring disc 453, the opening/closing disc 57C, and the pilot case 58C are all made of a metal. The discs 450 to 452 and the opening/closing disc 57C all have a bored circular flat plate shape with a constant thickness. The discs 450 to 452, the spring disc 453, and the opening/closing disc 57C are formed by press forming. The spring disc 453 has a disc shape. The pilot case 58C has an annular shape. The discs 450 to 452, the spring disc 453, the opening/closing disc 57C, and the pilot case 58C all have a mounting shaft portion 28 of the piston rod 21 fitted inside.

The pilot case 58C has a bottomed cylindrical shape. The pilot case 58C is seamlessly and integrally formed as a whole by sintering. The pilot case 58C has a bottom portion 65C and a cylindrical portion 66C.

The bottom portion 65C has a bored disc shape, and the mounting shaft portion 28 of the piston rod 21 is fitted to an inner circumferential side thereof.

The cylindrical portion 66C extends in an axial direction of the bottom portion 65C from one axial end side of an outer circumferential portion of the bottom portion 65C. The cylindrical portion 66C has a cylindrical shape.

The pilot case 58C has an opening 67 on a side of the cylindrical portion 66C opposite to the bottom portion 65C in the axial direction.

The bottom portion 65C has a bottom main body portion 71C, and an inner seat portion 77 and an outer seat portion 78 similar to those described above.

The bottom main body portion 71C has a bored disc shape. The cylindrical portion 66C extends in an axial direction of the bottom main body portion 71C from a side of the bottom main body portion 71C opposite to the inner seat portion 77 and the outer seat portion 78 in the axial direction.

A seal groove 68C is formed in the bottom main body portion 71C at an intermediate position in a radial direction of the bottom main body portion 71C. The seal groove 68C is recessed from an end surface of the bottom main body portion 71C on a side opposite to the inner seat portion 77 and the outer seat portion 78 in the axial direction to a side of the inner seat portion 77 and the outer seat portion 78 in the axial direction of the bottom main body portion 71C.

In the bottom main body portion 71C, inner passage holes 80C and 81C shown in FIG. 14 are formed in a bottom surface of the seal groove 68C. The inner passage holes 80C and 81C penetrate the bottom main body portion 71C at a position of the seal groove 68C. The inner passage hole 80C is on an inner side with respect to the inner passage hole 81C in a radial direction of the pilot case 58C. The inner passage hole 80C is at an inner end position of the bottom surface of the seal groove 68C in the radial direction of the pilot case 58C. The inner passage hole 81C is at an outer end position of the bottom surface of the seal groove 68C in the radial direction of the pilot case 58C. A plurality of inner passage holes 80C and 81C, specifically three of each, are provided in the pilot case 58C. The inner passage holes 80C and the inner passage holes 81C are alternately disposed at regular intervals in a circumferential direction of the pilot case 58C.

In the pilot case 58C, an outer passage hole 83C is formed outward of the seal groove 68C in the radial direction of the bottom main body portion 71C. The outer passage hole 83C penetrates the bottom main body portion 71C in the axial direction thereof. A plurality of, specifically six, outer passage holes 83C are provided in the pilot case 58C at regular intervals in the circumferential direction of the pilot case 58C. The outer passage hole 83C is aligned with either the inner passage hole 80C or the inner passage hole 81C in the circumferential direction of the pilot case 58C.

The inner passage holes 80C and 81C and the outer passage hole 83C are provided at positions between adjacent seat forming portions 91 (see FIG. 3) in the circumferential direction of the pilot case 58C. Therefore, the inner passage holes 80C and 81C and the outer passage hole 83C are provided outward of the outer seat portion 78. The inner passage holes 80C and 81C and the outer passage hole 83C do not open into a passage recessed portion 92 (see FIG. 3).

A passage groove 468 extending inward in the radial direction of the bottom main body portion 71C from the seal groove 68C is formed on a side of the bottom main body portion 71C opposite to the inner seat portion 77 in the axial direction. As shown in FIG. 13, the passage groove 468 allows communication between the seal groove 68C and a rod-side passage 191 of the piston rod 21.

The damping force generation mechanism 10C has a partition member 111C (movable mechanism) in the seal groove 68C. The partition member 111C has an annular shape as a whole, and is an O-ring having a circular cross section in a plane including a central axis of the annular ring. The partition member 111C is made of an elastic material having sealing properties, specifically, rubber. The partition member 111C is fitted in the seal groove 68C. A seal portion 112C at an inner circumference of the partition member 111C comes into pressure contact with a wall surface on a radially inner side of the seal groove 68C to seal a gap between itself and the wall surface. A seal portion 113C at an outer circumference of the partition member 111C comes into pressure contact with a wall surface on a radially outer side of the seal groove 68C to seal a gap between itself and the wall surface.

An outer diameter of the disc 450 is larger than an outer diameter of the disc 53 and smaller than a minimum inner diameter of a seal member 132.

The disc 451 has an outer diameter equal to the outer diameter of the disc 450. The disc 451 has a notch 471 formed at an outer circumferential portion. The disc 451 has a plurality of notches 471 provided at regular intervals in a circumferential direction thereof.

The disc 452 has an outer diameter smaller than the outer diameter of the disc 451.

The spring disc 453 has an outer diameter larger than the outer diameter of the disc 452.

The spring disc 453 has a base plate portion 481 and a protruding portion 482.

Before the spring disc 453 is incorporated into the damping force generation mechanism 10C, the base plate portion 481 has a bored circular flat plate shape with a constant thickness. The protruding portion 482 protrudes to one side in an axial direction of the base plate portion 481 from an intermediate position on an outer circumferential side of the base plate portion 481 in the radial direction. The protruding portion 482 has an annular shape extending in a circumferential direction of the base plate portion 481.

A passage hole 485 is formed in the base plate portion 481 at a position outward of the disc 452 in a radial direction of the disc 452. The passage hole 485 penetrates in the axial direction of the base plate portion 481 at a position inward of the protruding portion 482 in the radial direction of the base plate portion 481. A plurality of passage holes 485 are provided in the base plate portion 481 at regular intervals in the circumferential direction of the base plate portion 481.

The opening/closing disc 57C has an outer diameter larger than an outer diameter of the protruding portion 482 of the spring disc 453. The opening/closing disc 57C extends to a position outside the outer passage hole 83C in the radial direction of the pilot case 58C. The opening/closing disc 57C comes into contact with the bottom main body portion 71C of the pilot case 58C by surface contact to close the seal groove 68C and the outer passage hole 83C. The opening/closing disc 57C covers the entirety of the seal groove 68C and the outer passage hole 83C. The opening/closing disc 57C opens a passage in the outer passage hole 83C by being separated from the bottom main body portion 71C.

The spring disc 453, in a state of being incorporated into the damping force generation mechanism 10C, is in contact with the opening/closing disc 57C at the protruding portion 482. Thereby, the spring disc 453 elastically deforms in a tapered shape such that the base plate portion 481 becomes further away from the opening/closing disc 57C in the axial direction toward the outer side in the radial direction.

The opening/closing disc 57C has a passage hole 491 formed to be aligned with the passage hole 485 of the spring disc 453 in position in the radial direction. The passage hole 491 penetrates the opening/closing disc 57C in an axial direction of the opening/closing disc 57C. The passage hole 491 extends in an are shape in a circumferential direction of the opening/closing disc 57C. The passage hole 491 is in constant communication with the passage hole 485 of the spring disc 453. The passage hole 491 is on an inner side of the seal groove 68C of the pilot case 58C in a radial direction of the opening/closing disc 57C. The passage hole 491 constantly communicates with the passage groove 468 of the pilot case 58C.

The seal portions 112C and 113C of the partition member 111C are simultaneously in pressure contact with the respective wall surfaces on the radially inner and outer sides of the seal groove 68C. Thereby, a portion surrounded by the pilot case 58C, the first damping valve 52, the discs 53 and 450 to 452, the spring disc 453, the opening/closing disc 57C, and the partition member 111C forms a back pressure chamber 171C. The back pressure chamber 171C is in constant communication with a passage in the passage groove 30 of the piston rod 21 via the passage holes 485 and 491 and passages in the passage grooves 468.

Also, due to the partition member 111C, a variable chamber 172C is formed between the bottom surface side of the seal groove 68C and the partition member 111C. The variable chamber 172C is in constant communication with the lower chamber 20 via the passages in the inner passage holes 80C and 81C.

The back pressure chamber 171C is formed inside the bottomed cylindrical pilot case 58C by the first damping valve 52, the discs 53 and 450 to 452, the opening/closing disc 57C, and the partition member 111C. The partition member 111C is provided inside the pilot case 58C and partitions the inside of the pilot case 58C into the back pressure chamber 171C and the variable chamber 172C.

A passage in a notch 121 (see FIG. 2) of a disc 50 (see FIG. 2), the passage in the passage groove 30 of the piston rod 21, the passage in the passage groove 468, and the passages in the passage holes 485 and 491 constitute a back pressure chamber introduction passage 176C that branches off from a piston-side passage 43 (see FIG. 2). The back pressure chamber introduction passage 176C allows communication between an upper chamber 19 (see FIG. 2) and the back pressure chamber 171C via a part of the piston-side passage 43 (see FIG. 2). During the extension stroke, the back pressure chamber introduction passage 176C introduces the oil fluid L from the upper chamber 19 (see FIG. 2), which is upstream of the back pressure chamber 171C, to the back pressure chamber 171C via a part of the piston-side passage 43 (see FIG. 2).

The passages in the inner passage holes 80C and 81C and the passage in the seal groove 68C, which are all provided in the bottom portion 65C of the pilot case 58C, constitute a first passage 173C that extends to connect the back pressure chamber 171C and the lower chamber 20. The partition member 111C having the seal portions 112C and 113C that seal the first passage 173C with an elastic member is movably provided in the first passage 173C.

The back pressure chamber 171C causes an internal pressure to act on the first damping valve 52 in a direction of a piston 18 (see FIG. 2), that is, in a valve closing direction in which a disc 131 is seated on the valve seat portion 47 (see FIG. 2). The pilot case 58C has a bottomed cylindrical shape and forms the back pressure chamber 171C that causes the first damping valve 52 disposed on the opening 67 side to generate a biasing force in a valve closing direction.

The inside of the outer passage hole 83C of the pilot case 58C serves as a second passage 180C. The opening/closing disc 57C is provided to be openable and closable between the second passage 180C and the back pressure chamber 171C. The second passage 180C in the outer passage hole 83C is provided parallel to the first passage 173C. The second passage 180C is disposed on an outer circumferential side of the pilot case 58C with respect to the first passage 173C. In a state in which the opening/closing disc 57C is in contact with the bottom main body portion 71C of the pilot case 58C by surface contact, the opening/closing disc 57C blocks a flow of the oil fluid L between the back pressure chamber 171C, and the second passage 180C and the lower chamber 20. Also, in a state in which the opening/closing disc 57C is separated from the bottom main body portion 71C of the pilot case 58C, the opening/closing disc 57C allows the oil fluid L to flow between the back pressure chamber 171C, and the second passage 180C and the lower chamber 20.

Here, when a pressure on a side of the second passage 180C and the lower chamber 20 becomes higher than a pressure on the back pressure chamber 171C side by a predetermined value or more, the opening/closing disc 57C and the spring disc 453 allow a flow of the oil fluid L from the lower chamber 20 and the second passage 180C to the back pressure chamber 171C. In a state in which a pressure on the back pressure chamber 171C side is higher than a pressure on the side of the second passage 180C and the lower chamber 20, the opening/closing disc 57C and the spring disc 453 restrict a flow of the oil fluid L from the back pressure chamber 171C to the lower chamber 20 through the second passage 180C.

The opening/closing disc 57C, the spring disc 453, and a portion of the bottom main body portion 71C of the pilot case 58C on the opening/closing disc 57C side in the axial direction constitute a communication mechanism 181C. One side of the second passage 180C can communicate with the back pressure chamber 171C. The communication mechanism 181C is on the one side of the second passage 180C and is allowed to communicate with the lower chamber 20 side, which is the other side of the second passage 180C, only when the lower chamber 20 is on the upstream side. In other words, when the lower chamber 20 is on the downstream side, the communication mechanism 181C cannot communicate with the lower chamber 20 side which is the other side of the second passage 180C. Between the back pressure chamber 171C and the second passage 180C, the communication mechanism 181C restricts a flow of the oil fluid L in one direction from the back pressure chamber 171C side to the second passage 180C side. On the other hand, the communication mechanism 181C allows a flow of the oil fluid L in the other direction from the second passage 180C side to the back pressure chamber 171C side. The communication mechanism 181C is a check valve, and the opening/closing disc 57C is a valve member thereof.

The communication mechanism 181C restricts a flow of the oil fluid L from the upper chamber 19 (see FIG. 2), a part of the piston-side passage 43 (see FIG. 2), the back pressure chamber introduction passage 176C, and the back pressure chamber 171C to the second passage 180C and the lower chamber 20. The communication mechanism 181C allows a flow of the oil fluid L from the lower chamber 20 and the second passage 180C to the back pressure chamber 171C, the back pressure chamber introduction passage 176C, a part of the piston-side passage 43 (see FIG. 2), and the upper chamber 19 (see FIG. 2).

The pilot case 58C and the partition member 111C constitute a frequency sensitive mechanism 211C that varies the damping force in response to a frequency of reciprocation of the piston 18 (see FIG. 2). In the frequency sensitive mechanism 211C, the partition member 111C moves and deforms in response to the frequency of reciprocation of the piston 18 (see FIG. 2), thereby changing a volume of the back pressure chamber 171C that is in constant communication with the upper chamber 19 (see FIG. 2) and a volume of the variable chamber 172C that is in constant communication with the lower chamber 20. The frequency sensitive mechanism 211C has the partition member 111C provided in the first passage 173C to be movable. The frequency sensitive mechanism 211C varies a biasing force on the first damping valve 52 by the back pressure chamber 171C.

During the extension stroke, a differential pressure between the back pressure chamber 171C and the lower chamber 20 is such that the back pressure chamber 171C side has a higher pressure than the lower chamber 20 side. Then, the partition member 111C, receiving the pressure from the back pressure chamber 171C, moves to the bottom surface of the seal groove 68C and comes into contact with the bottom surface to be compressively deformed while maintaining the sealed state with the seal groove 68C. Thereby, a volume of the back pressure chamber 171C increases.

During the compression stroke, the lower chamber 20 side has a higher pressure than the back pressure chamber 171C side. Then, if a differential pressure between the lower chamber 20 side and the back pressure chamber 171C side is lower than a predetermined value, the partition member 111C, receiving the pressure from the lower chamber 20 side, moves to the opening/closing disc 57C side and comes into contact with the opening/closing disc 57C to be compressively deformed while maintaining the sealed state with the seal groove 68C. Thereby, a volume of the variable chamber 172C increases. Also, during the compression stroke, when a pressure on the lower chamber 20 side becomes higher than that on the back pressure chamber 171C side by a predetermined value or more, the communication mechanism 181C opens to allow the oil fluid L to flow from the lower chamber 20 to the back pressure chamber 171C.

Next, an operation of the shock absorber 1C including the damping force generation mechanism 10C will be described.

### {Low-Frequency Minute-Low-Speed Region x1 in Extension Stroke}

In a low-frequency minute-low-speed region x1, the first valve mechanism 41 and the second valve mechanism 201 do not open. Then, the oil fluid L from the upper chamber 19 (see FIG. 2) flows into the back pressure chamber 171C via a part of the piston-side passage 43 (see FIG. 2) and the back pressure chamber introduction passage 176C. Then, the partition member 111C of the frequency sensitive mechanism 211C moves to the bottom surface of the seal groove 68C and comes into contact with the bottom surface to be compressively deformed. In the low-frequency minute-low-speed region x1, the partition member 111C of the frequency sensitive mechanism 211C moves and deforms to the bottom surface side of the seal groove 68C to near the limit, and then does not readily deform. Also, none of the first valve mechanism 41 and 42 (see FIG. 2) and the second valve mechanism 201 has a fixed orifice that allows constant communication between the upper chamber 19 and the lower chamber 20. As a result, in the low-frequency minute-low-speed region x1, an increasing rate of the damping force with respect to an increase in the piston speed is high.

### {Low-Frequency Low-Speed Region x2 in Extension Stroke}

In a low-frequency low-speed region x2, the oil fluid L from the upper chamber 19 (see FIG. 2) largely moves and deforms the partition member 111C of the frequency sensitive mechanism 211C to the bottom surface side of the seal groove 68C as in the low-frequency minute-low-speed region x1. Thereafter, the oil fluid L from the upper chamber 19 (see FIG. 2) via the piston-side passage 43 (see FIG. 2) and the back pressure chamber introduction passage 176C is not readily introduced into the back pressure chamber 171C. In the low-frequency low-speed region x2, the pressure in the back pressure chamber 171C is higher than that in the low-frequency minute-low-speed region x1. Therefore, in the low-frequency low-speed region x2, the oil fluid L from the upper chamber 19 (see FIG. 2) flows from the piston-side passage 43 (see FIG. 2), the back pressure chamber introduction passage 176C, and the rod-side passage 191 to the lower chamber 20 by opening the second damping valve 60 of the second valve mechanism 201. As a result, in the low-frequency low-speed region x2, the increasing rate of the damping force with respect to an increase in the piston speed is lower than that in the low-frequency minute-low-speed region x1. In the low-frequency low-speed region x2, since the partition member 111C of the frequency sensitive mechanism 211C moves and deforms to near the limit, the pressure in the back pressure chamber 171C becomes high. Therefore, a biasing force from the back pressure chamber 171C is large, and therefore opening of the first damping valve 52 of the first valve mechanism 41 is limited.

### {Low-Frequency Medium-High-Speed Region x3 in Extension Stroke}

In a low-frequency medium-high-speed region x3, the oil fluid L from the upper chamber 19 (see FIG. 2) opens the second damping valve 60 of the second valve mechanism 201 and flows into the lower chamber 20 via a part of the piston-side passage 43 (see FIG. 2), a part of the back pressure chamber introduction passage 176C, and the rod-side passage 191 as in the low-frequency low-speed region x2. In this way, in the low-frequency medium-high-speed region x3, since the oil fluid L flows from the rod-side passage 191 to the lower chamber 20, an increase in pressure of the back pressure chamber 171C due to the oil fluid L introduced into the back pressure chamber 171C via a part of the piston-side passage 43 (see FIG. 2) and the back pressure chamber introduction passage 176C is suppressed. In contrast, since a force in a valve opening direction exerted to the first valve mechanism 41 from the piston-side passage 43 (see FIG. 2) increases, the oil fluid L from the upper chamber 19 (see FIG. 2) passes through the piston-side passage 43 (see FIG. 2) and flows into the lower chamber 20 by opening the first damping valve 52 of the first valve mechanism 41. As a result, in the low-frequency medium-high-speed region x3, the increasing rate of the damping force with respect to an increase in the piston speed is lower than that in the low-frequency low-speed region x2.

### {High-Frequency Minute-Low-Speed Region x4 in Extension Stroke}

In a high-frequency minute-low-speed region x4, the first valve mechanism 41 and the second valve mechanism 201 do not open. Then, as in the low-frequency minute-low-speed region x1, the oil fluid L from the upper chamber 19 (see FIG. 2) flows into the back pressure chamber 171C via a part of the piston-side passage 43 (see FIG. 2) and the back pressure chamber introduction passage 176C. Then, the partition member 111C of the frequency sensitive mechanism 211C moves and deforms to the bottom surface side of the seal groove 68C. In the high-frequency minute-low-speed region x4, the piston frequency is high and a stroke of the piston 18 (see FIG. 2) is small. Therefore, an amount of the oil fluid L introduced from the upper chamber 19 into the back pressure chamber 171C is less than that in the low-frequency minute-low-speed region x1. Therefore, the partition member 111C of the frequency sensitive mechanism 211C is likely to deform without deforming to near the limit. As a result, the oil fluid L introduced from the upper chamber 19 (see FIG. 2) into the back pressure chamber 171C can be absorbed by the movement and deformation of the partition member 111C. Therefore, in the high-frequency minute-low-speed region x4, although the increasing rate of the damping force with respect to an increase in the piston speed is high, the damping force at the same piston speed is lower than that in the low-frequency minute-low-speed region x1, thereby exhibiting soft characteristics.

### {High-Frequency Low-Medium-High-Speed Region x5 in Extension Stroke}

In a high-frequency low-medium-high-speed region x5, the oil fluid L from the upper chamber 19 (see FIG. 2) moves and deforms the partition member 111C of the frequency sensitive mechanism 211C to the bottom surface side of the seal groove 68C as in the high-frequency minute-low-speed region x4. In the high-frequency low-medium-high-speed region x5, since an amount of the oil fluid L introduced into the back pressure chamber 171C is small, an increase in pressure of the back pressure chamber 171C is suppressed by the deformation of the partition member 111C. Therefore, the biasing force from the back pressure chamber 171C to the first damping valve 52 of the first valve mechanism 41 becomes smaller, making it easier for the first damping valve 52 to open. As a result, the oil fluid L from the upper chamber 19 (see FIG. 2) passes through the piston-side passage 43 (see FIG. 2) and flows into the lower chamber 20 by opening the first damping valve 52 of the first valve mechanism 41. As a result, in the high-frequency low-medium-high-speed region x5, the increasing rate of the damping force with respect to an increase in the piston speed is lower than that in the high-frequency minute-low-speed region x4. Also, in the high-frequency low-medium-high-speed region x5, the damping force at the same piston speed is lower than that in the low-frequency low-speed region x2 and the low-frequency medium-high-speed region x3, thereby exhibiting soft characteristics. In the high-frequency low-medium-high-speed region x5, since the increase in pressure of the back pressure chamber 171C is suppressed, the second valve mechanism 201 remains in a closed state.

### {Low-Frequency Minute-Low-Speed Region y1 in Compression Stroke}

In a low-frequency minute-low-speed region y1, the first valve mechanism 42 (see FIG. 2) and the communication mechanism 181C do not open. Then, the oil fluid L from the lower chamber 20 is introduced into the variable chamber 172C through the passages in the inner passage holes 80C and 81C in the first passage 173C. Then, the partition member 111C of the frequency sensitive mechanism 211C moves to the opening/closing disc 57C side and deforms. In the low-frequency minute-low-speed region y1, since the piston frequency is low and the piston 18 (see FIG. 2) makes a large stroke, a large amount of the oil fluid L is introduced from the lower chamber 20 into the variable chamber 172C at the beginning of the stroke. Therefore, the partition member 111C of the frequency sensitive mechanism 211C moves and deforms to the opening/closing disc 57C side to near the limit, and does not readily deform. Also, none of the first valve mechanism 41 and 42 (see FIG. 2) and the second valve mechanism 201 has a fixed orifice that allows constant communication between the lower chamber 20 and the upper chamber 19. As a result, in the low-frequency minute-low-speed region y1, the increasing rate of the damping force with respect to an increase in the piston speed is high, thereby exhibiting hard characteristics.

### {Low-Frequency Low-Speed Region y2 in Compression Stroke}

In the low-frequency low-speed region y2, the oil fluid L from the lower chamber 20 moves and deforms the partition member 111C to the opening/closing disc 57C side to near the limit as in the low-frequency minute-low-speed region y1, and then flows from the second passage 180C to the upper chamber 19 (see FIG. 2) via the back pressure chamber 171C, the back pressure chamber introduction passage 176C, and a part of the piston-side passage 43 (see FIG. 2) by opening the communication mechanism 181C. As a result, in the low-frequency low-speed region y2, the increasing rate of the damping force with respect to an increase in the piston speed is lower than that in the low-frequency minute-low-speed region y1.

### {Low-Frequency Medium-High-Speed Region y3 in Compression Stroke}

In a low-frequency medium-high-speed region y3, as in the low-frequency low-speed region y2, the oil fluid L from the lower chamber 20 flows from the second passage 180C to the upper chamber 19 (see FIG. 2) via the back pressure chamber 171C, the back pressure chamber introduction passage 176C, and a part of the piston-side passage 43 (see FIG. 2) by opening the communication mechanism 181C. In addition to this, in the low-frequency low-medium-high-speed region y3, the oil fluid L from the lower chamber 20 passes through the piston-side passage 44 (see FIG. 2) and flows into the upper chamber 19 (see FIG. 2) by opening the first damping valve 231 (see FIG. 2) of the first valve mechanism 42 (see FIG. 2). As a result, in the low-frequency medium-high-speed region y3, the increasing rate of the damping force with respect to an increase in the piston speed is lower than that in the low-frequency low-speed region y2.

### {High-Frequency Minute-Low-Speed Region y4 in Compression Stroke}

In a high-frequency minute-low-speed region y4, the first valve mechanism 42 and the communication mechanism 181C do not open. Then, the oil fluid L from the lower chamber 20 is introduced into the variable chamber 172C through the passages in the inner passage holes 80C and 81C in the first passage 173C. Then, the partition member 111C of the frequency sensitive mechanism 211C deforms to the opening/closing disc 57C side. In the high-frequency minute-low-speed region y4, since the piston frequency is high and the stroke of the piston 18 is small, an amount of the oil fluid L introduced from the lower chamber 20 to the variable chamber 172C is less than that in the low-frequency minute-low-speed region y1. Therefore, the partition member 111C of the frequency sensitive mechanism 211C is likely to move and deform without deforming to near the limit. As a result, the oil fluid L introduced from the lower chamber 20 into the variable chamber 172C can be absorbed by the movement and deformation of the partition member 111C. Therefore, in the high-frequency minute-low-speed region y4, the damping force at the same piston speed has softer characteristics than in the low-frequency minute-low-speed region y1.

### {High-Frequency Low-Speed Region y5 in Compression Stroke}

In a high-frequency low-speed region y5, the oil fluid L from the lower chamber 20 flows from the second passage 180C to the upper chamber 19 (see FIG. 2) via the back pressure chamber 171C, the back pressure chamber introduction passage 176C, and a part of the piston-side passage 43 (see FIG. 2) by opening the communication mechanism 181C. In the high-frequency low-speed region y5, the increasing rate of the damping force with respect to an increase in the piston speed is lower than that in the high-frequency minute-low-speed region y4. Also, in the high-frequency low-speed region y5, the damping force at the same piston speed is lower and softer than that in the low-frequency low-speed region y2.

### {High-Frequency Medium-High-Speed Region y6 in Compression Stroke}

In a high-frequency medium-high-speed region y6, as in the high-frequency low-speed region y5, the oil fluid L from the lower chamber 20 flows from the second passage 180C to the upper chamber 19 (see FIG. 2) via the back pressure chamber 171C, the back pressure chamber introduction passage 176C, and a part of the piston-side passage 43 (see FIG. 2) by opening the communication mechanism 181C. In addition to this, in the high-frequency medium-high-speed region y6, the oil fluid L from the lower chamber 20 passes through the piston-side passage 44 (see FIG. 2) and flows into the upper chamber 19 (see FIG. 2) by opening the first damping valve 231 (see FIG. 2) of the first valve mechanism 42 (see FIG. 2). As a result, in the high-frequency medium-high-speed region y6, the increasing rate of the damping force with respect to an increase in the piston speed is lower than that in the high-frequency low-speed region y5. Also, in the high-frequency medium-high-speed region y6, the damping force at the same piston speed is lower and softer than that in the low-frequency medium-high-speed region y3.

The damping force generation mechanism 10C of the fourth embodiment has the pilot case 58C, the frequency sensitive mechanism 211C, the second passage 180C, and the communication mechanism 181C. The pilot case 58C has a bottomed cylindrical shape and forms the back pressure chamber 171C that causes the first damping valve 52 disposed on the opening 67 side to generate a biasing force in a valve closing direction. The frequency sensitive mechanism 211C is configured such that the partition member 111C, having the seal portions 112C and 113C that seal the first passage 173C with an elastic member, is movably provided in the first passage 173C that is provided in the bottom portion 65C of the pilot case 58C to connect the back pressure chamber 171C and the lower chamber 20, thereby varying the biasing force in a valve closing direction on the first damping valve 52. The second passage 180C is provided parallel to the first passage 173C, and one side thereof can communicate with the back pressure chamber 171C. The communication mechanism 181C is on the one side of the second passage 180C and is allowed to communicate with the other side of the second passage 180C only when the lower chamber 20 is on the upstream side.

As described above, the damping force generation mechanism 10C is configured such that the first passage 173C, which extends to connect the back pressure chamber 171C and the lower chamber 20, is provided in the bottom portion 65C of the pilot case 58C that forms the back pressure chamber 171C. Then, the damping force generation mechanism 10C varies the biasing force in a valve closing direction on the first damping valve 52 by the frequency sensitive mechanism 211C in which the partition member 111C that seals the first passage 173C with the seal portions 112C and 113C is movably provided in the first passage 173C. Therefore, the damping force generation mechanism 10C, even with the frequency sensitive mechanism 211C, can suppress an increase in size.

Also, since the communication mechanism 181C is provided in the damping force generation mechanism 10C, when the stroke is reversed from the compression stroke to the extension stroke, the communication mechanism 181C opens and introduces the oil fluid L from the lower chamber 20, which has a higher pressure than the upper chamber 19 during the compression stroke, into the back pressure chamber 171C through the second passage 180C, thereby allowing the pressure in the back pressure chamber 171C to be quickly increased. Then, the closed state of the first damping valve 52, which is biased in a valve closing direction by the pressure of the back pressure chamber 171C, becomes stable. Thereby, it is possible to suppress a delay in the rise of the damping force that occurs when the stroke is reversed from the compression stroke to the extension stroke.

Also, in the damping force generation mechanism 10C, the second passage 180C that is opened and closed by the communication mechanism 181C is disposed on an outer circumferential side of the bottom portion 65C with respect the first passage 173C. Therefore, in the damping force generation mechanism 10C, the opening/closing disc 57C of the communication mechanism 181C can cover the entirety of the opening of the first passage 173C on the opening/closing disc 57C side. Therefore, it is possible to suppress the partition member 111C provided in the first passage 173C entering a gap between the opening/closing disc 57C and the opening of the first passage 173C. Therefore, a decrease in durability of the partition member 111C can be suppressed.

Also, since an O-ring is used as the partition member 111C having the seal portions 112C and 113C that seal the first passage 173C with an elastic member, the damping force generation mechanism 10C is subject to a large compressive deformation. From this, provision of the communication mechanism 181C is highly effective in suppressing the delay in the rise of the damping force that occurs when the stroke is reversed from the compression stroke to the extension stroke.

### Fifth Embodiment

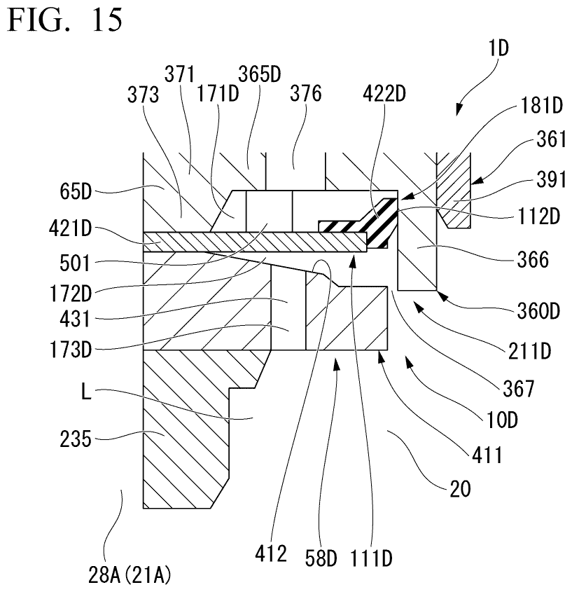

Next, a fifth embodiment will be described mainly on the basis of FIG. 15, focusing on differences from the third embodiment. Further, parts common to those in the third embodiment will be denoted by the same terms and the same reference signs.

As shown in FIG. 15, in a shock absorber 1D including a damping force generation mechanism 10D of the fifth embodiment, a partial configuration of the damping force generation mechanism 10D differs from that of the damping force generation mechanism 10B.

The opening/closing disc 57B is not provided in the damping force generation mechanism 10D. Further, the damping force generation mechanism 10D has a pilot case 58D, which is partially different from the pilot case 58B, instead of the pilot case 58B. Also, the damping force generation mechanism 10D has a partition member 111D, which is partially different from the partition member 111B, instead of the partition member 111B.

The pilot case 58D has a case member 360D, which is partially different from the case member 360, instead of the case member 360. The case member 360D has a bottom portion 365D, which is partially different from the bottom portion 365, instead of the bottom portion 365. The bottom portion 365D has a protruding portion 501 that protrudes from a bottom main body portion 371 to the same side as the other side seat portion 373 in an axial direction of the bottom main body portion 371. The protruding portion 501 is provided between the other side seat portion 373 and a cylindrical portion 366 in a radial direction of the bottom main body portion 371. A plurality of protruding portions 501 are provided at regular intervals in a circumferential direction of the bottom main body portion 371. The pilot case 58D has a bottom portion 65D which is different from the bottom portion 65B in that it has the protruding portion 501 described above.

The partition member 111D has a disc 421D, which is partially different from the disc 421, instead of the disc 421. Also, the partition member 111D has a packing 422D, which is partially different from the packing 422, instead of the packing 422.

The disc 421D differs from the disc 421 in that the passage hole 425 is not formed.

The packing 422D is made of an elastic material having sealing properties, specifically, rubber. The packing 422D has an annular shape. The packing 422D is fixed to an outer circumferential side of the disc 421D. The packing 422D protrudes from the disc 421D to one side of the disc 421D in the axial direction. The packing 422D is configured such that a seal portion 112D at the outer circumferential portion extends in a radial direction of the disc 421D with distance away from the disc 421D in an axial direction of the disc 421D. The packing 422D is configured such that an inner circumferential portion extends in the radial direction of the disc 421D with distance away from the disc 421D in the axial direction of the disc 421D.

The packing 422D is fitted to an inner circumferential surface of the cylindrical portion 366 of the case member 360D over the entire circumference. At that time, the packing 422D comes into contact with the inner circumferential surface of the cylindrical portion 366 at the seal portion 112D of the outer circumferential portion. The packing 422D is slidable in the axial direction with respect to the inner circumferential surface of the cylindrical portion 366. The packing 422D seals a gap between the partition member 111D and the cylindrical portion 366. The protruding portion 501 of the pilot case 58D is disposed inward of the packing 422D in the radial direction of the disc 421D.

The seal portion 112D of the packing 422D of the partition member 111D is in pressure contact with the inner circumferential surface of the cylindrical portion 366 of the case member 360D over the entire circumference. Thereby, a portion surrounded by a first damping valve 52B (see FIG. 10), a pressing member 361 (see FIG. 10), a seal member 402 (see FIG. 10), the case member 360D, and the partition member 111D forms a back pressure chamber 171D. The back pressure chamber 171D communicates with a rod-side passage 341B (see FIG. 10) through a back pressure chamber introduction passage 176B (see FIG. 10).

Also, a portion surrounded by the partition member 111D and a stopper member 411 serves as a variable chamber 172D. The variable chamber 172D is in constant communication with a lower chamber 20 through a passage in a passage hole 431 of the stopper member 411. Also, the variable chamber 172D is in constant communication with the lower chamber 20 through a passage between the stopper member 411 and the cylindrical portion 366 of the case member 360D.

The back pressure chamber 171D is formed inside the bottomed cylindrical pilot case 58D by the partition member 111D. The partition member 111D is provided inside the pilot case 58D and partitions the inside of the pilot case 58D into the back pressure chamber 171D and the variable chamber 172D.

A passage between an outer circumferential portion of the stopper member 411 and the cylindrical portion 366 of the case member 360D, a passage in the passage hole 431 of the stopper member 411, the variable chamber 172D, and a passage between the seal portion 112D of the packing 422D and the cylindrical portion 366 constitute a first passage 173D that extends to connect the back pressure chamber 171D and the lower chamber 20. The partition member 111D, having the seal portion 112D that seals the first passage 173D with an elastic member, is movably provided in the first passage 173D.

The back pressure chamber 171D causes an internal pressure to act on the first damping valve 52B (see FIG. 10) in a direction of a seat forming member 351 (see FIG. 10), that is, in a valve closing direction in which the first damping valve 52B is seated on the valve seat portion 356 (see FIG. 10). The pilot case 58D has a bottomed cylindrical shape and forms the back pressure chamber 171D that causes the first damping valve 52B disposed on the opening 67B (see FIG. 10) side to generate a biasing force in a valve closing direction.

The seal portion 112D of the packing 422D of the partition member 111D is provided to be openable and closable between the first passage 173D and the back pressure chamber 171D. In a state in which the seal portion 112D of the packing 422D is in contact with the inner circumferential surface of the cylindrical portion 366 of the case member 360D over the entire circumference, the seal portion 112D blocks a flow of the oil fluid L between the back pressure chamber 171D, and the first passage 173D and the lower chamber 20. Also, in a state in which the seal portion 112D of the packing 422D is separated from the inner circumferential surface of the cylindrical portion 366 of the case member 360D, the seal portion 112D allows the oil fluid L to flow between the back pressure chamber 171D, and the first passage 173D and the lower chamber 20.

Here, when a pressure on the lower chamber 20 side becomes higher than a pressure on the back pressure chamber 171D side by a predetermined value or more, the seal portion 112D of the packing 422D separates from the cylindrical portion 366 to allow a flow of the oil fluid L from the lower chamber 20 to the back pressure chamber 171D via the first passage 173D. That is, when a pressure on the lower chamber 20 side becomes higher than a pressure on the back pressure chamber 171D side by a predetermined value or more, the partition member 111D attempts to move to the bottom main body portion 371 side in the axial direction, but the protruding portion 501 of the case member 360D comes into contact with the disc 421D to suppress movement of the disc 421D to the bottom main body portion 371 side. As a result, in the partition member 111D, the packing 422D is satisfactorily separated from the inner circumferential surface of the cylindrical portion 366 due to the pressure difference between the variable chamber 172D and the back pressure chamber 171D, thereby allowing the oil fluid L to flow from the lower chamber 20 to the back pressure chamber 171D via the first passage 173D. In a state in which a pressure on the back pressure chamber 171D side is higher than a pressure on the lower chamber 20 side, the seal portion 112D of the packing 422D comes into contact with the cylindrical portion 366 to restrict a flow of the oil fluid L from the back pressure chamber 171D to the lower chamber 20 via the first passage 173D.

The packing 422D and the cylindrical portion 366 of the case member 360D constitute a communication mechanism 181D. One side of the first passage 173D can communicate with the back pressure chamber 171D. The communication mechanism 181D is on the one side of the first passage 173D and is allowed to communicate with the lower chamber 20 side, which is the other side of the first passage 173D, only when the lower chamber 20 is on the upstream side. In other words, when the lower chamber 20 is on the downstream side, the communication mechanism 181D cannot communicate with the lower chamber 20 side which is the other side of the first passage 173D. Between the back pressure chamber 171D and the variable chamber 172D, the communication mechanism 181D restricts a flow of the oil fluid L in one direction from the back pressure chamber 171D side to the variable chamber 172D side. On the other hand, the communication mechanism 181D allows a flow of the oil fluid L in the other direction from the variable chamber 172D side to the back pressure chamber 171D side. The communication mechanism 181D is a check valve, and the partition member 111D is a valve member thereof.

The first passage 173D is provided to connect the back pressure chamber 171D and the lower chamber 20, and a partition member 111D is provided therein. In the first passage 173D in which the partition member 111D is provided, one side thereof is allowed to communicate with the back pressure chamber 171D, and the one side also serves as a passage in which the communication mechanism 181D allowed to communicate with the other side only when the lower chamber 20 side is an upstream side is provided.

The communication mechanism 181D restricts a flow of the oil fluid L from an upper chamber 19 (see FIG. 10), the rod-side passage 341B (see FIG. 10), the back pressure chamber introduction passage 176B (see FIG. 10), and the back pressure chamber 171D to the lower chamber 20 via the first passage 173D. The communication mechanism 181D allows a flow of the oil fluid L from the lower chamber 20 to the back pressure chamber 171D, the back pressure chamber introduction passage 176B (see FIG. 10), the rod-side passage 341B (see FIG. 10), and the upper chamber 19 (see FIG. 10) via the first passage 173D.

The pilot case 58D and the partition member 111D constitute a frequency sensitive mechanism 211D that makes a damping force variable in response to a piston frequency. In the frequency sensitive mechanism 211D, the partition member 111D moves and deforms in response to the frequency of reciprocation of a piston 18A (see FIG. 10), thereby changing a volume of the back pressure chamber 171D that is in constant communication with the upper chamber 19 (see FIG. 10) and a volume of the variable chamber 172D that is in constant communication with the lower chamber 20. The frequency sensitive mechanism 211D has the partition member 111D provided in the first passage 173D to be movable. The frequency sensitive mechanism 211D varies a biasing force on the first damping valve 52B (see FIG. 10) by the back pressure chamber 171D.

During the extension stroke, a differential pressure between the back pressure chamber 171D and the lower chamber 20 is such that the back pressure chamber 171D side is higher than the lower chamber 20 side. Then, the partition member 111D, receiving the pressure from the back pressure chamber 171D, moves and deforms to the stopper member 411 side while maintaining the sealed state with the cylindrical portion 366. Thereby, a volume of the back pressure chamber 171D increases.

During the compression stroke, the lower chamber 20 side has a higher pressure than the back pressure chamber 171D side. Then, if a differential pressure between the lower chamber 20 side and the back pressure chamber 171D side is lower than a predetermined value, the partition member 111D, receiving the pressure from the lower chamber 20 side, moves and deforms to a side opposite to the stopper member 411 while maintaining the sealed state with the cylindrical portion 366. Thereby, a volume of the variable chamber 172D increases. Also, during the compression stroke, if the pressure on the lower chamber 20 side becomes higher than the pressure on the back pressure chamber 171D side by a predetermined value or more, the communication mechanism 181D opens to allow the oil fluid L to flow from the lower chamber 20 to the back pressure chamber 171D.

An operation of the shock absorber 1D including the damping force generation mechanism 10D is substantially the same as the operation of the shock absorber 1B and is different in that the communication mechanism 181D provided in place of the communication mechanism 181B opens in the low-frequency low-speed region y2, the low-frequency medium-high-speed region y3, the high-frequency low-speed region y5, and the high-frequency medium-high-speed region y6 during the compression stroke.

The damping force generation mechanism 10D of the fifth embodiment has the pilot case 58D, the frequency sensitive mechanism 211D, the first passage 173D, and the communication mechanism 181D. The pilot case 58D has a bottomed cylindrical shape, and forms the back pressure chamber 171D that causes the first damping valve 52B (see FIG. 10) disposed on the opening 67B (see FIG. 10) side to generate a biasing force in a valve closing direction. The frequency sensitive mechanism 211D is configured such that the partition member 111D, having the seal portion 112D that seals the first passage 173D with an elastic member, is movably provided in the first passage 173D that is provided in the bottom portion 65D of the pilot case 58D to allow communication between the back pressure chamber 171D and the lower chamber 20, thereby varying the biasing force in a valve closing direction on the first damping valve 52B (see FIG. 10). One side of the first passage 173D can communicate with the back pressure chamber 171D. The communication mechanism 181D is on the one side of the first passage 173D and is allowed to communicate with the other side of the first passage 173D only when the lower chamber 20 is on the upstream side.

As described above, the damping force generation mechanism 10D is configured such that the first passage 173D, which allows communication between the back pressure chamber 171D and the lower chamber 20, is provided in the bottom portion 65D of the pilot case 58D that forms the back pressure chamber 171D. Then, the damping force generation mechanism 10D varies the biasing force in a valve closing direction on the first damping valve 52B (see FIG. 10) by the frequency sensitive mechanism 211D in which the partition member 111D that seals the first passage 173D with the seal portions 112D is movably provided in the first passage 173D. Therefore, the damping force generation mechanism 10D, even with the frequency sensitive mechanism 211D, can suppress an increase in size.

Also, since the communication mechanism 181D is provided in the damping force generation mechanism 10D, when the stroke is reversed from the compression stroke to the extension stroke, the communication mechanism 181D opens and introduces the oil fluid L from the lower chamber 20, which has a higher pressure than the upper chamber 19 during the compression stroke, into the back pressure chamber 171D via the first passage 173D, thereby allowing the pressure in the back pressure chamber 171D to be quickly increased. Then, the closed state of the first damping valve 52B (see FIG. 10), which is biased in a valve closing direction by the pressure of the back pressure chamber 171D, becomes stable. Thereby, it is possible to suppress a delay in the rise of the damping force that occurs when the stroke is reversed from the compression stroke to the extension stroke.

Also, the damping force generation mechanism 10D is configured such that, in the first passage 173D in which the partition member 111D is provided, one side thereof is allowed to communicate with the back pressure chamber 171D, and the one side also serves as a passage in which the communication mechanism 181D allowed to communicate with the other side only when the lower chamber 20 side is an upstream side is provided. Thereby, it is possible to further suppress an increase in size of the damping force generation mechanism 10D.

Also, in the damping force generation mechanism 10D, when the variable chamber 172D is at a higher pressure than the back pressure chamber 171D, the communication mechanism 181D opens the packing 422D of the partition member 111D, which blocks communication between the back pressure chamber 171D and the variable chamber 172D when the back pressure chamber 171D is at a higher pressure than the variable chamber 172D, and introduces the oil fluid L from the variable chamber 172D to the back pressure chamber 171D. Therefore, a configuration of the communication mechanism 181D can be simplified.

### Sixth Embodiment

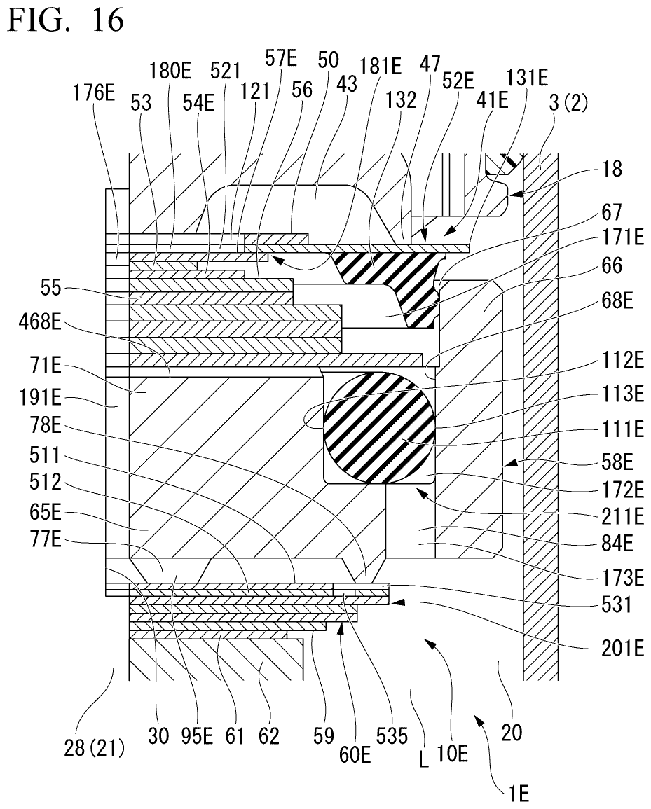

Next, a sixth embodiment will be described mainly on the basis of FIGS. 16 to 19, focusing on differences from the first embodiment. Further, parts common to those in the first embodiment will be denoted by the same terms and the same reference signs.

As shown in FIG. 16, in a shock absorber 1E including a damping force generation mechanism 10E of the sixth embodiment, a partial configuration of the damping force generation mechanism 10E differs from that of the damping force generation mechanism 10. The damping force generation mechanism 10E differs from the damping force generation mechanism 10 in configuration between a disc 50 and a disc 61 in an axial direction of a piston rod 21.

The damping force generation mechanism 10E includes, in order from the disc 50 side in the axial direction of the piston rod 21, one first damping valve 52E (first damping force generation member), one opening/closing disc 57E, one disc 53, one disc 54E, a plurality of, specifically six, discs 55 similar to those in the first embodiment, one pilot case 58E (biasing force generation member), one disc 511, one disc 512, and a plurality of, specifically four, discs 59 similar to those in the first embodiment. The discs 511 and 512, and 59 constitute a second damping valve 60E.

The disc 54E differs from the disc 54 in that the notch 141 is not formed.

The discs 511 and 512, the opening/closing disc 57E, and the pilot case 58E are all made of a metal. The discs 511 and 512 and the opening/closing disc 57E all have a bored circular flat plate shape with a constant thickness. The discs 511 and 512 and the opening/closing disc 57E are formed by press forming. The pilot case 58E has an annular shape. The discs 511 and 512, the opening/closing disc 57E, and the pilot case 58E all have a mounting shaft portion 28 of the piston rod 21 fitted inside.

The pilot case 58E has a bottomed cylindrical shape. The pilot case 58E is seamlessly and integrally formed as a whole by sintering. The pilot case 58E has a bottomed cylindrical shape and has a bottom portion 65E instead of the bottom portion 65.

The bottom portion 65E has a bored disc shape, and the mounting shaft portion 28 of the piston rod 21 is fitted to an inner circumferential side thereof. The pilot case 58E has an opening 67 on a side of the cylindrical portion 66 opposite to the bottom portion 65E in the axial direction.

The bottom portion 65E has a bottom main body portion 71E, an inner seat portion 77E, and a valve seat portion 78E.

The bottom main body portion 71E has a bored disc shape, and the mounting shaft portion 28 of the piston rod 21 is fitted to an inner circumferential side thereof. The cylindrical portion 66 extends in an axial direction of the bottom main body portion 71E from one axial end side of the bottom main body portion 71E on an outer circumferential side.

A seal groove 68E is formed in the bottom main body portion 71E at an intermediate position in a radial direction of the bottom main body portion 71E. The seal groove 68E is annular and is formed on an inner side of the cylindrical portion 66 in the radial direction of the bottom main body portion 71E. The seal groove 68E is recessed in a direction opposite to the cylindrical portion 66 in the axial direction of the bottom main body portion 71E from the cylindrical portion 66 side in the axial direction of the bottom main body portion 71E.

In the bottom main body portion 71E, a passage hole 84E is formed in the bottom surface of the seal groove 68E. The passage hole 84E penetrates the bottom main body portion 71E at a position of the seal groove 68E. The passage hole 84E is at an outer end position of the bottom surface of the seal groove 68E in a radial direction of the pilot case 58E. A plurality of passage holes 84E are provided in the pilot case 58E at regular intervals in a circumferential direction of the pilot case 58E.

A passage groove 468E extending inward in the radial direction of the bottom main body portion 71E from the seal groove 68E is formed on the cylindrical portion 66 side of the bottom main body portion 71E in the axial direction. The passage groove 468E allows communication between the inside of the seal groove 68E and a passage inside a passage groove 30 of the piston rod 21.

The inner seat portion 77E is formed on an inner circumferential side of the bottom main body portion 71E. The inner seat portion 77E has an annular shape. The inner seat portion 77E protrudes from a portion of the bottom main body portion 71E on the inner circumferential side to a side opposite to the cylindrical portion 66 in the axial direction of the bottom main body portion 71E. A passage groove 95E penetrating the inner seat portion 77E in the radial direction is formed in the inner seat portion 77E. A passage in the passage groove 95E communicates with the passage in the passage groove 30 of the piston rod 21.

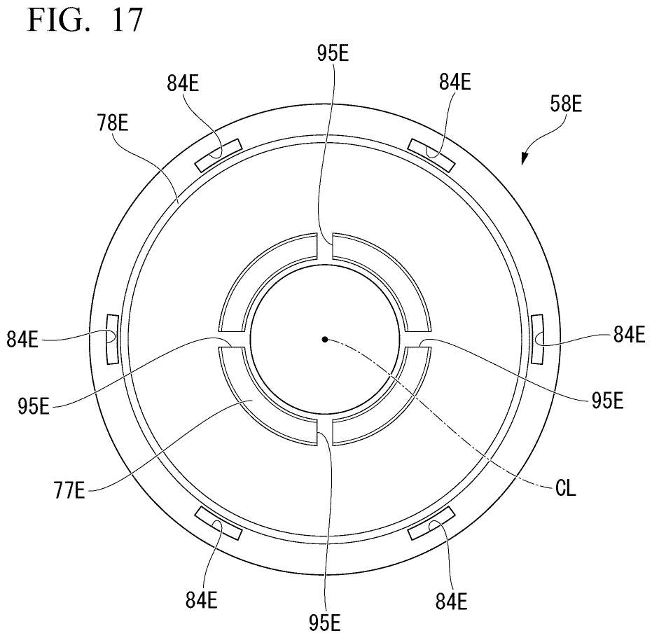

The valve seat portion 78E protrudes to a side opposite to the cylindrical portion 66 in the axial direction of the bottom main body portion 71E. As shown in FIG. 17, the valve seat portion 78E is annular. The valve seat portion 78E is provided to surround the inner seat portion 77E from an outer side of the inner seat portion 77E in the radial direction of the bottom main body portion 71E.

As shown in FIG. 16, the damping force generation mechanism 10E has a partition member 111E (movable mechanism) in the seal groove 68E. The partition member 111E has an annular shape as a whole, and is an O-ring having a circular cross section in a plane including a central axis of the annular ring. The partition member 111E is fitted into the seal groove 68E of the pilot case 58E. The partition member 111E is made of an elastic material having sealing properties, specifically, rubber. A seal portion 112E at an inner circumference of the partition member 111E comes into pressure contact with a wall surface on a radially inner side of the seal groove 68E to seal a gap between itself and the wall surface. A seal portion 113E at an outer circumference of the partition member 111E comes into pressure contact with a wall surface on a radially outer side of the seal groove 68E to seal a gap between itself and the wall surface.

The first damping valve 52E is formed of a disc 131E and a seal member 132.

The disc 131E differs from the disc 131 in that a notch 521 is formed on an inner circumferential side. The notch 521 is formed on an inner side of the seal member 132 in a radial direction of the first damping valve 52E. A passage in the notch 521 communicates with a passage in a notch 121 of the disc 50.

The opening/closing disc 57E extends to an outer side beyond the notch 521 of the first damping valve 52E in the radial direction of the first damping valve 52E. The opening/closing disc 57E closes the passage in the notch 521 by coming into contact with the disc 131E of the first damping valve 52E by surface contact. The opening/closing disc 57E opens the passage in the notch 521 by being separated from the disc 131E.

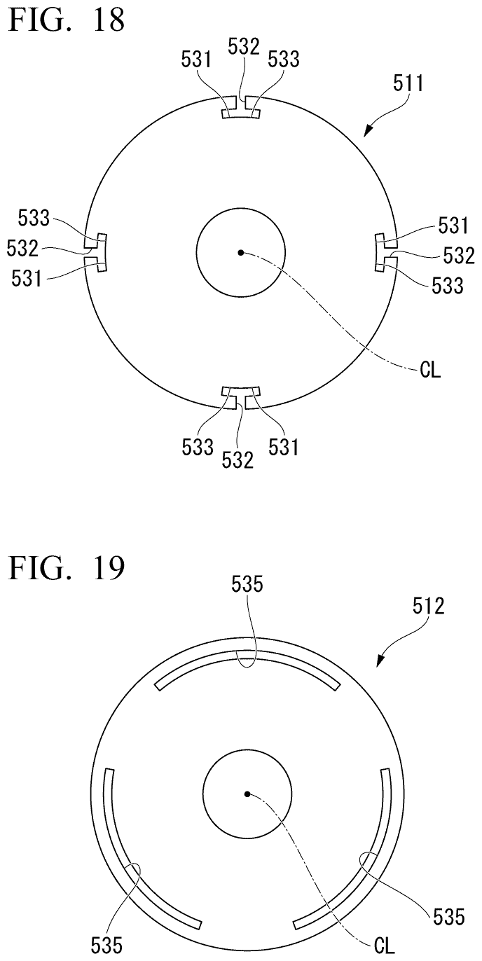

The disc 511 has an outer diameter larger than an outer diameter of the valve seat portion 78E. As shown in FIG. 18, a notch 531 is formed at an outer circumferential portion of the disc 511. The notch 531 has an outer notch portion 532 extending inward in the radial direction from an outer circumferential edge part of the disc 511, and an arc-shaped inner notch portion 533 extending to both sides in a circumferential direction of the disc 511 from an inner end position of the outer notch portion 532 in the radial direction of the disc 511. The disc 511 has a plurality of, specifically four, notches 531 formed at regular intervals in the circumferential direction.

As shown in FIG. 16, the disc 512 has an outer diameter equal to the outer diameter of the disc 511. As shown in FIG. 19, the disc 512 has a plurality of, specifically three, passage holes 535 formed on an outer circumferential side thereof. The passage hole 535 has an arcuate shape extending in a circumferential direction of the disc 512. In the radial direction of the discs 511 and 512, the passage holes 535 are aligned with the inner notch portions 533 in position. That is, the passage hole 535 and the notch 531 communicate with each other.

The disc 511 comes into contact with the valve seat portion 78E of the pilot case 58E. At that time, the outer notch portion 532 of the disc 511 crosses the valve seat portion 78E in the radial direction. Also, at that time, the inner notch portion 533 of the disc 511 is positioned on an inner side of the valve seat portion 78E in the radial direction of the valve seat portion 78E.

As shown in FIG. 16, the seal portions 112E and 113E of the partition member 111E are simultaneously in pressure contact with the respective wall surfaces on the radially inner and outer sides of the seal groove 68E. Thereby, a portion surrounded by the pilot case 58E, the first damping valve 52E and the discs 53, 54E, and 55, the opening/closing disc 57E, and the partition member 111E forms a back pressure chamber 171E. The back pressure chamber 171E is in constant communication with the passage in the passage groove 30 of the piston rod 21 via a passage in the passage groove 468E.

Also, due to the partition member 111E, a variable chamber 172E is formed between the bottom surface side of the seal groove 68E and the partition member 111E. The variable chamber 172E is in constant communication with a lower chamber 20 via a passage in the passage hole 84E.

The back pressure chamber 171E is formed inside the bottomed cylindrical pilot case 58E by the first damping valve 52E, the discs 53, 54E, and 55, the opening/closing disc 57E, and the partition member 111E. The partition member 111E is provided inside the pilot case 58E and partitions the inside of the pilot case 58E into the back pressure chamber 171E and the variable chamber 172E.

The first damping valve 52E, together with a valve seat portion 47 of a piston 18, constitutes a first valve mechanism 41E. The first damping valve 52E opens when the disc 131E thereof is separated from the valve seat portion 47 during the extension stroke. Then, the first damping valve 52E allows the oil fluid L from a piston-side passage 43 to flow into the lower chamber 20 through a gap between itself and the valve seat portion 47. The extension-side first valve mechanism 41E, formed of the valve seat portion 47 and the first damping valve 52E, is provided in the piston-side passage 43, and generates a damping force by opening and closing the piston-side passage 43 with the first damping valve 52E to suppress a flow of the oil fluid L.

The passage in the notch 121 of the disc 50, the passage in the passage groove 30 of the piston rod 21, and the passage in the passage groove 468E of the pilot case 58E constitute a back pressure chamber introduction passage 176E that branches off from the piston-side passage 43. The back pressure chamber introduction passage 176E allows communication between an upper chamber 19 (see FIG. 2) and the back pressure chamber 171E via a part of the piston-side passage 43 (see FIG. 2). During the extension stroke, the back pressure chamber introduction passage 176E introduces the oil fluid L from the upper chamber 19 (see FIG. 2), which is upstream of the back pressure chamber 171E, to the back pressure chamber 171E via a part of the piston-side passage 43.

The passage in the passage hole 84E and a passage in the seal groove 68E, which are both provided in the bottom portion 65E of the pilot case 58E, constitute a first passage 173E that extends to connect the back pressure chamber 171E and the lower chamber 20. The partition member 111E having the seal portions 112E and 113E that seal the first passage 173E with an elastic member is movably provided in the first passage 173E. The lower chamber 20 is on a downstream side of the first damping valve 52E in a flow direction of the oil fluid L during the extension stroke.

The back pressure chamber 171E causes an internal pressure to act on the first damping valve 52E in a direction of the piston 18, that is, in a valve closing direction in which the disc 131E is seated on the valve seat portion 47. The pilot case 58E has a bottomed cylindrical shape and forms the back pressure chamber 171E that causes the first damping valve 52E disposed on the opening 67 side to generate a biasing force in a valve closing direction.

The passages in the notch 531 and the passage hole 535 of the second damping valve 60E, a passage between the valve seat portion 78E and the inner seat portion 77E of the pilot case 58E, the passage in the passage groove 95E of the pilot case 58E, the passage in the passage groove 30 of the piston rod 21, and the passage in the notch 521 of the first damping valve 52E form a second passage 180E. The opening/closing disc 57E is provided to be openable and closable between the second passage 180E and the back pressure chamber 171E. The second passage 180E is provided parallel to the first passage 173E in the passage hole 84E. The second passage 180E is disposed on an inner circumferential side of the first passage 173E in the pilot case 58E. In a state in which the opening/closing disc 57E is in contact with the disc 131E of the first damping valve 52E by surface contact, the opening/closing disc 57E blocks a flow of the oil fluid L between the back pressure chamber 171E, and the second passage 180E and the lower chamber 20. Also, in a state in which the opening/closing disc 57E is separated from the disc 131E, the opening/closing disc 57E allows the oil fluid L to flow between the back pressure chamber 171E, and the second passage 180E and the lower chamber 20.

Here, when a pressure on a side of the second passage 180E and the lower chamber 20 becomes higher than a pressure on the back pressure chamber 171E side by a predetermined value or more, the opening/closing disc 57E allows a flow of the oil fluid L from the lower chamber 20 and the second passage 180E to the back pressure chamber 171E via the second passage 180E. In a state in which a pressure on the back pressure chamber 171E side is higher than a pressure on the side of the second passage 180E and the lower chamber 20, the opening/closing disc 57E restricts a flow of the oil fluid L from the back pressure chamber 171E to the lower chamber 20 via the second passage 180E.

The opening/closing disc 57E and the disc 131E of the first damping valve 52E constitute a communication mechanism 181E. One side of the second passage 180E can communicate with the back pressure chamber 171E. The communication mechanism 181E is on the one side of the second passage 180E and is allowed to communicate with the lower chamber 20 side, which is the other side of the second passage 180E, only when the lower chamber 20 is on the upstream side. The communication mechanism 181E is a check valve, and the opening/closing disc 57E is a valve member thereof.

The second damping valve 60E formed of the discs 59, 511, and 512 can be separated from and seated on the valve seat portion 78E.

The passage in the passage groove 30 of the piston rod 21, the passage in the passage groove 95E of the pilot case 58E, and the passage between the inner seat portion 77E and the valve seat portion 78E form a rod-side passage 191E that branches off from the piston-side passage 43. The rod-side passage 191E allows communication between the upper chamber 19 and the lower chamber 20. The valve seat portion 78E and the second damping valve 60E are provided in the rod-side passage 191E and constitute a second valve mechanism 201E that opens and closes the rod-side passage 191E.

The second damping valve 60E of the second valve mechanism 201E is seated on the valve seat portion 78E. During the extension stroke, the second damping valve 60E opens to provide resistance to a flow of the oil fluid L from the upper chamber 19 to the lower chamber 20 via a part of the piston-side passage 43, a part of the back pressure chamber introduction passage 176E, and the rod-side passage 191E. In other words, the second valve mechanism 201E suppresses the flow of the oil fluid L from the upper chamber 19 to the lower chamber 20 to generate a damping force. The second valve mechanism 201E is an extension-side damping force generation mechanism that is provided in the rod-side passage 191E and generates a damping force due to a flow of oil fluid L.

The pilot case 58E and the partition member 111E constitute a frequency sensitive mechanism 211E that varies the damping force in response to a frequency of reciprocation of the piston 18. In the frequency sensitive mechanism 211E, the partition member 111E moves and deforms in response to the frequency of reciprocation of the piston 18, thereby changing a volume of the back pressure chamber 171E that is in constant communication with the upper chamber 19 and a volume of the variable chamber 172E that is in constant communication with the lower chamber 20. The frequency sensitive mechanism 211E has the partition member 111E provided in the first passage 173E to be movable. The frequency sensitive mechanism 211E varies a biasing force on the first damping valve 52E by the back pressure chamber 171E.

During the extension stroke, the oil fluid L is introduced into the back pressure chamber 171E from the back pressure chamber introduction passage 176E. As a result, the back pressure chamber 171E side has a higher pressure than the lower chamber 20 side. Then, the partition member 111E, receiving the pressure from the back pressure chamber 171E, moves to the bottom surface of the seal groove 68E and comes into contact with the bottom surface to be compressively deformed while maintaining the sealed state with the seal groove 68E. Thereby, a volume of the back pressure chamber 171E increases.

During the compression stroke, if a pressure on the lower chamber 20 side becomes higher than that on the back pressure chamber 171E side, the partition member 111E, receiving the pressure on the lower chamber 20 side introduced from the first passage 173E, moves to the disc 55 side and comes into contact with the disc 55 to be compressively deformed while maintaining the sealed state with the seal groove 68E. Thereby, a volume of the variable chamber 172E increases.

The damping force generation mechanism 10E of the sixth embodiment has the pilot case 58E, the frequency sensitive mechanism 211E, the second passage 180E, and the communication mechanism 181E. The pilot case 58E has a bottomed cylindrical shape and forms the back pressure chamber 171E that causes the first damping valve 52E disposed on the opening 67 side to generate a biasing force in a valve closing direction. The frequency sensitive mechanism 211E is configured such that the partition member 111E having the seal portions 112E and 113E that seal the first passage 173E with an elastic member is movably provided in the first passage 173E that is provided in the bottom portion 65E of the pilot case 58E to connect the back pressure chamber 171E and the lower chamber 20, thereby varying the biasing force in a valve closing direction to the first damping valve 52E. The second passage 180E is provided parallel to the first passage 173E, and one side thereof can communicate with the back pressure chamber 171E. The communication mechanism 181E is on the one side of the second passage 180E and is allowed to communicate with the other side of the second passage 180E only when the lower chamber 20 is on the upstream side.

As described above, the damping force generation mechanism 10E is configured such that the first passage 173E, which extends to connect the back pressure chamber 171E and the lower chamber 20, is provided in the bottom portion 65E of the pilot case 58E that forms the back pressure chamber 171E. Then, the damping force generation mechanism 10E varies the biasing force in a valve closing direction on the first damping valve 52E by the frequency sensitive mechanism 211E in which the partition member 111E that seals the first passage 173E with the seal portions 112E and 113E is movably provided in the first passage 173E. Therefore, the damping force generation mechanism 10E, even with the frequency sensitive mechanism 211E, can suppress an increase in size.

Also, since the communication mechanism 181E is provided in the damping force generation mechanism 10E, when the stroke is reversed from the compression stroke to the extension stroke, the communication mechanism 181E opens and introduces the oil fluid L from the lower chamber 20, which has a higher pressure than the upper chamber 19 during the compression stroke, into the back pressure chamber 171E via the second passage 180E. At that time, the damping force generation mechanism 10E introduces the oil fluid L from the lower chamber 20 to the back pressure chamber 171E through the passages in the notch 531 and the passage hole 535 of the second damping valve 60E, the passage between the valve seat portion 78E and the inner seat portion 77E of the pilot case 58E, the passage in the passage groove 95E of the pilot case 58E, the passage in the passage groove 30 of the piston rod 21, and the passage in the passage groove 468E of the pilot case 58E. Thereby, the pressure in the back pressure chamber 171E can be quickly increased. Then, the closed state of the first damping valve 52E, which is biased in the valve closing direction by the pressure of the back pressure chamber 171E, becomes stable. Thereby, it is possible to suppress a delay in the rise of the damping force that occurs when the stroke is reversed from the compression stroke to the extension stroke.

Also, since the second passage 180E that is opened and closed by the communication mechanism 181E is disposed on an inner circumference side of the bottom portion 65E with respect to the first passage 173E, an increase in size of the damping force generation mechanism 10E in the radial direction can be suppressed.

Also, since an O-ring is used as the partition member 111E having the seal portions 112E and 113E that seal the first passage 173E with an elastic member, the damping force generation mechanism 10E is subject to a large compressive deformation. From this, provision of the communication mechanism 181E is highly effective in suppressing the delay in the rise of the damping force that occurs when the stroke is reversed from the compression stroke to the extension stroke.

### Seventh Embodiment

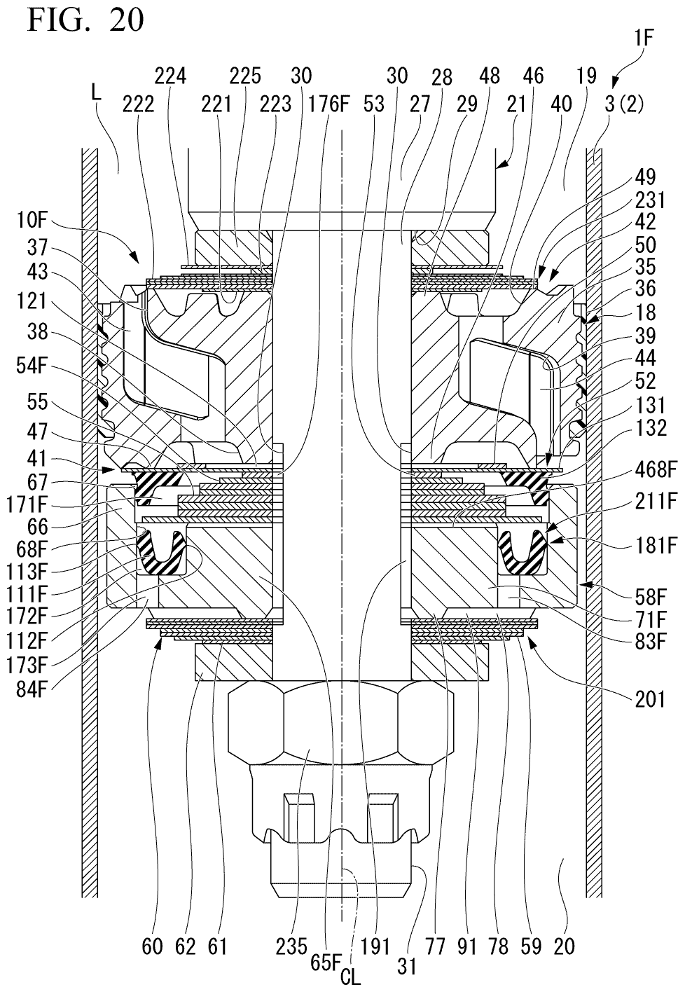

Next, a seventh embodiment will be described mainly on the basis of FIG. 20, focusing on differences from the first embodiment. Further, parts common to those in the first embodiment will be denoted by the same terms and the same reference signs.

As shown in FIG. 20, in a shock absorber 1F including a damping force generation mechanism 10F of the seventh embodiment, a partial configuration of the damping force generation mechanism 10F differs from that of the damping force generation mechanism 10. The damping force generation mechanism 10F is provided with a disc 54F, which is partially different from the disc 54, instead of the disc 54. The damping force generation mechanism 10F is provided with a pilot case 58F, which is partially different from the pilot case 58, instead of the pilot case 58. The opening/closing disc 57 is not provided in the damping force generation mechanism 10F.

The disc 54F differs from the disc 54 in that the notch 141 is not formed.

The pilot case 58F has a bottomed cylindrical shape. The pilot case 58F is seamlessly and integrally formed as a whole by sintering. The pilot case 58F has a bottom portion 65F. The bottom portion 65F has a bored disc shape, and a mounting shaft portion 28 of a piston rod 21 is fitted to an inner circumferential side thereof. The pilot case 58F has an opening 67 on a side of a cylindrical portion 66 opposite to the bottom portion 65F in an axial direction.

The bottom portion 65F has a bottom main body portion 71F, and an inner seat portion 77 and an outer seat portion 78 similarly to those described above.

The bottom main body portion 71F has a bored disc shape. The cylindrical portion 66 extends in an axial direction of the bottom main body portion 71F from a side of the bottom main body portion 71F opposite to the inner seat portion 77 and the outer seat portion 78 in the axial direction.

A seal groove 68F is formed in the bottom main body portion 71F at an intermediate position in a radial direction of the bottom main body portion 71F. The seal groove 68F is annular and is formed on an inner side of the cylindrical portion 66 in the radial direction of the bottom main body portion 71E The seal groove 68F is recessed in a direction opposite to the cylindrical portion 66 in the axial direction of the bottom main body portion 71F from the cylindrical portion 66 side in the axial direction of the bottom main body portion 71F.

In the bottom main body portion 71F, a passage hole 83F and a passage hole 84F are formed in a bottom surface of the seal groove 68F. The passage hole 83F penetrates the bottom main body portion 71F at a position of the seal groove 68F. The passage hole 83F is at an inner end position of the bottom surface of the seal groove 68F in a radial direction of the pilot case 58F. The passage hole 84F is at an outer end position of the bottom surface of the seal groove 68F in the radial direction of the pilot case 58F. A plurality of passage holes 83F and a plurality of passage holes 84F are provided in the pilot case 58F. In the pilot case 58F, the passage holes 83F and the passage holes 84F are provided alternately in a circumferential direction of the pilot case 58F.

A passage groove 468F extending inward in the radial direction of the bottom main body portion 71F from the seal groove 68F is formed on a side of the bottom main body portion 71F opposite to the inner seat portion 77 in the axial direction. The passage groove 468F allows communication between the seal groove 68F and a passage in a passage groove 30 of the piston rod 21.

The damping force generation mechanism 10F has a partition member 111F (movable mechanism) in the seal groove 68F. The partition member 111F has an annular shape as a whole, and is a V-packing having a V-shaped cross section in a plane including a central axis of the annular ring. The partition member 111F is fitted into the seal groove 68F of the pilot case 58F. At that time, a V-shaped opening side of the partition member 111F faces a side opposite to a bottom surface of the seal groove 68F. The partition member 111F is made of an elastic material having sealing properties, specifically, rubber. A seal portion 112F at an inner circumference of the partition member 111F comes into pressure contact with a wall surface on a radially inner side of the seal groove 68F to seal a gap between itself and the wall surface. A seal portion 113F at an outer circumference of the partition member 111F comes into pressure contact with a wall surface on a radially outer side of the seal groove 68F to seal a gap between itself and the wall surface.

In the damping force generation mechanism 10F, a disc 55 comes into contact with the bottom main body portion 71F of the pilot case 58F.

The seal portions 112F and 113F of the partition member 111F are simultaneously in pressure contact with the respective wall surfaces on the radially inner and outer sides of the seal groove 68F. Thereby, a portion surrounded by the pilot case 58F, a first damping valve 52, the discs 53, 54F, and 55, and the partition member 111F forms a back pressure chamber 171F. The back pressure chamber 171F is in constant communication with the passage in the passage groove 30 of the piston rod 21 via a passage in the passage groove 468F.

Also, due to the partition member 111F, a variable chamber 172F is formed between the bottom surface side of the seal groove 68F and the partition member 111F. The variable chamber 172F is in constant communication with a lower chamber 20 via the passages in the passage holes 83F and 84F.

The back pressure chamber 171F is formed inside the bottomed cylindrical pilot case 58F by the first damping valve 52, the discs 53, 54F, and 55, and the partition member 111F. The partition member 111F is provided inside the pilot case 58F and partitions the inside of the pilot case 58F into the back pressure chamber 171F and the variable chamber 172F.

A passage in a notch 121 of a disc 50, the passage in the passage groove 30 of the piston rod 21, and the passage in the passage groove 468F of the pilot case 58F constitute a back pressure chamber introduction passage 176F that branches off from a piston-side passage 43. The back pressure chamber introduction passage 176F allows communication between an upper chamber 19 and the back pressure chamber 171F via a part of the piston-side passage 43. During an extension stroke, the back pressure chamber introduction passage 176F introduces the oil fluid L from the upper chamber 19, which is upstream of the back pressure chamber 171F, to the back pressure chamber 171F via a part of the piston-side passage 43.

Passages in the passage holes 83F and 84F and a passage in the seal groove 68F, which are all provided in the bottom portion 65F of the pilot case 58F, constitute a first passage 173F that extends to connect the back pressure chamber 171F and the lower chamber 20. The partition member 111F having the seal portions 112F and 113F that seal the first passage 173F with an elastic member is movably provided in the first passage 173F.

The back pressure chamber 171F causes an internal pressure to act on the first damping valve 52 in a direction of a piston 18, that is, in a valve closing direction in which a disc 131 is seated on a valve seat portion 47. The pilot case 58F has a bottomed cylindrical shape and forms the back pressure chamber 171F that causes the first damping valve 52 disposed on the opening 67 side to generate a biasing force in a valve closing direction.

The partition member 111F is provided in the first passage 173F to be openable and closable. In a state in which the seal portions 112F and 113F simultaneously come into contact with respective wall surfaces on the radially inner and outer sides of the seal groove 68F, the partition member 111F blocks a flow of the oil fluid L via the first passage 173F between the back pressure chamber 171F and the lower chamber 20. Also, in a state in which the seal portions 112F and 113F are separated from the respective wall surfaces on the radially inner and outer sides of the seal groove 68F, the partition member 111F allows a flow of the oil fluid L via the first passage 173F between the back pressure chamber 171F and the lower chamber 20.

Here, when a pressure on the lower chamber 20 side becomes higher than a pressure on the back pressure chamber 171F side by a predetermined value or more, the partition member 111F allows a flow of the oil fluid L from the lower chamber 20 to the back pressure chamber 171F via the first passage 173F. When a pressure on the back pressure chamber 171F side is higher than a pressure on the lower chamber 20 side, the partition member 111F restricts a flow of the oil fluid L from the back pressure chamber 171F to the lower chamber 20 via the first passage 173F.

The partition member 111F and the respective wall surfaces on the radially inner and outer sides of the seal groove 68F constitute a communication mechanism 181F. One side of the first passage 173F can communicate with the back pressure chamber 171F. The communication mechanism 181F is on the one side of the first passage 173F and is allowed to communicate with the lower chamber 20 side, which is the other side of the first passage 173F, only when the lower chamber 20 is on the upstream side. In other words, when the lower chamber 20 is on the downstream side, the communication mechanism 181F cannot communicate with the lower chamber 20 side which is the other side of the first passage 173F. Between the back pressure chamber 171F and the variable chamber 172F, the communication mechanism 181F restricts a flow of the oil fluid L in one direction from the back pressure chamber 171F side to the variable chamber 172F side. On the other hand, the communication mechanism 181F allows a flow of the oil fluid L in the other direction from the variable chamber 172F side to the back pressure chamber 171F side. The communication mechanism 181F is a check valve, and the partition member 111F is a valve member thereof.

The partition member 111F opens when the first passage 173F allows the oil fluid L to flow from the lower chamber 20 to the back pressure chamber 171F. The first passage 173F is provided to connect the back pressure chamber 171F and the lower chamber 20, and the partition member 111F is provided therein. In the first passage 173F in which the partition member 111F is provided, one side thereof is allowed to communicate with the back pressure chamber 171F, and the one side also serves as a passage in which the communication mechanism 181F allowed to communicate with the other side only when the lower chamber 20 side is an upstream side is provided.

The communication mechanism 181F restricts a flow of the oil fluid L from the upper chamber 19, the piston-side passage 43, the back pressure chamber introduction passage 176F, and the back pressure chamber 171F to the lower chamber 20 via the first passage 173E The communication mechanism 181F allows a flow of the oil fluid L from the lower chamber 20 to the back pressure chamber 171F, the back pressure chamber introduction passage 176F, the piston-side passage 43, and the upper chamber 19 via the first passage 173F.

The pilot case 58F and the partition member 111F constitute a frequency sensitive mechanism 211F that varies the damping force in response to a frequency of reciprocation of the piston 18. In the frequency sensitive mechanism 211F, the partition member 111F moves and deforms in response to the frequency of reciprocation of the piston 18, thereby changing a volume of the back pressure chamber 171F that is in constant communication with the upper chamber 19 and a volume of the variable chamber 172F that is in constant communication with the lower chamber 20. The frequency sensitive mechanism 211F has the partition member 111F provided in the first passage 173F to be movable. The frequency sensitive mechanism 211F varies a biasing force on the first damping valve 52 by the back pressure chamber 171F.

The damping force generation mechanism 10F operates in substantially the same manner as the damping force generation mechanism 10, except for the following points.

During the extension stroke, the oil fluid L is introduced into the back pressure chamber 171F via the back pressure chamber introduction passage 176F. Then, a differential pressure between the back pressure chamber 171F and the lower chamber 20 at that time is such that the back pressure chamber 171F side is higher than the lower chamber 20 side. Then, the partition member 111F, receiving the pressure of the back pressure chamber 171F, moves to the bottom surface side of the seal groove 68F and comes into contact with the bottom surface to be deformed while maintaining the sealed state with the seal groove 68F. Thereby, a volume of the back pressure chamber 171F increases.

During a compression stroke, the lower chamber 20 side has a higher pressure than the back pressure chamber 171F side. Then, if a differential pressure between the lower chamber 20 side and the back pressure chamber 171F side is lower than a predetermined value, the oil fluid flows from the lower chamber 20 to the variable chamber 172F via the passages in the passage holes 83F and 84F of the first passage 173F, and the partition member 111F, receiving the pressure, moves to the disc 55 side and comes into contact with the disc 55 to be deformed while maintaining the sealed state with the seal groove 68F. Thereby, a volume of the variable chamber 172F increases. Also, during the compression stroke, if the lower chamber 20 side has a higher pressure than the back pressure chamber 171F side by a predetermined value or more, the partition member 111F deforms to reduce an outer diameter and increase an inner diameter so that the communication mechanism 181F opens, and the oil fluid L is allowed to flow from the lower chamber 20 to the back pressure chamber 171F via the passages in the passage holes 83F and 84F of the first passage 173F and the passage in the seal groove 68F.

The damping force generation mechanism 10F of the seventh embodiment has the pilot case 58F, the frequency sensitive mechanism 211F, the first passage 173F, and the communication mechanism 181F. The pilot case 58F has a bottomed cylindrical shape and forms the back pressure chamber 171F that causes the first damping valve 52 disposed on the opening 67 side to generate a biasing force in a valve closing direction. The frequency sensitive mechanism 211F is configured such that the partition member 111F, having the seal portions 112F and 113F that seal the first passage 173F with an elastic member, is movably provided in the first passage 173F that is provided in the bottom portion 65F of the pilot case 58F to connect the back pressure chamber 171F and the lower chamber 20, thereby varying the biasing force in a valve closing direction on the first damping valve 52. One side of the first passage 173F can communicate with the back pressure chamber 171F. The communication mechanism 181F is on the one side of the first passage 173F and is allowed to communicate with the other side of the first passage 173F only when the lower chamber 20 is on the upstream side.

As described above, the damping force generation mechanism 10F is configured such that the first passage 173F, which extends to connect the back pressure chamber 171F and the lower chamber 20, is provided in the bottom portion 65F of the pilot case 58F that forms the back pressure chamber 171F. Then, the damping force generation mechanism 10F varies the biasing force in a valve closing direction on the first damping valve 52 by the frequency sensitive mechanism 211F in which the partition member 111F that seals the first passage 173F with the seal portions 112F and 113F is movably provided in the first passage 173F. Therefore, the damping force generation mechanism 10F, even with the frequency sensitive mechanism 211F, can suppress an increase in size.

Also, since the communication mechanism 181F is provided in the damping force generation mechanism 10F, when the stroke is reversed from the compression stroke to the extension stroke, the communication mechanism 181F opens and introduces the oil fluid L from the lower chamber 20, which has a higher pressure than the upper chamber 19 during the compression stroke, into the back pressure chamber 171F via the first passage 173F, thereby allowing the pressure in the back pressure chamber 171F to be quickly increased. Then, the closed state of the first damping valve 52, which is biased in a valve closing direction by the pressure of the back pressure chamber 171F, becomes stable. Thereby, it is possible to suppress a delay in the rise of the damping force that occurs when the stroke is reversed from the compression stroke to the extension stroke.

Also, the damping force generation mechanism 10F is configured such that, in the first passage 173F in which the partition member 111F is provided, one side thereof is allowed to communicate with the back pressure chamber 171F, and the one side also serves as a passage in which the communication mechanism 181F allowed to communicate with the other side only when the lower chamber 20 side is an upstream side is provided. Thereby, it is possible to further suppress an increase in size of the damping force generation mechanism 10F.

Also, in the damping force generation mechanism 10F, when the partition member 111F is a V-packing and the lower chamber 20 side of the first passage 173F is an upstream side, an outer circumferential side or inner circumferential side of the partition member 111F, which is a V-packing, serves as a passage that allows the oil fluid L to flow from the lower chamber 20 to the back pressure chamber 171F. Therefore, the configuration can be simplified, and an increase in cost can be suppressed.

### (Additional Statement 1)

A damping force generation mechanism of Additional statement 1 includes:
a biasing force generation member having a bottomed cylindrical shape and forming a back pressure chamber which causes a first damping force generation member disposed on an opening side to generate a biasing force in a valve closing direction;
a frequency sensitive mechanism configured such that a movable mechanism having a seal portion, which seals a first passage with an elastic member, is movably provided in the first passage provided at a bottom portion of the biasing force generation member to connect the back pressure chamber and a first chamber, thereby making the biasing force variable;
a second passage parallel to or common with the first passage and having one side allowed to communicate with the back pressure chamber; and
a communication mechanism which is on the one side of the second passage and allowed to communicate with the other side of the second passage only when the first chamber is on an upstream side.

### (Additional Statement 2)

In a damping force generation mechanism of Additional statement 2 according to the damping force generation mechanism of Additional statement 1, the second passage is disposed on an inner circumferential side of the first passage.

### (Additional Statement 3)

In a damping force generation mechanism of Additional statement 3 according to the damping force generation mechanism of Additional statement 1, the second passage is disposed on an outer circumferential side of the first passage.

### (Additional Statement 4)

In a damping force generation mechanism of Additional statement 4 according to the damping force generation mechanism of any one of Additional statement 1 to Additional statement 3, the movable mechanism is an O-ring.

### (Additional Statement 5)

In a damping force generation mechanism of Additional statement 5 according to the damping force generation mechanism of Additional statement 1, the first passage also serves as the second passage.

### (Additional Statement 6)

In a damping force generation mechanism of Additional statement 6 according to the damping force generation mechanism of any one of Additional statement 1, Additional statement 2, and Additional statement 5, a tapered portion is provided in the biasing force generation member, and movement of the movable mechanism is restricted by the tapered portion.

### (Additional Statement 7)

In a damping force generation mechanism of Additional statement 7 according to the damping force generation mechanism of Additional statement 6, a passage allowing constant communication is formed between the tapered portion and an outer bottom side of the biasing force generation member.

### (Additional Statement 8)

In a damping force generation mechanism of Additional statement 8 according to the damping force generation mechanism of any one of Additional statement 5 to Additional statement 7, the movable mechanism has a disc having a hole, and a packing and is provided with a valve member capable of closing the hole, in which the valve member opens when the first passage acts as the second passage.

### (Additional Statement 9)

In a damping force generation mechanism of Additional statement 9 according to the damping force generation mechanism of any one of Additional statement 5 to Additional statement 7, when the movable mechanism is a V-packing and the first passage acts as the second passage, an outer circumferential side or an inner circumferential side of the V-packing serves as the second passage.

### INDUSTRIAL APPLICABILITY

According to each of the above-described aspects of the present invention, it is possible to provide a damping force generation mechanism in which an increase in size can be suppressed. Therefore, industrial applicability is high.

### REFERENCE SIGNS LIST

1, 1A to 1F Shock absorber
2 Cylinder
10, 10A to 10F Damping force generation mechanism
20 Lower chamber (first chamber)
52, 52A, 52B, 52E First damping valve (first damping force generation member)
57B Opening/closing disc (valve member)
58, 58A to 58F Pilot case (biasing force generation member)
65, 65A to 65F Bottom portion
67, 67A, 67B Opening
111, 111A to 111F Partition member (variable mechanism)
112, 112A to 112F, 113, 113A to 113F Seal portion
171, 171A to 171F Back pressure chamber
173, 173A to 173F First passage
180, 180A to 180F Second passage
181, 181A to 181F Communication mechanism
211, 211A to 211F Frequency sensitive mechanism
412 Tapered portion
421 Disc
422 Packing
425 Passage hole (hole)

1. A damping force generation mechanism comprising:
a biasing force generation member having a bottomed cylindrical shape and forming a back pressure chamber which causes a first damping force generation member disposed on an opening side to generate a biasing force in a valve closing direction;
a frequency sensitive mechanism configured such that a movable mechanism having a seal portion, which seals a first passage with an elastic member, is movably provided in the first passage provided at a bottom portion of the biasing force generation member to connect the back pressure chamber and a first chamber, thereby making the biasing force variable;
a second passage parallel to or common with the first passage and having one side allowed to communicate with the back pressure chamber; and
a communication mechanism which is on the one side of the second passage and allowed to communicate with another side of the second passage only when the first chamber is on an upstream side.

2. The damping force generation mechanism according to claim 1, wherein the second passage is disposed on an inner circumferential side of the first passage.

3. The damping force generation mechanism according to claim 1, wherein the second passage is disposed on an outer circumferential side of the first passage.

4. The damping force generation mechanism according to claim 1, wherein the movable mechanism is an O-ring.

5. The damping force generation mechanism according to claim 1, wherein the first passage also serves as the second passage.

6. The damping force generation mechanism according to claim 5, wherein a tapered portion is provided in the biasing force generation member, and movement of the movable mechanism is restricted by the tapered portion.

7. The damping force generation mechanism according to claim 6, wherein a passage allowing constant communication is formed between the tapered portion and an outer bottom side of the biasing force generation member.

8. The damping force generation mechanism according to claim 5, wherein the movable mechanism has a disc having a hole, and a packing and is provided with a valve member which is able to close the hole, in which the valve member opens when the first passage acts as the second passage.

9. The damping force generation mechanism according to claim 5, wherein the movable mechanism is a V-packing, and when the first passage acts as the second passage, an outer circumferential side or an inner circumferential side of the V-packing serves as the second passage.
